(19) United States
(12) Patent Application Publication
(10) Pub. No.: US 2020/0396993 A1
(43) Pub. Date: Dec. 24, 2020

(54) COMPOSITIONS AND METHODS FOR RELEASE OF CYCLOPROPENES

(71) Applicant: Hazel Technologies, Inc., Chicago, IL (US)

(72) Inventors: Aidan R. Mouat, Chicago, IL (US); Adam Truett Preslar, London (GB)

(73) Assignee: Hazel Technologies, Inc., Chicago, IL (US)

(21) Appl. No.: 16/957,794

(22) PCT Filed: Aug. 23, 2018
(86) PCT No.: PCT/US2018/047826

§ 371 Date: Jun. 25, 2020

Related U.S. Application Data
(60) Provisional application No. 62/714,582, filed on Aug. 3, 2018.
(60) Provisional application No. 62/610,697, filed on Dec. 27, 2017.

(51) Int. Cl. A01N 27/00; A01N 25/08; A01N 25/18

(52) U.S. Cl. CPC A01N 27/00; A01N 25/18; A01N 25/08

(57) ABSTRACT

Systems, compositions, methods, and methods of making compositions for release of one or more cyclopropene compounds are generally provided.

### RELATED APPLICATIONS

The present application claims priority under 35 U.S.C. § 119(e) to U.S. Provisional Patent Application No. 62/610,697, filed on Dec. 27, 2017, entitled “Compositions and Methods for Release of Cyclopropenes” and to U.S. Provisional Patent Application No. 62/714,582 filed on Aug. 3, 2018, entitled “Compositions for Controlled Release of Cyclopropenes,” each of which are incorporated herein by reference in their entirety.

### FIELD OF THE INVENTION

Compositions and methods for release of cyclopropenes are generally provided.

### BACKGROUND

Produce waste throughout the supply chain decreases agricultural productivity and reduces the availability of nutritious food sources. Produce ages and eventually spoils due to, for example, the plant hormone ethylene. Cyclopropene compounds are used to control control produce spoilage, but their inherent volatility in the gas and vapor phase limit their usefulness. Accordingly, improved composition and methods are needed.

### SUMMARY OF THE INVENTION

Systems, compositions, methods, and methods of making compositions for release of one or more cyclopropene compounds are generally provided.

### BRIEF DESCRIPTION OF THE DRAWINGS

These and other objects and advantages of the invention will become apparent upon reading the detailed description and upon referring to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1 is a cross-section of a composition in accordance with a non-limiting embodiment.

FIG. 2 is a cross-section of a delivery material in accordance with a non-limiting embodiment.

### DETAILED DESCRIPTION

In the following description and accompanying figures, the same numerical references refer to similar elements throughout the figures and text. Furthermore, for the sake of simplicity and clarity, namely so as not to unduly burden the figures with several reference numbers, only certain figures have been provided with reference numbers, and components and features of the invention illustrated in other figures can be easily inferred therefrom. The embodiments, geometrical configurations, and/or dimensions shown in the figures are preferred for exemplification purposes only. Various features, aspects and advantages of the embodiments will become more apparent from the following detailed description.

Compositions, the use of compositions, and methods of making such compositions, for the release or controlled-release delivery of cyclopropenes are generally provided. In some embodiments, a composition is provided comprising a delivery material and a cyclopropene. In some embodiments, a composition is provided comprising a carbon-based delivery material and a cyclopropene compound. In some embodiments, one or more cyclopropene compounds may stored in and released from the delivery materials discussed herein.

The composition may be useful for applications in at least one of agriculture and food preservation. The composition may be useful to extend the shelf life of an agricultural product, improve the overall quality of the agricultural product, and/or may provide control over the product ripeness. In some embodiments, the compositions, the use of compositions, and methods of making compositions as described herein relate to the release or controlled-release delivery of vapor-phase or gas-phase cyclopropene compounds. Cyclopropene compounds are also referred to interchangeably herein as “cyclropropene” or “cyclopropenes”. Additionally, one or more cyclopropene compounds as used herein can mean one cyclopropene compound or more than one cyclopropene compound (e.g two cyclopropene compounds, three cyclopropene compounds, or more). A “vapor-phase cyclopropene” or “gas-phase cyclopropene” is a cyclopropene that is in the vapor-phase or gas phase, respectively, at the desired conditions (e.g. ambient room temperature (about 23° C.-25° C.) and atmospheric pressure).

Additional details regarding each of the components of the composition and related methods will now be described in detail.

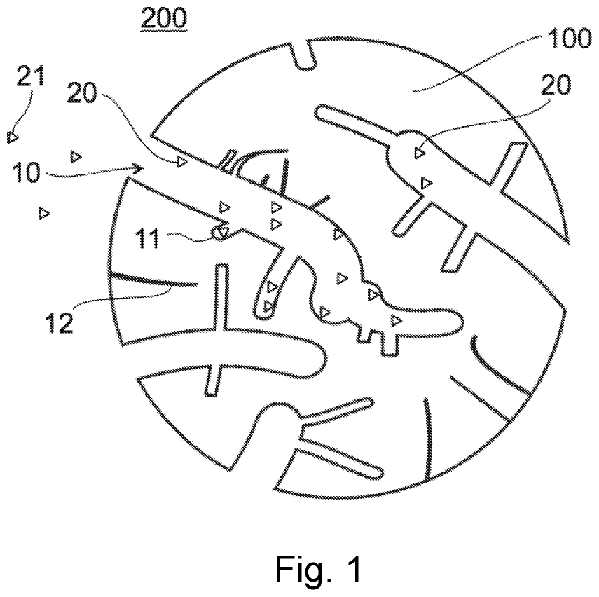

In some embodiments, when a delivery material has been charged with a cyclopropene or cycopropenes, the combination of the delivery material and the cyclopropene may be referred to herein as a matrix (and multiple such combinations, as matrices). In some embodiments, the delivery material is a carbon-based material. In an embodiment, a matrix comprises a carbon-based delivery material and at least one cyclopropene. In an embodiment, a matrix comprises a delivery material and at least one cyclopropene, the at least one cyclopropene contained within the delivery material. In an embodiment, a matrix comprises a carbon-based delivery material and at least one cyclopropene, the at least one cyclopropene contained within the carbon-based delivery material. In an embodiment, a matrix comprises a carbon-based delivery material and at least one cyclopropene, the at least one cyclopropene adsorbed by the carbon-based delivery material. In an embodiment, a matrix comprises a delivery material and at least one cyclopropene, the at least one cyclopropene adsorbed by the delivery material. In a non-limiting embodiment, a matrix consists essentially of a delivery material and at least one cyclopropene compound. In a non limiting embodiment, a matrix consists essentially of a carbon-based delivery material and at least one cyclopropene compound. In a non-limiting embodiment illustrated by FIG. 1, a matrix 200 is a composition comprising a cyclopropene 20 and a delivery material 100. FIG. 1 displays a non-limiting example of a delivery material 100 that is charged with cyclopropene 20. In an embodiment, delivery material 100 is a carbon-based material. In an embodiment, the matrix is configured for controlled release of at least one cyclopropene. In an embodiment, the cyclopropene is in the vapor phase or gas phase.

In some embodiments, the composition comprises a single cyclopropene compound. In other embodiments, the composition comprises more than one cyclopropene compound, for example, two different cyclopropene compound, three different cyclopropene compounds, four different cyclopropene compounds, or more. In some embodiments, when determining the weight percent of cyclopropene compound in the cyclopropene, the total weight of all cyclopropene compounds present in the composition is considered in determining the weight percent of cyclopropene and the weight or mass of the matrices described herein. In some embodiments, when determining the weight percent of cyclopropene compound in the cyclopropene, the total weight of all cyclopropene compounds present in and intended to be subsequently released from the composition is considered in determining the weight percent of cyclopropene and the weight or mass of the matrices described herein.

In some embodiments, the composition comprises a single delivery material. In other embodiments, the composition comprises more than one delivery material, for example, two different delivery materials, three different delivery materials, four different delivery materials, or more. In an embodiment, all delivery materials in the composition charged with and subsequently releasing cyclopropene compounds are considered the delivery material for determining the weight percent of cyclopropene and the weight or mass of a matrix as described herein.

In some embodiments, the weight percent of cyclopropene means the weight percent of cyclopropenes versus the total weight of the matrix (i.e., the matrix comprising the delivery material and the cyclopropene). In some cases, in non-limiting embodiments, the matrix comprises cyclopropene in a weight percent of at least about 0.01 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, versus the total weight of the matrix (e.g., the matrix comprising the delivery material and the cyclopropene). In some embodiments, cyclopropene is present in the matrix at between about 0.01 wt % and about 5 wt %, between about 0.01 wt % and about 10 wt %, between about 0.01 wt % and about 15 wt %, between about 0.01 wt % and about 20 wt %, between about 0.01 wt % and about 30 wt %, between about 0.05 wt % and about 5 wt %, between about 0.05 wt % and about 10 wt %, between about 0.05 wt % and about 20 wt %, between about 0.05 wt % and about 30 wt %, between about 0.1 wt % and about 5 wt %, between about 0.1 wt % and about 10 wt %, between about 0.1 wt % and about 20 wt %, between about 0.1 wt % and about 30 wt %, between about 0.5 wt % and about 5 wt %, between about 0.5 wt % and about 10 wt %, between about 0.5 wt % and about 20 wt %, between about 0.5 wt % and about 30 wt %, between about 1 wt % and about 5 wt %, between about 1 wt % and about 10 wt %, between about 1 wt % and about 15 wt %, between about 1 wt % and about 30 wt %, between about 1.5 wt % and about 3.5 wt %, between about 1.5 wt % and about 5 wt %, between about 1.5 wt % and about 10 wt %, between about 1.5 wt % and about 20 wt %, about 1.5 wt % and about 30 wt %, between about 2 wt % and about 3.5 wt %, between about 2 wt % and about 5 wt %, between about 2% and about 7 wt %, between about 2 wt % and about 10 wt %, between about 2 wt % and about 20 wt %, between about 2 wt % and about 30 wt %, between about 3 wt % and about 3.5 wt %, between about 3 wt % and about 5 wt %, between about 3 wt % and about 10 wt %, between about 3 wt % and about 20 wt %, between about 3 wt % and about 30 wt %, between about 5 wt % and about 10 wt %, or between about 5 wt % and about 30 wt %, versus the total weight of the matrix (e.g., the matrix comprising the delivery material and the cyclopropene).

In some embodiments, the weight percent of cyclopropene is indicated as the weight percent of cyclopropene versus the total weight of the matrix, (e.g., the total weight of the matrix being the total weight of the delivery material and the cyclopropene). In some cases, in non-limiting embodiments, the composition comprises cyclopropene in a weight percent of at least about 0.01 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, of the total weight of the matrix (e.g., the total weight of the delivery material and the cyclopropene). In some embodiments, cyclopropene is present in the composition at between about 0.01 wt % and about 5 wt %, between about 0.01 wt % and about 10 wt %, between about 0.01 wt % and about 15 wt %, between about 0.01 wt % and about 20 wt %, between about 0.01 wt % and about 30 wt %, between about 0.05 wt % and about 5 wt %, between about 0.05 wt % and about 10 wt %, between about 0.05 wt % and about 20 wt %, between about 0.05 wt % and about 30 wt %, between about 0.1 wt % and about 5 wt %, between about 0.1 wt % and about 10 wt %, between about 0.1 wt % and about 20 wt %, between about 0.1 wt % and about 30 wt %, between about 0.5 wt % and about 5 wt %, between about 0.5 wt % and about 10 wt %, between about 0.5 wt % and about 20 wt %, between about 0.5 wt % and about 30 wt %, between about 1 wt % and about 5 wt %, between about 1 wt % and about 10 wt %, between about 1 wt % and about 15 wt %, between about 1 wt % and about 30 wt %, between about 1.5 wt % and about 3.5 wt %, between about 1.5 wt % and about 5 wt %, between about 1.5 wt % and about 10 wt %, between about 1.5 wt % and about 20 wt %, about 1.5 wt % and about 30 wt %, between about 2 wt % and about 3.5 wt %, between about 2 wt % and about 5 wt %, between about 2% and about 7 wt %, between about 2 wt % and about 10 wt %, between about 2 wt % and about 20 wt %, between about 2 wt % and about 30 wt %, between about 3 wt % and about 3.5 wt %, between about 3 wt % and about 5 wt %, between about 3 wt % and about 10 wt %, between about 3 wt % and about 20 wt %, between about 3 wt % and about 30 wt %, between about 5 wt % and about 10 wt %, or between about 5 wt % and about 30 wt %, versus the total weight of the matrix (e.g., the total weight of the delivery material and the cyclopropene).

In some embodiments, where a carbon-based material is the delivery material, the weight percent of cyclopropene means the weight percent of cyclopropene versus the total weight of the matrix (e.g., the total weight of the matrix being the total weight of the carbon-based delivery material and the cyclopropene). In some cases, in non-limiting embodiments, the matrix comprises cyclopropene in a weight percent of at least about 0.01 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, versus the total weight of the matrix (e.g., the total weight of the carbon-based delivery material and the cyclopropene). In some embodiments, cyclopropene is present in the composition at between about 0.01 wt % and about 5 wt %, between about 0.01 wt % and about 10 wt %, between about 0.01 wt % and about 15 wt %, between about 0.01 wt % and about 20 wt %, between about 0.01 wt % and about 30 wt %, between about 0.05 wt % and about 5 wt %, between about 0.05 wt % and about 10 wt %, between about 0.05 wt % and about 20 wt %, between about 0.05 wt % and about 30 wt %, between about 0.1 wt % and about 5 wt %, between about 0.1 wt % and about 10 wt %, between about 0.1 wt % and about 20 wt %, between about 0.1 wt % and about 30 wt %, between about 0.5 wt % and about 5 wt %, between about 0.5 wt % and about 10 wt %, between about 0.5 wt % and about 20 wt %, between about 0.5 wt % and about 30 wt %, between about 1 wt % and about 5 wt %, between about 1 wt % and about 10 wt %, between about 1 wt % and about 15 wt %, between about 1 wt % and about 30 wt %, between about 1.5 wt % and about 3.5 wt %, between about 1.5 wt % and about 5 wt %, between about 1.5 wt % and about 10 wt %, between about 1.5 wt % and about 20 wt %, about 1.5 wt % and about 30 wt %, between about 2 wt % and about 3.5 wt %, between about 2 wt % and about 5 wt %, between about 2% and about 7 wt %, between about 2 wt % and about 10 wt %, between about 2 wt % and about 20 wt %, between about 2 wt % and about 30 wt %, between about 3 wt % and about 3.5 wt %, between about 3 wt % and about 5 wt %, between about 3 wt % and about 10 wt %, between about 3 wt % and about 20 wt %, between about 3 wt % and about 30 wt %, between about 5 wt % and about 10 wt %, or between about 5 wt % and about 30 wt %, versus the total weight of the matrix (e.g., the total weight of the carbon-based delivery material and the cyclopropene). In some embodiments, where activated carbon (or activated charcoal) is the delivery material, the weight percent of cyclopropene means the weight percent of cyclopropene versus the total weight of the matrix (e.g. the total weight of the matrix being the total weight of the activated carbon and the cyclopropene). In a non-limiting embodiment, the weight percent of cyclopropene means the weight percent of cyclopropene versus the total weight of the matrix, the matrix being a delivery material charged with cyclopropene, where the total weight of the matrix is the total weight of activated carbon (in the delivery material) and the cyclopropene. In some embodiments, where carbon black is the delivery material, the weight percent of cyclopropene means the weight percent of cyclopropene versus the total weight of the matrix (e.g. the total weight of the matrix being the total weight of the carbon black and the cyclopropene). In a non-limiting embodiment, the weight percent of cyclopropene means the weight percent of cyclopropene versus the total weight of the matrix, the matrix being a delivery material charged with cyclopropene, where the total weight of the matrix is the total weight of carbon black (in the delivery material) and the the cyclopropene. In some embodiments, the weight percent of cyclopropene means the weight percent of cyclopropene versus the total weight of the matrix, the matrix comprising a delivery material and cyclopropene, where the total weight of the matrix is the total weight of elemental carbon in the delivery material and the cyclopropene. In a non-limiting embodiment, the weight percent of cyclopropene means the weight percent of cyclopropene versus the total weight of the matrix, where the total weight of the matrix is the total weight of elemental carbon (in the delivery material) and the cyclopropene. In some cases, in non-limiting embodiments, the matrix comprises cyclopropene in a weight percent of at least about 0.01 wt %, at least about 0.05 wt %, at least about 0.1 wt %, at least about 0.5 wt %, at least about 1 wt %, at least about 1.5 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or more, versus the total weight of the matrix. In some embodiments, cyclopropene is present in the composition at between about 0.01 wt % and about 5 wt %, between about 0.01 wt % and about 10 wt %, between about 0.01 wt % and about 15 wt %, between about 0.01 wt % and about 20 wt %, between about 0.01 wt % and about 30 wt %, between about 0.05 wt % and about 5 wt %, between about 0.05 wt % and about 10 wt %, between about 0.05 wt % and about 20 wt %, between about 0.05 wt % and about 30 wt %, between about 0.1 wt % and about 5 wt %, between about 0.1 wt % and about 10 wt %, between about 0.1 wt % and about 20 wt %, between about 0.1 wt % and about 30 wt %, between about 0.5 wt % and about 5 wt %, between about 0.5 wt % and about 10 wt %, between about 0.5 wt % and about 20 wt %, between about 0.5 wt % and about 30 wt %, between about 1 wt % and about 5 wt %, between about 1 wt % and about 10 wt %, between about 1 wt % and about 15 wt %, between about 1 wt % and about 30 wt %, between about 1.5 wt % and about 3.5 wt %, between about 1.5 wt % and about 5 wt %, between about 1.5 wt % and about 10 wt %, between about 1.5 wt % and about 20 wt %, about 1.5 wt % and about 30 wt %, between about 2 wt % and about 3.5 wt %, between about 2 wt % and about 5 wt %, between about 2% and about 7 wt %, between about 2 wt % and about 10 wt %, between about 2 wt % and about 20 wt %, between about 2 wt % and about 30 wt %, between about 3 wt % and about 3.5 wt %, between about 3 wt % and about 5 wt %, between about 3 wt % and about 10 wt %, between about 3 wt % and about 20 wt %, between about 3 wt % and about 30 wt %, between about 5 wt % and about 10 wt %, or between about 5 wt % and about 30 wt %, versus the total weight of the matrix.

In some embodiments, the release characteristics of cyclopropene from a composition can be assessed by measuring the rate of release of cyclopropene from the composition over time. In some embodiments, the release characteristics of cyclopropene from a composition can be assessed by measuring concentration of cyclopropene released from the composition over time.

In embodiments where release characteristics of cyclopropene is assessed by measuring rate of release, the rate of release of cyclopropene is measured over time beginning at an hour zero, which may also be referred to as “time zero”. In a non-limiting embodiment, when using “hour zero” or “time zero” in a test to determine the rate of release of cyclopropene from a composition, “time zero” and “hour zero” are defined as the instant the composition is exposed to a non-equilibrium condition. In a non-limiting embodiment, when using “hour zero” or “time zero” in a test to determine the rate of release of cyclopropene, “hour zero” and “time zero” are defined as the instant a composition is exposed to 1) a liquid displacing medium, and 2) a non-equilibrium condition not necessarily in that order. In some embodiments, composition exposure to a liquid displacing medium is contact with a liquid displacing medium. In some embodiments, composition exposure to a liquid displacing medium comprises contact with a liquid displacing medium. In some embodiments, composition contact with a liquid displacing medium comprises agitation of a composition with a liquid displacing medium. In some embodiments, composition exposure to a liquid displacing medium comprises contact and agitation of a composition with a liquid displacing medium. In some embodiments, “hour zero” or “time zero” begin before agitation of the matrix and the liquid displacing medium. In some embodiments, “hour zero” or “time zero” begin after agitation of the matrix and the liquid displacing medium. In some embodiments, “hour zero” or “time zero” begin after sufficient agitation of the matrix and the liquid displacing medium. In some embodiments, “hour zero” or “time zero” begin after agitation of the matrix and liquid displacing medium slurry. In some embodiments, agitation of the matrix and the liquid displacing medum occurs after time zero but before the first sample timepoint (e.g. hour 1).

In embodiments where release characteristics of the cyclopropene from a composition is assessed by concentration, the concentration of cyclopropene released is measured over time after contact with a liquid displacing medium at “time zero.” In a non-limiting embodiment, when using “time zero” in a test to determine the concentration of cyclopropene released from a composition, “time zero” is defined as the instant a composition is exposed to a liquid displacing medium. In a non-limiting embodiment, when using “time zero” in a test to determine the concentration of cyclopropene released from a composition, “time zero” is defined as the instant a composition is exposed to 1) a liquid displacing medium, and 2) a non-equilibrium condition not necessarily in that order. In some embodiments, composition exposure to a liquid displacing medium is contact with a liquid displacing medium. In some embodiments, composition exposure to a liquid displacing medium comprises contact with a liquid displacing medium. In some embodiments, composition contact with a liquid displacing medium comprises agitation of a composition with a liquid displacing medium. In some embodiments, composition exposure to a liquid displacing medium comprises contact and agitation of a composition with a liquid displacing medium. In some embodiments, “time zero” begins before agitation of the matrix and the liquid displacing medium. In some embodiments, “time zero” begins after agitation of the matrix and the liquid displacing medium. In some embodiments, “time zero” begins after sufficient agitation of the matrix and the liquid displacing medium. In some embodiments, “time zero” begins after agitation of the matrix and liquid displacing medium slurry. In some embodiments, agitation of the matrix and the liquid displacing medum occurs after time zero but before the first sample timepoint (e.g. minute 1).

For tests measuring both rate of release and concentration characteristics of cyclopropene from a composition, in some embodiments, a non-equilibrium condition occurs at all temperatures and pressures at which the cyclopropene has vapor pressure. In general, a composition is exposed to an equilibrium condition via exposure to a gaseous atmosphere that triggers cyclopropene release due to vapor pressure. In some embodiments, exposure to a non-equilibrium condition is a condition that is not a liquid displacing medium. In an non-limiting example, the exposure of a composition containing a cyclopropene to an atmosphere containing zero (0) ppm of that cyclopropene will trigger the release of the cyclopropene until an equilibrium concentration of that cyclopropene is reached between the composition and the atmosphere. In a non-limiting embodiment, a non-equilibrium condition occurs when a composition comprising a cyclopropene is exposed to an atmosphere containing zero (0) ppm of that cyclopropene. In a non-limiting embodiment, a non-equilibrium condition occurs when a composition comprising a cyclopropene is exposed to an atmosphere containing about one (1) ppb or less of the cyclopropene. In a non-limiting embodiment, a non-equilibrium condition occurs when a composition comprising a cyclopropene is exposed to an atmosphere containing about one (1) ppm or less of the cyclopropene. In a non-limiting embodiment, a non-equilibrium condition occurs when a composition comprising a cyclopropene is exposed to an atmosphere containing about ten (10) ppm or less of the cyclopropene. In a non-limiting embodiment, a non-equilibrium condition occurs when a composition comprising a cyclopropene is exposed to an atmosphere containing about fifty (50) ppm or less of the cyclopropene. In a non-limiting embodiment, a non-equilibrium condition occurs when a composition comprising a cyclopropene is exposed to an atmosphere containing about one hundred (100) ppm or less of the cyclopropene. In a non-limiting embodiment, a non-equilibrium condition occurs when a composition comprising a cyclopropene is exposed to an atmosphere containing about one thousand (1000) ppm or less of the cyclopropene. In a non-limiting embodiment, a non-equilibrium condition occurs when a composition comprising a cyclopropene is exposed to an atmosphere containing about ten thousand (10,000) ppm or less of the cyclopropene. In a non-limiting embodiment, a non-equilibrium condition occurs when a composition comprising a cyclopropene is exposed to an atmosphere containing about one (1) ppb-ten (10) ppm of the cyclopropene. In a non-limiting embodiment, a non-equilibrium condition occurs when a composition comprising a cyclopropene is exposed to an atmosphere containing about one (1) ppb-one hundred (100) ppm of the cyclopropene. In a non-limiting embodiment, a non-equilibrium condition occurs when a composition comprising a cyclopropene is exposed to an atmosphere containing about one (1) ppb-one thousand (1000) ppm of the cyclopropene.

Non-limiting examples of instances when a composition and/or cyclopropene compound is likely exposed to a non-equilibrium condition include: immediately after removal from a low temperature (for example, −4° C. or lower) and transfer to a higher temperature (for example, ambient room temperature), immediately after removal from a very low temperature (for example −20° C. or lower) and transfer to a higher temperature (for example, ambient room temperature), immediately after the cyclopropene compound is removed from an outer packaging and exposed to atmosphere, immediately after a structure or form factor containing the composition is removed from a further outer packaging, immediately after the composition has been removed from a hermetically sealed or gas impermeable container.

In some embodiments, no solvent or external wetting or hydrating is required to liberate cyclopropene from the matrices described herein. In some embodiments, when the matrix material is in a non-equilibrium condition, no solvent or external wetting or hydrating is required to liberate cyclopropene from the matrices described herein. However, regarding matrix exposure to a liquid displacing medium, in some embodiments, matrix (e.g. the matrix comprising a delivery material and a cyclopropene or the matrix being a delivery material and a cyclopropene) exposure to or contact with a liquid displacing medium modifies the release characteristics of cyclopropene from the matrix versus the release characteristics of the cyclopropene from the matrix merely in a non-equilibrium condition. In some embodiments, the modification of release is immediate (e.g. within seconds or minutes of matrix exposure to the liquid displacing medium). In some embodiments, modification of the release characteristics is acceleration of release of cyclopropene from the matrix. In some embodiments, modification of the release characteristics is deceleration of release of cyclopropene from the matrix.

In some embodiments, exposure of the matrix to a liquid displacing medium accelerates the release rate of the cyclopropene from the matrix in a non-equilibrium condition versus the release rate of the cyclopropene from the matrix merely in the non-equilibrium condition. In some embodiments, exposure of the matrix to a liquid displacing medium decelerates the release rate of the cyclopropene in the non-equilibrium condition from the matrix versus the release rate of the cyclopropene from the matrix merely in the non-equilibrium condition. In some embodiments, exposure of the matrix to a liquid displacing medium accelerates the release rate of the cyclopropene from the matrix versus the release rate of the cyclopropene from the matrix merely in a non-equilibrium condition. In some embodiments, exposure of the matrix to a liquid displacing medium decelerates the release rate of the cyclopropene from the matrix versus the release rate of the cyclopropene from the matrix merely in a non-equilibrium condition. In some embodiments, the acceleration of release rate is immediate (e.g. within seconds or minutes of matrix exposure to the liquid displacing medium). In some embodiments, the deceleration of release rate is immediate (e.g. within seconds or minutes of matrix exposure to the liquid displacing medium).

As would be appreciated by one of ordinary skill in the art, a liquid displacing medium is in the liquid-phase upon contact with the matrix. In a non-limiting embodiment, the liquid displacing medium comprises water. In a non-limiting embodiment, the liquid displacing medium is water. In a non-limiting embodiment, the liquid displacing medium comprises water in which at least one electrolyte or ionic compound has been dissolved. In a non-limiting embodiment, the liquid displacing medium is water in which at least one electrolyte or ionic compound has been dissolved. In a non-limiting embodiment, the at least one electrolyte or ionic compound comprises a saturated solution of salt or salts such as, but not limited to, sodium chloride, sodium bicarbonate, or ammonium chloride. In a non-limiting embodiment, the at least one electrolyte or ionic compound is a saturated solution of salt or salts such as, but not limited to, sodium chloride, sodium bicarbonate, or ammonium chloride. In a non-limiting embodiment, the liquid displacing medium comprises an alcohol. In a non-limiting embodiment, the liquid displacing medium is an alcohol. In a non-limiting embodiment, the liquid displacing medium comprises methanol. In a non-limiting embodiment, the liquid displacing medium is methanol. In a non-limiting embodiment, the liquid displacing medium comprises ethanol. In a non-limiting embodiment, the liquid displacing medium is ethanol. In a non-limiting embodiment, the liquid displacing medium comprises isopropanol. In a non-limiting embodiment, the liquid displacing medium is isopropanol. In a non-limiting embodiment, the liquid displacing medium comprises butanol. In a non-limiting embodiment, the liquid displacing medium is butanol. In a non-limiting embodiment, the liquid displacing medium comprises glycerol. In a non-limiting embodiment, the liquid displacing medium is glycerol. In a non-limiting embodiment, the liquid displacing medium comprises acetone. In a non-limiting embodiment, the liquid displacing medium is acetone. In a non-limiting embodiment, the liquid displacing medium comprises ethyl acetate. In a non-limiting embodiment, the liquid displacing medium is ethyl acetate. In a non-limiting embodiment, the liquid displacing medium comprises a hydrocarbon solvent. In a non-limiting embodiment, the liquid displacing medium is a hydrocarbon solvent. In a non-limiting embodiment, the liquid displacing medium comprises a light hydrocarbon solvent. In a non-limiting embodiment, the liquid displacing medium is a light hydrocarbon solvent. In a non-limiting embodiment, the light hydrocarbon solvent comprises pentane. In a non-limiting embodiment, the light hydrocarbon solvent is pentane. In a non-limiting embodiment, the light hydrocarbon solvent comprises hexane. In a non-limiting embodiment, the light hydrocarbon solvent is hexane. In a non-limiting embodiment, the light hydrocarbon solvent comprises heptane. In a non-limiting embodiment, the light hydrocarbon solvent is heptane. In a non-limiting embodiment, the light hydrocarbon solvent comprises toluene. In a non-limiting embodiment, the light hydrocarbon solvent is toluene. In some embodiments, the liquid displacing medium comprises an organic chemical. In a non-limiting embodiment, the liquid displacing medium is an organic chemical.

In certain embodiments, it is particularly advantageous to use a liquid displacing medium to effect release from the compositions discussed herein. In a non-limiting alternative embodiment, a vapor displacing medium is exposed to the matrix in order to modify release. In an embodiment, a vapor displacing medium is water vapor.

Delivery materials as described herein are not soluble in liquid displacing mediums. In some embodiments, a liquid displacing medium as described cannot be considered a solvent or buffer and is not capable of dissolving the delivery material. In some embodiments, the liquid displacing medium has no absorptive, adsorptive, or dissolutive ability to store the cyclopropene. In some embodiments, the liquid displacing medium has no substantial ability to absorb the cyclopropene. In some embodiments, the liquid displacing medium has no substantial ability to adsorb the cyclopropene. In some embodiments, the liquid displacing medium has no substantial ability to dissolve the cyclopropene. As would be appreciated by one of ordinary skill in the art, a delivery material insoluble in a liquid displacing medium could exhibit some insubstantial amount of solubility. In some embodiments, the solubility of the delivery material in the liquid displacing medium is less than 1 g/L, or less than 0.5 g/L, or less than 0.1 g/L, less than 0.05 g/L, or less than 0.01 g/L at 25° C. and 1 atm pressure. In some embodiments, the solubility of the delivery material in the liquid displacing medium is 0 g/L at 25° C. and 1 atm pressure.

In an embodiment, the matrix comprises a carbon-based delivery material and a cyclopropene, the cyclopropene is 1-methylcyclopropene (1-MCP), and the liquid displacing medium is water. In an embodiment, the matrix comprises a carbon-based delivery material and a cyclopropene, the cyclopropene is 1-MCP, and the liquid displacing medium is ethanol. In an embodiment, the matrix comprises a carbon-based delivery material and a cyclopropene, the cyclopropene is 1-MCP, and the liquid displacing medium is isopropanol.

In some embodiments, the composition releases the one or more cyclopropenes at at least one temperature between about −2° C. and about 40° C., or at least one temperature between about −0.05° C. and about 20° C., or at least one temperature between about 0° C. and about 40° C. In some embodiments, the composition releases the one or more cyclopropenes at at least 25%, at least 50%, at least 75%, at least 90%, or at least 95% of the temperatures between about −2 C and about 40 C, or between about −0.05° C. and about 20° C., or between about 0° C. and about 40° C. In certain embodiments, the composition releases the one or more cyclopropenes at all of the temperatures between about −2° C. and about 40° C., or between about −0.05° C. and about 20° C., or between about 0° C. and about 40° C. In a non-limiting embodiment, cyclopropene is released from the compositions described herein at all temperatures from −2° C.-40° C. at atmospheric pressure. In a non-limiting embodiment, cyclopropene is released from the compositions described herein at all temperatures from 0° C.-40° C. at atmospheric pressure.

### Rate of Release

The release rates of cyclopropene out of the compositions described herein are, unless otherwise stated, reported in relation to the amount of cyclopropene (e.g. as a volume or mass) released per gram of matrix (i.e. the matrix being the delivery material and the cyclopropene) per unit time. In some embodiments, the mass (e.g. in grams) of the matrix used in the calculation to report release rate is the matrix (e.g. the matrix being the delivery material charged with cyclopropene) measured in grams immediately prior to hour zero of the release test. The release characteristics for the compositions described herein as indicated by release rate of cyclopropene are given for release tests starting “hour zero” conditions. In some embodiments, “hour zero” means composition exposure to a non-equilibrium condition. In some embodiments, “hour zero” means composition 1) exposure to a liquid displacing medium, and 2) exposure to a non-equilibrium condition, not necessarily in that order. In some embodiments, composition exposure to a liquid displacing medium is contact with a liquid displacing medium. In some embodiments, composition exposure to a liquid displacing medium comprises contact with a liquid displacing medium. In some embodiments, composition contact with a liquid displacing medium comprises agitation of a composition with a liquid displacing medium. In some embodiments, composition exposure to a liquid displacing medium comprises contact and agitation of a composition with a liquid displacing medium. In some embodiments, “hour zero” or “time zero” begin before agitation of the matrix and the liquid displacing medium. In some embodiments, “hour zero” or “time zero” begin after agitation of the matrix and the liquid displacing medium. In some embodiments, “hour zero” or “time zero” begins after sufficient agitation of the matrix and the liquid displacing medium. In some embodiments, “hour zero” or “time zero” begin after agitation of the matrix and liquid displacing medium slurry. In some embodiments, agitation of the matrix and the liquid displacing medum occurs after time zero but before the first sample timepoint (e.g. hour 1). In an embodiment, exposure to a non-equilibrium condition is a condition that is not a liquid displacing medium. A non-limiting example of exposure to a non-equilibrium condition is composition exposure to ambient room temperature (approximately 23-25° C.) and atmospheric pressure, with none of the cyclopropene detected in the atmosphere prior to commencement of the release test. It should be understood that throughout the duration of the release test, temperature and atmospheric pressure around the composition material is kept substantially constant. It should be further understood that the atmospheric concentration of the cyclopropene may vary throughout the duration of the release test as the cyclopropene is released from the composition into the surrounding atmosphere.

In some embodiments wherein quantification of cyclopropene release rate from the composition reported as an amount of cyclopropene (e.g. a volume or mass) released per gram of matrix (i.e. the matrix being the delivery material and the cyclopropene) per unit time, the rate of release is reported on a per hour basis. The rate of release of cyclopropene per gram of composition per hour may be determined for a particular hour (e.g. hour 22) by measuring the amount of cyclopropene released from the composition over a period of time (e.g. sixty (60) minutes) immediately preceding the particular hour (e.g. hour 22) at which the rate is reported. For example, the release rate on a per hour basis reported for hour 22 is calculated based on the amount (e.g. as a volume or mass) of cyclopropene released from a composition during the sixty (60) minutes which commences at hour 21 and ending at hour 22. The amount of cyclopropene released from the composition (e.g. calculated as a volume or a mass of cyclopropene released during that period of sixty (60) minutes) is then divided by the total mass of the matrix (e.g. as measured in grams) prior to hour zero of the release test to arrive at a release rate as an amount of cyclopropene released per gram of matrix per hour. As would be appreciated by one of ordinary skill of the art, the total mass of the matrix measured prior to hour zero, also known as the total mass of matrix initially measured or known, is the total mass of the matrix prior to exposure to a liquid displacing medium.

A non-limiting example of how to measure the release rate of a cyclopropene from a composition at hour 1 is as follows. The mass of the matrix (e.g. the matrix being a delivery material charged with cyclopropene) to be studied is measured or known (e.g. in grams). The release study commences at hour zero when the composition is either a) exposed to a non-equilibrium condition, or b) exposed to a liquid displacing medium and a non-equilibrium condition, as the case may be, as discussed above. In a non-limiting embodiment, “hour zero” as it relates to composition exposure to a liquid displacing medium may begin after a vial, jar, or container containing the matrix (comprising a delivery material and the cyclopropene) and the liquid displacing medium has been sufficiently agitated, for example, for about 30 seconds, for about 1 minute, or about 5 minutes, or about 10 minutes, or about 15 minutes, or about 20 minutes.

The cyclopropene released from the composition over the subsequent sixty (60) minutes is collected (e.g. in a sealed vial) and sampled (e.g. using conventional headspace methodologies) at hour 1, which occurs sixty (60) minutes after hour zero. The sample of the cyclopropene collected is then measured (e.g. using a gas chromatograph (GC)). The amount (e.g. as a volume or mass) of cyclopropene released as calculated from the GC measurement is then divided by the total mass of the matrix (e.g. in grams) as initially measured or known, as discussed above. The resulting numerical figure is the amount (e.g. as a volume or mass) of the cyclopropene released per gram matrix per hour at hour 1.

A non-limiting example of how to measure the release rate of a cyclopropene from the same composition (e.g. during the same release test) at hour 22 is as follows. After the cyclopropene collected over the sixty (60) minutes commencing at hour zero and ending at hour 1 is sampled at hour 1, the vial is left open to allow the cyclopropene to escape. At sixty (60) minutes prior to the next sample time (e.g. hour 22 in this case) the vial is again sealed to allow the cyclopropene to collect for one hour. In other words, the vial is sealed at hour 21 in anticipation of a measurement sample to be taken at hour 22. The cyclopropene released from the composition during the sixty (60) minutes from hour 21 to hour 22 is collected and promptly sampled (e.g. using conventional headspace methodologies) at hour 22. The sample of the cyclopropene collected is then measured using GC analysis. The amount (e.g. as a volume or mass) of the cyclopropene released as calculated from the GC measurement is then divided by the mass of the matrix as initially measured or known (e.g. the same matrix mass used in the calculation for hour 1). The resulting numerical figure is the amount (e.g. as a volume or mass) of the cyclopropene released per gram matrix per hour at hour 22.

Those with ordinary skill in the art will be aware of conventional headspace methodologies that use, for example, gas chromatography (GC). A non-limiting example of a method that uses headspace analysis to measure release rate of cyclopropene is provided as follows. The composition or a sample of the matrix comprising the cyclopropene, is placed in a vial for analysis (e.g. at hour zero, when the composition is either a) exposed to a non-equilibrium condition, or b) exposed to a liquid displacing medium and a non-equilibrium condition, and the vial may be sealed. The rate of release may be calibrated based on the number of hours or minutes that the cyclopropene is permitted to build up in the vial while the vial is sealed. For a period of time (e.g. one (1) hour) prior to each sampling time point, the vapor/gas phase cyclopropene may be permitted to build up in the vial. At all other times, the vial may be left open to allow the cyclopropene to escape. Doing so may reduce and/or eliminate any effects of equilibrium adsorption. Depending on the length of time the cyclopropene is permitted to build-up while the vial is sealed, the rate of release at a given time point can be calculated by sampling the headspace of the vial and injecting a sample volume (e.g. 100 μL to 300 μL) in a GC in accordance with methods known to those of ordinary skill in the art. The area of the GC peak may be calibrated by comparison against an internal standard. For example, for calculating the release of 1-methylcyclopropene (1-MCP) from a matrix, the area of the GC peak may be calibrated against known quantities of 1-MCP released from ETHYLBLOC™ (FLORALIFE; Walterboro, S.C.). 1-MCP in the form of ETHYLBLOC™ is obtainable as a 0.14 wt % solid powder.

As discussed above, release may be quantified as a rate of release, which may be reported as an amount of cyclopropene (as a volume or mass, for example) released per gram of matrix per hour (μL cyclopropene/g matrix/hr). In some embodiments, the rate of release reported is the amount (e.g. as a volume or mass) of cyclopropene released per gram of matrix during the hour (e.g. sixty (60) minutes) leading up to the sample time point. In some embodiments, upon and/or after exposing the composition to a liquid displacing medium, the rate at which the cyclopropene is released is modified relative to the rate at which the cyclopropene was being released by the composition prior to the exposure of the composition to the liquid displacing medium. In some embodiments, upon and/or after exposing the composition to a liquid displacing medium, the rate at which the cyclopropene is released is accelerated relative to the rate at which the cyclopropene was being released by the composition prior to the exposure of the composition to the liquid displacing medium. In some embodiments, upon and/or after exposing the composition to a liquid displacing medium, the rate at which the cyclopropene is released is decelerated relative to the rate at which the cyclopropene was being released by the composition prior to the exposure of the composition to the liquid displacing medium.

In some embodiments, a composition that initially control releases a cyclopropene upon exposure to a non-equilibrium condition that is not a liquid displacing medium subsequently accelerates cyclopropene release after or upon exposure to a liquid displacing medium. In some embodiments, a composition that initially control releases a cyclopropene upon exposure to a non-equilibrium condition that is not a liquid displacing medium subsequently decelerates cyclopropene release after or upon exposure to a liquid displacing medium.

In some embodiments, a composition having a first release rate of cyclopropene at a particular timepoint (e.g., hour 1, hour 22) after time zero exposure to a non-equilibrium condition has a second release rate at the same particular timepoint after time zero exposure to a liquid displacing medium and the non-equilibrium condition. For example, in an embodiment, a sample of a composition is exposed to a non-equilibrium condition (e.g. air) at time zero, the composition having a first release rate of cyclopropene one hour after the exposure to the non-equlibrium condition (air, in this example); another sample of the composition is exposed to the non-equilibrium condition (air, in this example) and to a liquid displacing medium at time zero, the composition having a second release rate of cyclopropene one hour after the exposure to the non-equilibrium condition (air, in this example and to the liquid displacing medium In some embodiments, composition exposure to a liquid displacing medium is contact with a liquid displacing medium. In some embodiments, composition exposure to a liquid displacing medium comprises contact with a liquid displacing medium. In some embodiments, composition contact with a liquid displacing medium comprises agitation of a composition with a liquid displacing medium. In some embodiments, composition exposure to a liquid displacing medium comprises contact and agitation of a composition with a liquid displacing medium. In some embodiments, agitation of the matrix and the liquid displacing medium occurs after time zero. In some embodiments, agitation of the matrix and the liquid displacing medum occurs after time zero but before the first sample timepoint (e.g. hour 1). In an embodiment, the second release rate is lower than the first release rate. In an alternative embodiment, the second release rate is higher than the first release rate.

In some embodiments, the following rates of release pertain to controlled release or initial control release parameters of cyclopropene from the compositions described herein. In some embodiments, the following rates of cyclopropene release are a first release rate of cyclopropene. In some embodiments, the following rates of cyclopropene release are a second release rate of cyclopropene. In some embodiments, the following rates of release are given for conditions where “time zero” (a.k.a. “hour zero”) means composition exposure to a non-equilibrium condition. In some embodiments, the following rates of release are given for conditions where “time zero” (a.k.a. “hour zero”) means composition exposure to a non-equilibrium condition and a liquid displacing medium.

In some embodiments, the rate of release of active ingredient at hour 1 is at least about 0.1 μL/g matrix/hr. In some embodiments, the rate of release of cyclopropene at hour 1 is at least about 1 μL/g matrix/hr. In some embodiments, the rate of release of cyclopropene at hour 1 is at least about 2 μL/g matrix/hr. In some embodiments, the rate of release of cyclopropene at hour 1 is at least about 3 μL/g matrix/hr. In some embodiments, the rate of release of cyclopropene at hour 1 is at least about 4 μL/g matrix/hr. In some embodiments, the rate of release of cyclopropene at hour 1 is at least about 5 μL/g matrix/hr. In some embodiments, the rate of release of cyclopropene at hour 1 is at least about 10 μL/g matrix/hr. In some embodiments, the rate of release of cyclopropene at hour 1 is at least about 25 μL/g matrix/hr. In some embodiments, the rate of release of cyclopropene at hour 1 is at least about 30 μL/g matrix/hr. In some embodiments, the rate of release of cyclopropene at hour 1 is at least about 35 μL/g matrix/hr. In some embodiments, the rate of release of cyclopropene at hour 1 is at least about 40 μL/g matrix/hr. In some embodiments, the rate of release of cyclopropene at hour 1 is at least about 45 μL/g matrix/hr. In some embodiments, the rate of release of cyclopropene at hour 1 is at least about 50 μL/g matrix/hr. In some embodiments, the rate of release of cyclopropene at hour 1 is at least about 55 μL/g matrix/hr. In some embodiments, the rate of release of cyclopropene at hour 1 is at least about 25 μL/g matrix/hr. In some embodiments, the rate of release of cyclopropene at hour 1 is between about 0.1 μL/g matrix/hr and about 65 μL/g matrix/hr. In some embodiments, the rate of release of cyclpropene at hour 1 is between about 0.1 μL/g matrix/hr and about 75 μL/g matrix/hr. In some embodiments, the rate of release of cyclopropene at hour 1 is between about 1 μL/g matrix/hr and about 65 μL/g matrix/hr. In some embodiments, the rate of release of cyclopropene at hour 1 is between about 1 μL/g matrix/hr and about 75 μL/g matrix/hr. In some embodiments, the rate of release of cyclopropene at hour 1 is between about 2 μL/g matrix/hr and about 65 μL/g matrix/hr. In some embodiments, the rate of release of cyclopropene at hour 1 is between about 2 μL/g matrix/hr and about 75 μL/g matrix/hr. In some embodiments, the rate of release of cyclopropene at hour 1 is between about 3 μL/g matrix/hr and about 65 μL/g matrix/hr. In some embodiments, the rate of release of cyclopropene at hour 1 is between about 3 μL/g matrix/hr and about 75 μL/g matrix/hr. In some embodiments, the rate of release of cyclopropene at hour 1 is between about 4 μL/g matrix/hr and about 65 μL/g matrix/hr. In some embodiments, the rate of release of cyclopropene at hour 1 is between about 4 μL/g matrix/hr and about 75 μL/g matrix/hr. In some embodiments, the rate of release of cyclopropene at hour 1 is between about 5 μL/g matrix/hr and about 65 μL/g matrix/hr. In some embodiments, the rate of release of cyclopropene at hour 1 is between about 5 μL/g matrix/hr and about 75 μL/g matrix/hr. In some embodiments, the rate of release of cyclopropene at hour 1 is between about 7 μL/g matrix/hr and about 65 μL/g matrix/hr. In some embodiments, the rate of release of cyclopropene at hour 1 is between about 7 μL/g matrix/hr and about 75 μL/g matrix/hr. In some embodiments, the rate of release of cyclopropene at hour 1 is between about 10 μL/g matrix/hr and about 65 μL/g matrix/hr. In some embodiments, the rate of release of cyclopropene at hour 1 is between about 10 μL/g matrix/hr and about 75 μL/g matrix/hr. In some embodiments, the rate of release of cyclopropene at hour 1 is between about 25 μL/g matrix/hr and about 75 μL/g matrix/hr. In some embodiments, the rate of release of cyclopropene at hour 1 is between about 25 μL/g matrix/hr and about 65 μL/g matrix/hr. In some embodiments, the rate of release of cyclopropene at hour 1 is between about 25 μL/g matrix/hr and about 60 μL/g matrix/hr. In some embodiments, the rate of release of cyclopropene at hour 1 is between about 30 μL/g matrix/hr and about 75 μL/g matrix/hr. In some embodiments, the rate of release of cyclopropene at hour 1 is between about 30 μL/g matrix/hr and about 65 μL/g matrix/hr. In some embodiments, the rate of release of cyclopropene at hour 1 is between about 30 μL/g matrix/hr and about 60 μL/g matrix/hr. In some embodiments, the rate of release of cyclopropene at hour 1 is between about 30 μL/g matrix/hr and about 500 μL/g matrix/hr. In some embodiments, the rate of release of cyclopropene at hour 1 is between about 40 μL/g matrix/hr and about 500 μL/g matrix/hr. In some embodiments, the rate of release of cyclopropene at hour 1 is between about 50 μL/g matrix/hr and about 500 μL/g matrix/hr. In some embodiments, the rate of release of cyclopropene at hour 1 is between about 75 μL/g matrix/hr and about 500 μL/g matrix/hr. In some embodiments, the rate of release of cyclopropene at hour 1 is between about 100 μL/g matrix/hr and about 500 μL/g matrix/hr. In some embodiments, the rate of release of cyclopropene at hour 1 is between about 200 μL/g matrix/hr and about 500 μL/g matrix/hr. In some embodiments, the rate of release of cyclopropene at hour 1 is between about 300 μL/g matrix/hr and about 500 μL/g matrix/hr. In some embodiments, the rate of release of cyclopropene at hour 1 is between about 40 μL/g matrix/hr and about 1000 μL/g matrix/hr. In some embodiments, the rate of release of cyclopropene at hour 1 is between about 50 μL/g matrix/hr and about 1000 μL/g matrix/hr. In some embodiments, the rate of release of cyclopropene at hour 1 is between about 75 μL/g matrix/hr and about 1000 μL/g matrix/hr. In some embodiments, the rate of release of cyclopropene at hour 1 is between about 100 μL/g matrix/hr and about 1000 μL/g matrix/hr. In some embodiments, the rate of release of cyclopropene at hour 1 is between about 200 μL/g matrix/hr and about 1000 μL/g matrix/hr. In some embodiments, the rate of release of cyclopropene at hour 1 is between about 300 μL/g matrix/hr and about 1000 μL/g matrix/hr. In some embodiments, the rate of release of cyclopropene at hour 1 is between about 35 μL/g matrix/hr and about 75 μL/g matrix/hr. In some embodiments, the rate of release of cyclopropene at hour 1 is between about 35 μL/g matrix/hr and about 65 μL/g matrix/hr. In some embodiments, the rate of release of cyclopropene at hour 1 is between about 35 μL/g matrix/hr and about 60 μL/g matrix/hr. In some embodiments, the rate of release of cyclopropene at hour 1 is between about 40 μL/g matrix/hr and about 60 μL/g matrix/hr. In some embodiments, the rate of release of cyclopropene at hour 1 is between about 40 μL/g matrix/hr and about 65 μL/g matrix/hr. In some embodiments, the rate of release of cyclopropene at hour 1 is between about 40 μL/g matrix/hr and about 75 μL/g matrix/hr. In some embodiments, the rate of release of cyclopropene at hour 1 is between about 45 μL/g matrix/hr and about 60 μL/g matrix/hr. In some embodiments, the rate of release of cyclopropene at hour 1 is between about 45 μL/g matrix/hr and about 65 μL/g matrix/hr. In some embodiments, the rate of release of cyclopropene at hour 1 is between about 45 μL/g matrix/hr and about 75 μL/g matrix/hr. In some embodiments, the rate of release of cyclopropene at hour 1 is between about 50 μL/g matrix/hr and about 60 μL/g matrix/hr. In some embodiments, the rate of release of cyclopropene at hour 1 is between about 50 μL/g matrix/hr and about 65 μL/g matrix/hr. In some embodiments, the rate of release of cyclopropene at hour 1 is between about 50 μL/g matrix/hr and about 75 μL/g matrix/hr. In some embodiments, the rate of release of cyclopropene at hour 1 is between about 25 μL/g matrix/hr and about 100 μL/g matrix/hr. In some embodiments, the rate of release of cyclopropene at hour 1 is between about 30 μL/g matrix/hr and about 100 μL/g matrix/hr. In some embodiments, the rate of release of active ingredient at hour 2 is at least about 0.1 μL/g matrix/hr. In some embodiments, the rate of release of cyclopropene at hour 2 is at least about 1 μL/g matrix/hr. In some embodiments, the rate of release of cyclopropene at hour 2 is at least about 2 μL/g matrix/hr. In some embodiments, the rate of release of cyclopropene at hour 2 is at least about 3 μL/g matrix/hr. In some embodiments, the rate of release of cyclopropene at hour 2 is at least about 4 μL/g matrix/hr. In some embodiments, the rate of release of cyclopropene at hour 2 is at least about 5 μL/g matrix/hr. In some embodiments, the rate of release of cyclopropene at hour 2 is at least about 10 μL/g matrix/hr. In some embodiments, the rate of release of cyclopropene at hour 2 is at least about 25 μL/g matrix/hr. In some embodiments, the rate of release of cyclopropene at hour 2 is at least about 30 μL/g matrix/hr. In some embodiments, the rate of release of cyclopropene at hour 2 is at least about 35 μL/g matrix/hr. In some embodiments, the rate of release of cyclopropene at hour 2 is at least about 40 μL/g matrix/hr. In some embodiments, the rate of release of cyclopropene at hour 2 is at least about 45 μL/g matrix/hr. In some embodiments, the rate of release of cyclopropene at hour 2 is at least about 50 μL/g matrix/hr. In some embodiments, the rate of release of cyclopropene at hour 2 is at least about 55 μL/g matrix/hr. In some embodiments, the rate of release of active ingredient at hour 3 is at least about 0.1 μL/g matrix/hr. In some embodiments, the rate of release of cyclopropene at hour 3 is at least about 1 μL/g matrix/hr. In some embodiments, the rate of release of cyclopropene at hour 3 is at least about 2 μL/g matrix/hr. In some embodiments, the rate of release of cyclopropene at hour 1 is at least about 3 μL/g matrix/hr. In some embodiments, the rate of release of cyclopropene at hour 3 is at least about 4 μL/g matrix/hr. In some embodiments, the rate of release of cyclopropene at hour 3 is at least about 5 μL/g matrix/hr. In some embodiments, the rate of release of cyclopropene at hour 3 is at least about 10 μL/g matrix/hr. In some embodiments, the rate of release of cyclopropene at hour 3 is at least about 25 μL/g matrix/hr. In some embodiments, the rate of release of cyclopropene at hour 3 is at least about 30 μL/g matrix/hr. In some embodiments, the rate of release of cyclopropene at hour 3 is at least about 35 μL/g matrix/hr. In some embodiments, the rate of release of cyclopropene at hour 3 is at least about 40 μL/g matrix/hr. In some embodiments, the rate of release of cyclopropene at hour 3 is at least about 45 μL/g matrix/hr. In some embodiments, the rate of release of cyclopropene at hour 3 is at least about 50 μL/g matrix/hr. In some embodiments, the rate of release of cyclopropene at hour 3 is at least about 55 μL/g matrix/hr. In some embodiments, the rate of release of active ingredient at hour 4 is at least about 0.1 μL/g matrix/hr. In some embodiments, the rate of release of cyclopropene at hour 4 is at least about 1 μL/g matrix/hr. In some embodiments, the rate of release of cyclopropene at hour 4 is at least about 2 μL/g matrix/hr. In some embodiments, the rate of release of cyclopropene at hour 4 is at least about 3 μL/g matrix/hr. In some embodiments, the rate of release of cyclopropene at hour 4 is at least about 4 μL/g matrix/hr. In some embodiments, the rate of release of cyclopropene at hour 4 is at least about 5 μL/g matrix/hr. In some embodiments, the rate of release of cyclopropene at hour 4 is at least about 10 μL/g matrix/hr. In some embodiments, the rate of release of cyclopropene at hour 4 is at least about 25 μL/g matrix/hr. In some embodiments, the rate of release of cyclopropene at hour 4 is at least about 30 μL/g matrix/hr. In some embodiments, the rate of release of cyclopropene at hour 4 is at least about 35 μL/g matrix/hr. In some embodiments, the rate of release of cyclopropene at hour 4 is at least about 40 μL/g matrix/hr. In some embodiments, the rate of release of cyclopropene at hour 4 is at least about 45 μL/g matrix/hr. In some embodiments, the rate of release of cyclopropene at hour 4 is at least about 50 μL/g matrix/hr. In some embodiments, the rate of release of cyclopropene at hour 4 is at least about 55 μL/g matrix/hr. In some embodiments, the rate of release of cyclopropene at hour 22 is at least about 0.0005 μL/g matrix/hr. In some embodiments, the rate of release of cyclopropene at hour 22 is at least about 0.001 μL/g matrix/hr. In some embodiments, the rate of release of cyclopropene at hour 22 is at least about 0.1 μL/g matrix/hr. In some embodiments, the rate of release of cyclopropene at hour 22 is at least about 1 μL/g matrix/hr. In some embodiments, the rate of release of cyclopropene at hour 1 is at least about 2 μL/g matrix/hr. In some embodiments, the rate of release of cyclopropene at hour 1 is at least about 3 μL/g matrix/hr. In some embodiments, the rate of release of cyclopropene at hour 1 is at least about 4 μL/g matrix/hr. In some embodiments, the rate of release of cyclopropene at hour 22 is at least about 5 μL/g matrix/hr. In some embodiments, the rate of release of cyclopropene at hour 22 is at least about 10 μL/g matrix/hr. In some embodiments, the rate of release of cyclopropene at hour 22 is at least about 25 μL/g matrix/hr. In some embodiments, the rate of release of cyclopropene at hour 22 is at least about 28 μL/g matrix/hr. In some embodiments, the rate of release of cyclopropene at hour 22 is between about 0.0005 μL/g matrix/hr and about 25 μL/g matrix/hr. In some embodiments, the rate of release of cyclopropene at hour 22 is between about 0.0005 μL/g matrix/hr and about 30 μL/g matrix/hr. In some embodiments, the rate of release of cyclopropene at hour 22 is between about 0.0005 μL/g matrix/hr and about 40 μL/g matrix/hr. In some embodiments, the rate of release of cyclopropene at hour 22 is between about 0.001 μL/g matrix/hr and about 25 μL/g matrix/hr. In some embodiments, the rate of release of cyclopropene at hour 22 is between about 0.001 μL/g matrix/hr and about 30 μL/g matrix/hr. In some embodiments, the rate of release of cyclopropene at hour 22 is between about 0.0005 μL/g matrix/hr and about 40 μL/g matrix/hr. In some embodiments, the rate of release of cyclopropene at hour 22 is between about 0.1 μL/g matrix/hr and about 25 μL/g matrix/hr. In some embodiments, the rate of release of cyclopropene at hour 22 is between about 0.1 μL/g matrix/hr and about 30 μL/g matrix/hr. In some embodiments, the rate of release of cyclopropene edient at hour 22 is between about 0.1 μL/g matrix/hr and about 40 μL/g matrix/hr. In some embodiments, the rate of release of cyclopropene at hour 22 is between about 1 μL/g matrix/hr and about 22 μL/g matrix/hr. In some embodiments, the rate of release of cyclopropene at hour 22 is between about 1 μL/g matrix/hr and about 25 μL/g matrix/hr. In some embodiments, the rate of release of cyclopropene at hour 22 is between about 1 μL/g matrix/hr and about 30 μL/g matrix/hr. In some embodiments, the rate of release of cyclopropene at hour 22 is between about 1 μL/g matrix/hr and about 40 μL/g matrix/hr. In some embodiments, the rate of release of cyclopropene at hour 22 is between about 3 μL/g matrix/hr and about 22 μL/g matrix/hr. In some embodiments, the rate of release of cyclopropene at hour 22 is between about 3 μL/g matrix/hr and about 25 μL/g matrix/hr. In some embodiments, the rate of release of cyclopropene at hour 22 is between about 3 μL/g matrix/hr and about 30 μL/g matrix/hr. In some embodiments, the rate of release of cyclopropene at hour 22 is between about 3 μL/g matrix/hr and about 40 μL/g matrix/hr. In some embodiments, the rate of release of cyclopropene at hour 22 is between about 5 μL/g matrix/hr and about 22 μL/g matrix/hr. In some embodiments, the rate of release of cyclopropene at hour 22 is between about 5 μL/g matrix/hr and about 25 μL/g matrix/hr. In some embodiments, the rate of release of cyclopropene at hour 22 is between about 5 μL/g matrix/hr and about 30 μL/g matrix/hr. In some embodiments, the rate of release of cyclopropene at hour 22 is between about 5 μL/g matrix/hr and about 40 μL/g matrix/hr. In some embodiments, the rate of release of cyclopropene at hour 22 is between about 10 μL/g matrix/hr and about 25 μL/g matrix/hr. In some embodiments, the rate of release of cyclopropene at hour 22 is between about 10 μL/g matrix/hr and about 30 μL/g matrix/hr. In some embodiments, the rate of release of cyclopropene at hour 22 is between about 10 μL/g matrix/hr and about 40 μL/g matrix/hr. In some embodiments, the rate of release of cyclopropene at hour 22 is between about 15 μL/g matrix/hr and about 25 μL/g matrix/hr. In some embodiments, the rate of release of cyclopropene at hour 22 is between about 15 μL/g matrix/hr and about 30 μL/g matrix/hr. In some embodiments, the rate of release of cyclopropene at hour 22 is between about 15 μL/g matrix/hr and about 40 μL/g matrix/hr. In some embodiments, the rate of release of cyclopropene at hour 22 is between about 22 μL/g matrix/hr and about 25 μL/g matrix/hr. In some embodiments, the rate of release of cyclopropene at hour 22 is between about 22 μL/g matrix/hr and about 30 μL/g matrix/hr. In some embodiments, the rate of release of cyclopropene at hour 22 is between about 22 μL/g matrix/hr and about 40 μL/g matrix/hr. In some embodiments, the rate of release of cyclopropene at hour 22 is between about 25 μL/g matrix/hr and about 30 μL/g matrix/hr. In some embodiments, the rate of release of cyclopropene at hour 22 is between about 25 μL/g matrix/hr and about 35 μL/g matrix/hr. In some embodiments, the rate of release of cyclopropene at hour 22 is between about 25 μL/g matrix/hr and about 40 μL/g matrix/hr. In some embodiments, the rate of release of cyclopropene at hour 24 is at least about 0.001 μL/g matrix/hr. In some embodiments, the rate of release of cyclopropene at hour 24 is at least about 0.1 μL/g matrix/hr. In some embodiments, the rate of release of cyclopropene at hour 24 is at least about 1 μL/g matrix/hr. In some embodiments, the rate of release of cyclopropene at hour 24 is at least about 5 μL/g matrix/hr. In some embodiments, the rate of release of cyclopropene at hour 24 is at least about 10 μL/g matrix/hr. In some embodiments, the rate of release of cyclopropene at hour 24 is at least about 20 μL/g matrix/hr. In some embodiments, the rate of release of cyclopropene at hour 24 is at least about 30 μL/g matrix/hr. In some embodiments, the rate of release of cyclopropene at hour 24 is at least about 35 μL/g matrix/hr. In some embodiments, the rate of release of cyclopropene at hour 24 is between about 0.0005 μL/g matrix/hr and about 35 μL/g matrix/hr. In some embodiments, the rate of release of cyclopropene at hour 24 is between about 0.001 μL/g matrix/hr and about 35 μL/g matrix/hr. In some embodiments, the rate of release of cyclopropene at hour 22 is between about 0.1 μL/g matrix/hr and about 35 μL/g matrix/hr. In some embodiments, the rate of release of cyclopropene at hour 24 is between about 1 μL/g matrix/hr and about 25 μL/g matrix/hr. In some embodiments, the rate of release of cyclopropene at hour 24 is between about 3 μL/g matrix/hr and about 35 μL/g matrix/hr. In some embodiments, the rate of release of cyclopropene at hour 24 is between about 5 μL/g matrix/hr and about 35 μL/g matrix/hr. In some embodiments, the rate of release of cyclopropene at hour 48 is greater than zero μL/g matrix/hr. In some embodiments, the rate of release of cyclopropene at hour 48 is at least about 0.01 μL/g matrix/hr. In some embodiments, the rate of release of cyclopropene at hour 48 is at least about 0.1 μL/g matrix/hr. In some embodiments, the rate of release of cyclopropene at hour 48 at least about 1 μL/g matrix/hr. In some embodiments, the rate of release of cyclopropene at hour 48 at least about 5 μL/g matrix/hr. In some embodiments, the rate of release of cyclopropene at hour 48 at least about 10 μL/g matrix/hr. In some embodiments, the rate of release of cyclopropene at hour 48 at least about 20 μL/g matrix/hr. In some embodiments, the rate of release of cyclopropene at hour 48 at least about 25 μL/g matrix/hr. In some embodiments, the rate of release of cyclopropene at hour 48 at least about 30 μL/g matrix/hr. In some embodiments, the rate of release of cyclopropene at hour 48 is between about 0.1 μL/g matrix/hr and about 4 μL/g matrix/hr. In some embodiments, the rate of release of cyclopropene at hour 48 is between about 1 μL/g matrix/hr and about 5 μL/g matrix/hr. In some embodiments, the rate of release of cyclopropene at hour 48 is between about 0.01 μL/g matrix/hr and about 30 μL/g matrix/hr. In some embodiments, the rate of release of cyclopropene at hour 48 is between about 1 μL/g matrix/hr and about 30 μL/g matrix/hr. In some embodiments, the rate of release of cyclopropene at hour 72 is greater than zero μL/g matrix/hr. In some embodiments, the rate of release of cyclopropene at hour 72 is at least about 0.01 μL/g matrix/hr. In some embodiments, the rate of release of cyclopropene at hour 72 is at least about 0.1 μL/g matrix/hr. In some embodiments, the rate of release of cyclopropene at hour 72 is at least about 1 μL/g matrix/hr. In some embodiments, the rate of release of cyclopropene at hour 72 is at least about 3 μL/g matrix/hr. In some embodiments, the rate of release of cyclopropene at hour 72 is at least about 5 μL/g matrix/hr. In some embodiments, the rate of release of cyclopropene at hour 72 is at least about 10 μL/g matrix/hr. In some embodiments, the rate of release of cyclopropene at hour 72 is at least about 15 μL/g matrix/hr. In some embodiments, the rate of release of cyclopropene at hour 72 is between about 0.01 μL/g matrix/hr and about 3 μL/g matrix/hr. In some embodiments, the rate of release of cyclopropene at hour 72 is between about 0.1 μL/g matrix/hr and about 3 μL/g matrix/hr. In some embodiments, the rate of release of cyclopropene at hour 72 is between about 1 μL/g matrix/hr and about 3 μL/g matrix/hr. In some embodiments, the rate of release of cyclopropene at hour 72 is between about 0.01 μL/g matrix/hr and about 15 μL/g matrix/hr. In some embodiments, the rate of release of cyclopropene at hour 72 is between about 0.1 μL/g matrix/hr and about 15 μL/g matrix/hr. In some embodiments, the rate of release of cyclopropene at hour 72 is between about 1 μL/g matrix/hr and about 15 μL/g matrix/hr. In some embodiments, the rate of release of cyclopropene at hour 72 is between about 0.01 μL/g matrix/hr and about 20 μL/g matrix/hr. In some embodiments, the rate of release of cyclopropene at hour 72 is between about 0.1 μL/g matrix/hr and about 20 μL/g matrix/hr. In some embodiments, the rate of release of cyclopropene at hour 72 is between about 1 μL/g matrix/hr and about 20 μL/g matrix/hr. In some embodiments, the rate of release of cyclopropene at hour 72 is between about 0.01 μL/g matrix/hr and about 25 μL/g matrix/hr. In some embodiments, the rate of release of cyclopropene at hour 72 is between about 0.1 μL/g matrix/hr and about 25 μL/g matrix/hr. In some embodiments, the rate of release of cyclopropene at hour 72 is between about 1 μL/g matrix/hr and about 25 μL/g matrix/hr. In some embodiments, the rate of release of cyclopropene at hour 72 is between about 15 μL/g matrix/hr and about 20 μL/g matrix/hr. In some embodiments, the rate of release of cyclopropene at hour 72 is between about 15 μL/g matrix/hr and about 25 μL/g matrix/hr. In some embodiments, the rate of release of cyclopropene at hour 72 is between about 17 μL/g matrix/hr and about 20 μL/g matrix/hr. In some embodiments, the rate of release of cyclopropene at hour 72 is between about 17 μL/g matrix/hr and about 25 μL/g matrix/hr. In some embodiments, the rate of release of cyclopropene at hour 96 is greater than zero μL/g matrix/hr. In some embodiments, the rate of release of cyclopropene at hour 96 is at least about 0.01 μL/g matrix/hr. In some embodiments, the rate of release of cyclopropene at hour 96 is at least about 0.1 μL/g matrix/hr. In some embodiments, the rate of release of cyclopropene at hour 96 is at least 1 μL/g matrix/hr. In some embodiments, the rate of release of cyclopropene at hour 96 is at least about 2 μL/g matrix/hr. In some embodiments, the rate of release of cyclopropene at hour 96 is at least about 5 μL/g matrix/hr. In some embodiments, the rate of release of cyclopropene at hour 96 is at least about 10 μL/g matrix/hr. In some embodiments, the rate of release of cyclopropene at hour 96 is between about 0.01 μL/g matrix/hr and about 2 μL/g matrix/hr. In some embodiments, the rate of release of cyclopropene at hour 96 is between about 0.1 μL/g matrix/hr and about 2 μL/g matrix/hr. In some embodiments, the rate of release of cyclopropene at hour 96 is between about 1 μL/g matrix/hr and about 2 μL/g matrix/hr. In some embodiments, the rate of release of cyclopropene at hour 96 is between about 0.01 μL/g matrix/hr and about 2 μL/g matrix/hr. In some embodiments, the rate of release of cyclopropene at hour 96 is between about 0.1 μL/g matrix/hr and about 2 μL/g matrix/hr. In some embodiments, the rate of release of cyclopropene at hour 96 is between about 1 μL/g matrix/hr and about 2 μL/g matrix/hr. In some embodiments, the rate of release of cyclopropene at hour 96 is between about 0.01 μL/g matrix/hr and about 15 μL/g matrix/hr. In some embodiments, the rate of release of cyclopropene at hour 96 is between about 0.1 μL/g matrix/hr and about 15 μL/g matrix/hr. In some embodiments, the rate of release of cyclopropene at hour 96 is between about 1 μL/g matrix/hr and about 15 μL/g matrix/hr. In some embodiments, the rate of release of cyclopropene at hour 96 is between about 2 μL/g matrix/hr and about 15 μL/g matrix/hr. In some embodiments, the rate of release of cyclopropene at hour 96 is between about 5 μL/g matrix/hr and about 15 μL/g matrix/hr. In some embodiments, the rate of release of cyclopropene at hour 96 is between about 10 μL/g matrix/hr and about 15 μL/g matrix/hr. In some embodiments, the rate of release of cyclopropene at hour 96 is between about 0.01 μL/g matrix/hr and about 15 μL/g matrix/hr. In some embodiments, the rate of release of cyclopropene at hour 96 is between about 0.1 μL/g matrix/hr and about 20 μL/g matrix/hr. In some embodiments, the rate of release of cyclopropene at hour 96 is between about 1 μL/g matrix/hr and about 20 μL/g matrix/hr. In some embodiments, the rate of release of cyclopropene at hour 96 is between about 2 μL/g matrix/hr and about 20 μL/g matrix/hr. In some embodiments, the rate of release of cyclopropene at hour 96 is between about 5 μL/g matrix/hr and about 20 μL/g matrix/hr. In some embodiments, the rate of release of cyclopropene at hour 96 is between about 10 μL/g matrix/hr and about 20 μL/g matrix/hr. In some embodiments, the rate of release of cyclopropene at hour 120 is greater than zero μL/g matrix/hr. In some embodiments, the rate of release of cyclopropene at hour 120 is at least about 0.01 μL/g matrix/hr. In some embodiments, the rate of release of cyclopropene at hour 120 is at least about 0.1 μL/g matrix/hr. In some embodiments, the rate of release of cyclopropene at hour 120 is at least about 1 μL/g matrix/hr. In some embodiments, the rate of release of cyclopropene at hour 120 is at least about 5 μL/g matrix/hr. In some embodiments, the rate of release of cyclopropene at hour 120 is at least about 10 μL/g matrix/hr. In some embodiments, the rate of release of cyclopropene at hour 120 is between about 0.01 μL/g matrix/hr and about 1 μL/g matrix/hr. In some embodiments, the rate of release of cyclopropene at hour 120 is between about 0.1 μL/g matrix/hr and about 1 μL/g matrix/hr. In some embodiments, the rate of release of cyclopropene at hour 120 is between about 0.01 μL/g matrix/hr and about 5 μL/g matrix/hr. In some embodiments, the rate of release of cyclopropene at hour 120 is between about 0.1 μL/g matrix/hr and about 5 μL/g matrix/hr. In some embodiments, the rate of release of cyclopropene at hour 120 is between about 1 μL/g matrix/hr and about 5 μL/g matrix/hr. In some embodiments, the rate of release of cyclopropene at hour 120 is between about 0.01 μL/g matrix/hr and about 10 μL/g matrix/hr. In some embodiments, the rate of release of cyclopropene at hour 120 is between about 0.1 μL/g matrix/hr and about 10 μL/g matrix/hr. In some embodiments, the rate of release of cyclopropene at hour 120 is between about 1 μL/g matrix/hr and about 10 μL/g matrix/hr. In some embodiments, the rate of release of cyclopropene at hour 120 is between about 0.01 μL/g matrix/hr and about 15 μL/g matrix/hr. In some embodiments, the rate of release of cyclopropene at hour 120 is between about 0.1 μL/g matrix/hr and about 15 μL/g matrix/hr. In some embodiments, the rate of release of cyclopropene at hour 120 is between about 1 μL/g matrix/hr and about 15 μL/g matrix/hr. In some embodiments, the rate of release of cyclopropene at hour 120 is between about 2 μL/g matrix/hr and about 15 μL/g matrix/hr. In some embodiments, the rate of release of cyclopropene at hour 120 is between about 2 μL/g matrix/hr and about 15 μL/g matrix/hr. In some embodiments, the rate of release of cyclopropene at hour 120 is between about 2 μL/g matrix/hr and about 15 μL/g matrix/hr. In some embodiments, the rate of release of cyclopropene at hour 120 is between about 5 μL/g matrix/hr and about 15 μL/g matrix/hr. In some embodiments, the rate of release of cyclopropene at hour 120 is between about 5 μL/g matrix/hr and about 15 μL/g matrix/hr. In some embodiments, the rate of release of cyclopropene at hour 120 is between about 5 μL/g matrix/hr and about 15 μL/g matrix/hr. In some embodiments, the rate of release of cyclopropene at hour 120 is between about 7 μL/g matrix/hr and about 15 μL/g matrix/hr. In some embodiments, the rate of release of cyclopropene at hour 120 is between about 7 μL/g matrix/hr and about 15 μL/g matrix/hr. In some embodiments, the rate of release of cyclopropene at hour 120 is between about 7 μL/g matrix/hr and about 15 μL/g matrix/hr. In some embodiments, the rate of release of cylopropene at hour 168 is at least about 0.01 μL/g matrix/hr. In some embodiments, the rate of release of cylopropene at hour 168 is at least about 0.1 μL/g matrix/hr. In some embodiments, the rate of release of cylopropene at hour 168 is at least about 0.5 μL/g matrix/hr. In some embodiments, the rate of release of cylopropene at hour 168 is at least about 2 μL/g matrix/hr. In some embodiments, the rate of release of cylopropene at hour 168 is at least about 5 μL/g matrix/hr. In some embodiments, the rate of release of cylopropene at hour 168 is at least about 10 μL/g matrix/hr. In some embodiments, the rate of release of cylopropene at hour 168 is between about 0.01 μL/g matrix/hr and about 0.5 μL/g matrix/hr. In some embodiments, the rate of release of cylopropene at hour 168 is between about 0.01 μL/g matrix/hr and about 3 μL/g matrix/hr. In some embodiments, the rate of release of cylopropene at hour 168 is between about 0.01 μL/g matrix/hr and about 5 μL/g matrix/hr. In some embodiments, the rate of release of cylopropene at hour 168 is between about 0.5 μL/g matrix/hr and about 13 μL/g matrix/hr. In some embodiments, the rate release of cylopropene at hour 240 is greater than zero μL/g matrix/hr. In some embodiments, the rate of release of cylopropene at hour 240 is at least about 0.01 μL/g matrix/hr. In some embodiments, the rate of release of cylopropene at hour 240 is at least about 0.1 μL/g matrix/hr. In some embodiments, the rate of release of cylopropene at hour 240 is at least about 1 μL/g matrix/hr. In some embodiments, the rate of release of cylopropene at hour 240 is at least about 1.5 μL/g matrix/hr. In some embodiments, the rate of release of cylopropene at hour 240 is between about 0.01 μL/g matrix/hr and about 1 μL/g matrix/hr. In some embodiments, the rate of release of cylopropene at hour 240 is between about 0.1 μL/g matrix/hr and about 1 μL/g matrix/hr. In some embodiments, the rate of release of cylopropene at hour 240 is between about 0.1 μL/g matrix/hr and about 1.5 μL/g matrix/hr. In some embodiments, the rate release of active ingredient at hour 336 is greater than zero μL/g matrix/hr. In some embodiments, the rate of release of active ingredient at hour 336 is at least about 0.01 μL/g matrix/hr. In some embodiments, the rate of release of cylopropene at hour 336 is at least about 0.1 μL/g matrix/hr. In some embodiments, the rate of release of cylopropene at hour 336 is at least about 1 μL/g matrix/hr. In some embodiments, the rate of release of cylopropene at hour 336 is between about 0.01 μL/g matrix/hr and about 1 μL/g matrix/hr. In some embodiments, the rate of release of cylopropene at hour 336 is between about 0.1 μL/g matrix/hr and about 1 μL/g matrix/hr. In some embodiments, the rate of release of cyclopropene sustained between hour 1 and hour 216 is at least about 1 μL/g matrix/hr. In some embodiments, the rate of release of cyclopropene sustained between hour 22 and hour 120 is at least about 1 μL/g matrix/hr. In some embodiments, the rate of release of cyclopropene sustained between hour 22 and hour 120 is at least about 2 μL/g matrix/hr. In some embodiments, the rate of release of cyclopropene sustained between hour 22 and hour 96 is at least about 1 μL/g matrix/hr. In some embodiments, the rate of release of cyclopropene sustained between hour 22 and hour 96 is at least about 2 μL/g matrix/hr. In some embodiments, the rate of release of cyclopropene sustained between hour 22 and hour 72 is at least about 1 μL/g matrix/hr. In some embodiments, the rate of release of cyclopropene sustained between hour 22 and hour 72 is at least about 4 μL/g matrix/hr. In some embodiments, the rate of release of cyclopropene sustained between hour 22 and hour 72 is at least about 10 μL/g matrix/hr. In some embodiments, the rate of release of cyclopropene sustained between hour 22 and hour 72 is at least about 15 μL/g matrix/hr. In some embodiments, the rate of release of cyclopropene sustained between hour 22 and hour 168 is at least about 5 μL/g matrix/hr. In some embodiments, the rate of release of cyclopropene sustained between hour 22 and hour 168 is at least about 10 μL/g matrix/hr. In some embodiments, a release rate of cyclopropene between hour 22 and hour 72 is sustained within a range of about 0.1 and about 30 μL/g matrix/hr. In some embodiments, a release rate of cyclopropene between hour 22 and hour 72 is sustained within a range of about 0.1 and about 35 μL/g matrix/hr. In some embodiments, a release rate of the cyclopropene between hour 22 and hour 72 is sustained within a range of about 0.1 and about 40 μL/g matrix/hr. In some embodiments, a release rate of the cyclopropene between hour 22 and hour 72 is sustained within a range of about 0.1 and about 50 μL/g matrix/hr. In some embodiments, a release rate of cyclopropene between hour 22 and hour 72 is sustained within a range of about 1 and about 30 μL/g matrix/hr. In some embodiments, a release rate of cyclopropene between hour 22 and hour 72 is sustained within a range of about 1 and about 35 μL/g matrix/hr. In some embodiments, a release rate of the cyclopropene between hour 22 and hour 72 is sustained within a range of about 1 and about 40 μL/g matrix/hr. In some embodiments, a release rate of the cyclopropene between hour 22 and hour 72 is sustained within a range of about 1 and about 50 μL/g matrix/hr. In some embodiments, a release rate of cyclopropene between hour 22 and hour 72 is sustained within a range of about 2 and about 30 μL/g matrix/hr. In some embodiments, a release rate of cyclopropene between hour 22 and hour 72 is sustained within a range of about 2 and about 35 μL/g matrix/hr. In some embodiments, a release rate of the cyclopropene between hour 22 and hour 72 is sustained within a range of about 2 and about 40 μL/g matrix/hr. In some embodiments, a release rate of the cyclopropene between hour 22 and hour 72 is sustained within a range of about 2 and about 50 μL/g matrix/hr. In some embodiments, a release rate of cyclopropene between hour 22 and hour 72 is sustained within a range of about 5 and about 30 μL/g matrix/hr. In some embodiments, a release rate of cyclopropene between hour 22 and hour 72 is sustained within a range of about 5 and about 35 μL/g matrix/hr. In some embodiments, a release rate of the cyclopropene between hour 22 and hour 72 is sustained within a range of about 5 and about 40 μL/g matrix/hr. In some embodiments, a release rate of the cyclopropene between hour 22 and hour 72 is sustained within a range of about 5 and about 50 μL/g matrix/hr. In some embodiments, a release rate of cyclopropene between hour 22 and hour 72 is sustained within a range of about 7 and about 30 μL/g matrix/hr. In some embodiments, a release rate of cyclopropene between hour 22 and hour 72 is sustained within a range of about 7 and about 35 μL/g matrix/hr. In some embodiments, a release rate of the cyclopropene between hour 22 and hour 72 is sustained within a range of about 7 and about 40 μL/g matrix/hr. In some embodiments, a release rate of the cyclopropene between hour 22 and hour 72 is sustained within a range of about 7 and about 50 μL/g matrix/hr. In some embodiments, a release rate of cyclopropene between hour 22 and hour 72 is sustained within a range of about 10 and about 30 μL/g matrix/hr. In some embodiments, a release rate of cyclopropene between hour 22 and hour 72 is sustained within a range of about 10 and about 35 μL/g matrix/hr. In some embodiments, a release rate of the cyclopropene between hour 22 and hour 72 is sustained within a range of about 10 and about 40 μL/g matrix/hr. In some embodiments, a release rate of the cyclopropene between hour 22 and hour 72 is sustained within a range of about 10 and about 50 μL/g matrix/hr. In some embodiments, a release rate of cyclopropene between hour 22 and hour 72 is sustained within a range of about 15 and about 30 μL/g matrix/hr. In some embodiments, a release rate of cyclopropene between hour 22 and hour 72 is sustained within a range of about 15 and about 35 μL/g matrix/hr. In some embodiments, a release rate of the cyclopropene between hour 22 and hour 72 is sustained within a range of about 15 and about 40 μL/g matrix/hr. In some embodiments, a release rate of the cyclopropene between hour 22 and hour 72 is sustained within a range of about 15 and about 50 μL/g matrix/hr. In some embodiments, a release rate of cyclopropene between hour 22 and hour 72 is sustained within a range of about 2 and about 30 μL/g matrix/hr. In some embodiments, a release rate of cyclopropene between hour 22 and hour 72 is sustained within a range of about 17 and about 35 μL/g matrix/hr. In some embodiments, a release rate of the cyclopropene between hour 22 and hour 72 is sustained within a range of about 17 and about 40 μL/g matrix/hr. In some embodiments, a release rate of the cyclopropene between hour 22 and hour 72 is sustained within a range of about 17 and about 50 μL/g matrix/hr. In some embodiments, the release rate of cyclopropene between hour 22 and hour 120 is sustained within a range of about 0.1 and about 2 μL/g matrix/hr. In some embodiments, a release rate of cyclopropene between hour 22 and hour 120 is sustained within a range of about 1 and about 15 μL/g matrix/hr. In some embodiments, a release rate of cyclopropene between hour 22 and hour 120 is sustained within a range of about 1 and about μL/g matrix/hr. In some embodiments, a release rate of cyclopropene between hour 22 and hour 120 is sustained within a range of about 1 and about 30 μL/g matrix/hr. In some embodiments, a release rate of cyclopropene between hour 22 and hour 120 is sustained within a range of about 1 and about 35 μL/g matrix/hr. In some embodiments, a release rate of cyclopropene between hour 22 and hour 120 is sustained within a range of about 1 and about 40 μL/g matrix/hr. In some embodiments, a release rate of cyclopropene between hour 22 and hour 120 is sustained within a range of about 1 and about 50 μL/g matrix/hr. In some embodiments, a release rate of cyclopropene between hour 22 and hour 120 is sustained within a range of about 5 and about 30 μL/g matrix/hr. In some embodiments, a release rate of cyclopropene between hour 22 and hour 120 is sustained within a range of about 5 and about 35 μL/g matrix/hr. In some embodiments, a release rate of cyclopropene between hour 22 and hour 120 is sustained within a range of about 5 and about 40 μL/g matrix/hr. In some embodiments, a release rate of cyclopropene between hour 22 and hour 120 is sustained within a range of about 5 and about 50 μL/g matrix/hr. In some embodiments, a release rate of cyclopropene between hour 22 and hour 120 is sustained within a range of about 10 and about 30 μL/g matrix/hr. In some embodiments, a release rate of cyclopropene between hour 22 and hour 120 is sustained within a range of about 10 and about 35 μL/g matrix/hr. In some embodiments, a release rate of cyclopropene between hour 22 and hour 120 is sustained within a range of about 10 and about 40 μL/g matrix/hr. In some embodiments, a release rate of cyclopropene between hour 22 and hour 120 is sustained within a range of about 10 and about 50 μL/g matrix/hr. In some embodiments, the release rates discussed above occur at ambient room temperature (approximately 23-25° C.) and at atmospheric pressure.

Controlled release of cyclopropene (with “hour zero” meaning composition exposure to a non-equilibrium condition) may alternatively be quantified as a percentage of the rate of release of cyclopropene as compared to the rate of release of cyclopropene at hour one (1), for example. In a non-limiting embodiment, the rate of release of cyclopropene at hour 22 is at least 0.1% of the release rate at hour 1. In some embodiments, the rate of release of cyclopropene at hour 22 is at least 1% of the release rate at hour 1. In some embodiments, the rate of release of cyclopropene at hour 22 at least 2.5% of the release rate at hour 1. In some embodiments, the rate of release of cyclopropene at hour 22 is at least 10% of the release rate at hour 1. In some embodiments, the release rate of cyclopropene at hour 22 is at least 20% of the rate of release at hour 1. In some embodiments, the release rate of cyclopropene at hour 22 is at least 30% of the rate of release at hour 1. In some embodiments, the release rate of cyclopropene at hour 22 is at least 40% of the rate of release at hour 1. In some embodiments, the release rate of cyclopropene at hour 22 is at least 45% of the rate of release at hour 1. In some embodiments, the rate of release of cyclopropene at hour 48 is at least 0.1% of the release rate at hour 1. In some embodiments, the release of cyclopropene at hour 48 is at least 1% of the release rate at hour 1. In some embodiments, the rate of release of cyclopropene at hour 48 is at least 2% of the release rate at hour 1. In some embodiments, the rate of release of cyclopropene at hour 48 is at least 10% of the release rate at hour 1. In some embodiments, the rate of release of cyclopropene at hour 48 is at least 15% of the release rate at hour 1. In some embodiments, the rate of release of cyclopropene at hour 48 is at least 20% of the release rate at hour 1. In some embodiments, the rate of release of cyclopropene at hour 48 is at least 25% of the release rate at hour 1. In some embodiments, the rate of release of cyclopropene at hour 48 is at least 30% of the release rate at hour 1. In some embodiments, the rate of release of active ingredient at hour 72 is at least 0.1% of the release rate at hour 1. In some embodiments, the rate of release of active ingredient at hour 72 is at least 1% of the rate of release at hour 1. In some embodiments, the rate of release of active ingredient at hour 72 is at least 10% of the release rate at hour 1. In some embodiments, the rate of release of cyclopropene at hour 72 is at least 15% of the release rate at hour 1. In some embodiments, the rate of release of cyclopropene at hour 72 is at least 20% of the release rate at hour 1. In some embodiments, the rate of release of cyclopropene at hour 72 is at least 25% of the release rate at hour 1. In some embodiments, the rate of release of cyclopropene at hour 72 is at least 30% of the release rate at hour 1. In some embodiments, the rate of release of cyclopropene at hour 96 is at least 0.1% of the release rate at hour 1. In some embodiments, the rate of release of cyclopropene at hour 96 is at least 1% of the release rate at hour 1. In some embodiments, the rate of release of cyclopropene at hour 96 is at least 5% of the release rate at hour 1. In some embodiments, the rate of release of active ingredient at hour 96 is at least 10% of the release rate at hour 1. In some embodiments, the rate of release of cyclopropene at hour 96 is at least 15% of the release rate at hour 1. In some embodiments, the rate of release of cyclopropene at hour 96 is at least 20% of the release rate at hour 1. In some embodiments, the rate of release of cyclopropene at hour 96 is at least 24% of the release rate at hour 1. In some embodiments, the rate of release of cyclopropene at hour 120 is at least 0.1% of the release rate at hour 1. In some embodiments, the rate of release of cyclopropene at hour 120 is at least 1% of the release rate at hour 1. In some embodiments, the rate of release of cyclopropene at hour 120 is at least 5% of the release rate at hour 1. In some embodiments, the rate of release of active ingredient at hour 120 is at least 10% of the release rate at hour 1. In some embodiments, the rate of release of cyclopropene at hour 120 is at least 15% of the release rate at hour 1. In some embodiments, the rate of release of cyclopropene at hour 120 is at least 18% of the release rate at hour 1. In some embodiments, the rate of release of cyclopropene at hour 168 is at least 0.1% of the rate of release at hour 1. In some embodiments, the rate of release of cyclopropene at hour 168 is at least 1% of the release rate at hour 1. In some embodiments, the rate of release of cyclopropene at hour 168 is at least 4% of the release rate at hour 1. In some embodiments, the rate of release of cyclopropene at hour 240 is at least 0.1% of the release rate at hour 1. In some embodiments, the rate of release of cyclopropene at hour 240 is at least 1% of the release rate at hour 1. In some embodiments, the rate of release of cyclopropene at hour 336 is at least 0.1% of the rate of release rate at hour 1. In some embodiments, the rate of release of cyclopropene at hour 336 is at least 1% of the release rate at hour 1. In some embodiments, the rate of release of cyclopropene at hour 48 is at least 1% of the rate of release at hour 24. In some embodiments, the rate of release of cyclopropene at hour 48 is at least 10% of the rate of release at hour 24. In some embodiments, the rate of release of cyclopropene at hour 48 is at least 20% of the rate of release at hour 22. In some embodiments, the rate of release of cyclopropene at hour 48 is at least 50% of the rate of release at hour 22. In some embodiments, the rate of release of cyclopropene at hour 48 is at least 60% of the rate of release at hour 22. In some embodiments, the rate of release of cyclopropene at hour 48 is at least 75% of the rate of release at hour 22. In some embodiments, the rate of release of cyclopropene at hour 48 is at least 90% of the rate of release at hour 22. In some embodiments, the rate of release of cyclopropene at hour 48 is at least 95% of the rate of release at hour 22. In some embodiments, the rate of release of cyclopropene at hour 72 is at least 1% of the rate of release at hour 22. In some embodiments, the rate of release of cyclopropene at hour 72 is at least 10% of the rate of release at hour 22. In some embodiments, the rate of release of cyclopropene at hour 72 is at least 20% of the rate of release at hour 22. In some embodiments, the rate of release of cyclopropene at hour 72 is at least 30% of the rate of release at hour 22. In some embodiments, the rate of release of cyclopropene at hour 72 is at least 40% of the rate of release at hour 22. In some embodiments, the rate of release of cyclopropene at hour 72 is at least 50% of the rate of release at hour 22. In some embodiments, the rate of release of cyclopropene at hour 72 is at least 60% of the rate of release at hour 22. In some embodiments, the rate of release of cyclopropene at hour 96 is at least 1% of the rate of release at hour 22. In some embodiments, the rate of release of cyclopropene at hour 96 is at least 10% of the rate of release at hour 22. In some embodiments, the rate of release of cyclopropene at hour 96 is at least 20% of the rate of release at hour 22. In some embodiments, the rate of release of cyclopropene at hour 96 is at least 25% of the rate of release at hour 22. In some embodiments, the rate of release of cyclopropene at hour 96 is at least 30% of the rate of release at hour 22. In some embodiments, the rate of release of cyclopropene at hour 96 is at least 35% of the rate of release at hour 22. In some embodiments, the rate of release of cyclopropene at hour 96 is at least 40% of the rate of release at hour 22. In some embodiments, the rate of release of cyclopropene at hour 96 is at least 45% of the rate of release at hour 22. In some embodiments, the rate of release of cyclopropene at hour 120 is at least 1% of the rate of release at hour 22. In some embodiments, the rate of release of cyclopropene at hour 120 is at least 5% of the rate of release at hour 22. In some embodiments, the rate of release of cyclopropene at hour 120 is at least 10% of the rate of release at hour 22. In some embodiments, the rate of release of cyclopropene at hour 120 is at least 15% of the rate of release at hour 22. In some embodiments, the release profiles discussed above occur at ambient room temperature (approximately 23-25° C.) and at atmospheric pressure. In some embodiments, the rate of release of cyclopropene at hour 1 is at least about 0.1 μL/g matrix/hr, or at least about 1 μL/g matrix/hr, or at least about 2 μL/g matrix/hr, or at least about 3 μL/g matrix/hr, or at least about 4 μL/g matrix/hr, or at least about 5 μL/g matrix/hr, or at least about 7 μL/g matrix/hr, or at least about 10 μL/g matrix/hr, or at least about about 25 μL/g matrix/hr, or at least about 40 μL/g matrix/hr, or at least about 50 μL/g matrix/hr. In some embodiments, the rate of release of cyclopropene at hour 22 is at least about 0.0005 μL/g matrix/hr, or at least about 0.001 μL/g matrix/hr, or at least about 0.1 μL/g matrix/hr, or at least about 1 μL/g matrix/hr, or at least about 2 μL/g matrix/hr, or at least about 3 μL/g matrix/hr, or at least about 4 μL/g matrix/hr, or at least about 5 μL/g matrix/hr, or at least about 10 μL/g matrix/hr, or at least about 25 μL/g matrix/hr, or at least about 28 μL/g matrix/hr.

### Concentration

As mentioned above, in embodiments, where release characteristics of the cyclopropene is assessed by concentration, the concentration of cyclopropene released is measured over time after exposure to a liquid displacing medium or to a liquid displacing medium and a non-equilibrium condition at “time zero.” In some embodiments, composition exposure to a liquid displacing medium is contact with a liquid displacing medium. In some embodiments, composition exposure to a liquid displacing medium comprises contact with a liquid displacing medium. In some embodiments, composition contact with a liquid displacing medium comprises agitation of a composition with a liquid displacing medium. In some embodiments, composition exposure to a liquid displacing medium comprises contact and agitation of a composition with a liquid displacing medium. In some embodiments, “time zero” begins before agitation of the matrix and the liquid displacing medium. In some embodiments, “time zero” begins after agitation of the matrix and the liquid displacing medium. In some embodiments, “time zero” begins after sufficient agitation of the matrix and the liquid displacing medium. In some embodiments, “time zero” begins after agitation of the matrix and liquid displacing medium slurry. In some embodiments, agitation of the matrix and the liquid displacing medum occurs after time zero but before the first sample timepoint (e.g. minute 1). In an embodiment, exposure to a non-equilibrium condition is a condition that is not a liquid displacing medium. A non-limiting example of a non-equilibrium condition for the release parameters discussed herein are composition exposure to ambient room temperature (approximately 23-25° C.) and atmospheric pressure, with none of the cyclopropene detected in the atmosphere prior to commencement of the release test. It should be understood that throughout the duration of the release test, temperature and atmospheric pressure around the composition material is kept substantially constant. It should be further understood that the atmospheric concentration of the cyclopropene may vary throughout the duration of the release test as the cyclopropene is released from the composition into the surrounding atmosphere.

The concentration in ppm may be determined for a particular timepoint (e.g. hour, minute, etc.) by instantaneous sampling at that timepoint of (a) the volume, in μL, occupied by cyclopropene gas according to the ideal gas law, and (b) dividing the volume in (a) by the volume, in L, of total space containing the cyclopropene gas. In other words, the measurement “parts per million” (ppm) is defined as “p L cyclopropene gas/L of volume” and a ppm value is calculated by (a) determining the volume, in μL, occupied by cyclopropene gas according to the ideal gas law, and (b) dividing the volume in (a) by the volume, in L, of total space containing the cyclopropene gas.

A non-limiting example of how to measure the concentration of a cyclopropene from a composition at 60 minutes is as follows. The release study commences at time zero at the instant the composition (or matrix, as the case may be) is exposed to a liquid displacing medium or exposed to a liquid displacing medium and a non-equilibrium condition, as discussed above. The concentration in ppm at 60 minutes can be determined by instantaneous sampling at 60 minutes after time zero of (a) the volume, in μL, occupied by cyclopropene gas according to the ideal gas law, and (b) dividing the volume in (a) by the volume, in L, of total space containing the cyclopropene gas.

The sample of the cyclopropene collected is measured using conventional headspace methodologies (e.g. using a gas chromatograph (GC)). Those with ordinary skill in the art will be aware of conventional headspace methodologies that use, for example, gas chromatography (GC). A non-limiting example of a method that uses headspace analysis to measure concentration of cyclopropene is provided as follows. The composition or a sample of the matrix comprising the cyclopropene, may be placed in a vial for analysis (e.g. at time zero, when the composition is either a) exposed to a liquid displacing medium, or b) exposed to a liquid displacing medium and a non-equilibrium condition. The vial is sealed. It would be appreciated by one of ordinary skill in the art that the cyclopropene is permitted to build up over the duration of the test. As the cyclopropene is permitted to build-up over time while the vial is sealed, the concentration at a given time point can be calculated by sampling the headspace of the vial and injecting a sample volume (e.g. 100 μL to 300 μL) in a GC in accordance with methods known to those of ordinary skill in the art. The area of the GC peak may be calibrated by comparison against an internal standard. For example, for calculating the release of 1-methylcyclopropene (1-MCP) from a matrix, the area of the GC peak may be calibrated against known quantities of 1-MCP released from ETHYLBLOC™ (FLORALIFE*; Walterboro, S.C.). 1-MCP in the form of ETHYLBLOC™ is obtainable as a 0.14 wt % solid powder.

In some embodiments, the following concentration parameters pertain to release of cyclopropene from the compositions described herein. In some embodiments, the following rates of release are given for conditions where “time zero” (a.k.a. “minute zero”) means composition exposure to a liquid displacing medium. In some embodiments, the following rates of release are given for conditions where “time zero” (a.k.a. “minute zero”) means composition exposure to a liquid displacing medium and a non-equilibrium condition. In some embodiments, the concentration of cyclopropene sampled at minute 3 is less than about 55% of the concentration of cyclopropene sampled at minute 300. In some embodiments, the concentration of cyclopropene sampled at minute 3 is less than about 50% of the concentration of cyclopropene sampled at minute 300. In some embodiments, the concentration of cyclopropene sampled at minute 3 is less than about 40% of the concentration of cyclopropene sampled at minute 300. In some embodiments, the concentration of cyclopropene sampled at minute 3 is less than about 30% of the concentration of cyclopropene sampled at minute 300. In some embodiments, the concentration of cyclopropene sampled at minute 3 is less than about 20% of the concentration of cyclopropene sampled at minute 300. In some embodiments, the concentration of cyclopropene sampled at minute 3 is less than about 15% of the concentration of cyclopropene sampled at minute 300. In some embodiments, the concentration of cyclopropene sampled at minute 3 is less than about 10% of the concentration of cyclopropene sampled at minute 300. In some embodiments, the concentration of cyclopropene sampled at minute 30 is less than about 80% of the concentration of cyclopropene sampled at minute 300. In some embodiments, the concentration of cyclopropene sampled at minute 30 is less than about 70% of the concentration of cyclopropene sampled at minute 300. In some embodiments, the concentration of cyclopropene sampled at minute 30 is less than about 60% of the concentration of cyclopropene sampled at minute 300. In some embodiments, the concentration of cyclopropene sampled at minute 30 is less than about 50% of the concentration of cyclopropene sampled at minute 300. In some embodiments, the concentration of cyclopropene sampled at minute 30 is less than about 40% of the concentration of cyclopropene sampled at minute 300. In some embodiments, the concentration of cyclopropene sampled at minute 30 is less than about 30% of the concentration of cyclopropene sampled at minute 300. In some embodiments, the concentration of cyclopropene sampled at minute 30 is less than about 20% of the concentration of cyclopropene sampled at minute 300. In some embodiments, the concentration of cyclopropene sampled at minute 60 is less than about 90%, or less than about 80%, or less than about 70%, or less than about 60%, of the concentration of cyclopropene sampled at minute 300. In some embodiments, the concentration of cyclopropene sampled at minute 60 is less than about 50% of the concentration of cyclopropene sampled at minute 300. In some embodiments, the concentration of cyclopropene sampled at minute 60 is less than about 40% of the concentration of cyclopropene sampled at minute 300. In some embodiments, the concentration of cyclopropene sampled at minute 60 is less than about 35% of the concentration of cyclopropene sampled at minute 300. In some embodiments, the concentration of cyclopropene sampled at minute 90 is less than about 95%, or less than about 90%, or less than about 80%, or less than about 70%, or less than about 60% of the concentration of cyclopropene sampled at minute 300. In some embodiments, the concentration of cyclopropene sampled at minute 90 is less than about 50% of the concentration of cyclopropene sampled at minute 300. In some embodiments, the concentration of cyclopropene sampled at minute 90 is less than about 45% of the concentration of cyclopropene sampled at minute 300. In some embodiments, the concentration of cyclopropene sampled at minute 120 is less than about 95% of the concentration of cyclopropene sampled at minute 300. In some embodiments, the concentration of cyclopropene sampled at minute 120 is less than about 90% of the concentration of cyclopropene sampled at minute 300. In some embodiments, the concentration of cyclopropene sampled at minute 120 is less than about 80% of the concentration of cyclopropene sampled at minute 300. In some embodiments, the concentration of cyclopropene sampled at minute 120 is less than about 70% of the concentration of cyclopropene sampled at minute 300. In some embodiments, the concentration of cyclopropene sampled at minute 120 is less than about 60% of the concentration of cyclopropene sampled at minute 300. In some embodiments, the concentration of cyclopropene sampled at minute 120 is less than about 55% of the concentration of cyclopropene sampled at minute 300. In some embodiments, the concentration of cyclopropene sampled at minute 150 is less than about 95% of the concentration of cyclopropene sampled at minute 300. In some embodiments, the concentration of cyclopropene sampled at minute 150 is less than about 90% of the concentration of cyclopropene sampled at minute 300. In some embodiments, the concentration of cyclopropene sampled at minute 150 is less than about 80% of the concentration of cyclopropene sampled at minute 300. In some embodiments, the concentration of cyclopropene sampled at minute 150 is less than about 70% of the concentration of cyclopropene sampled at minute 300. In some embodiments, the concentration of cyclopropene sampled at minute 150 is less than about 65% of the concentration of cyclopropene sampled at minute 300. In some embodiments, the concentration of cyclopropene sampled at minute 180 is less than about 95%, or less than about 90%, or less than about 80%, or less than about 85% of the concentration of cyclopropene sampled at minute 300.

In some embodiments, the concentration of cyclopropene sampled at minute 3 is between about 3% and about 35%, or between about 3% and about 45%, or between about 3% and about 55%, or between about 5% and about 55% of the concentration of cyclopropene sampled at minute 300. In some embodiments, the concentration of cyclopropene sampled at minute 30 is between about 10% and about 50%, between about 10% and about 60%, or between about 10% and 70%, or between about 10% and 80%, or between about 15% and about 80% of the concentration of cyclopropene sampled at minute 300. In some embodiments, the concentration of cyclopropene sampled at minute 60 is between about 20% and about 50%, or between about 20% and about 60%, or between about 20% and about 70%, or between about 20% and about 80%, or 30% and about 80%, or between about 30% and about 90% of the concentration of cyclopropene sampled at minute 300. In some embodiments, the concentration of cyclopropene sampled at minute 90 is between about 25% and about 65%, or between about 25% and about 75%, or between about 25% and about 85%, or between about 25% and about 95%, or between about 35% and about 95% of the concentration of cyclopropene sampled at minute 300. In some embodiments, the concentration of cyclopropene sampled at minute 120 is between about 40% and about 65%, or between about 40% and about 75%, or between about 40% and about 85%, or between about 40% and about 95%, or between about 50% and about 95% of the concentration of cyclopropene sampled at minute 300. In some embodiments, the concentration of cyclopropene sampled at minute 150 is between about 50% and about 65%, or between about 50% and about 75%, or between about 50% and about 85%, or between about 50% and about 95%, or about 60% to about 95% of the concentration of cyclopropene sampled at minute 300. In some embodiments, the concentration of cyclopropene sampled at minute 180 between about 60% and about 75%, or between about 60% and about 85%, or between about 60% and about 95%, or between 75% to about 95% of the concentration of cyclopropene sampled at minute 300.

In some embodiments, one or more cyclopropene compounds may stored in and released from the delivery materials discussed herein. In a non-limiting embodiment, the use of compositions described herein can be used to improve the quality and shelf life of produce. When in the presence of produce, compositions described herein are able to release one or more cyclopropene compounds such that liberated at least one cyclopropene compound can contact the produce. The quality and shelf life of produce may be improved, for example, by inhibiting the effects of ethylene, enhancing or maintaining shelf life, color, firmness, weight, sweetness, flavor, heat or chill temperature tolerance, resistance to microbes, fungi, or other pathogens, and/or humidity tolerance. The products and processes described herein may be applied to either pre-harvest or post-harvest produce.

“Produce” as used herein and above means agricultural and horticultural products, including pre- and post-harvest unprocessed and processed agricultural and horticultural products. Examples of produce include, but are not limited to fruits, vegetables, flowers, ornamental plants, herbs, grains, seeds, fungi (e.g. mushrooms) and nuts. Processed produce refers to produce that has been altered by at least one mechanical, chemical, or physical process that modify the natural state or appearance of the produce. Mashed, cut, peeled, diced, squeezed, and chopped produce are non-limiting examples of processed produce. Produce also can refer to hydroponically-grown plants.

In a non-limiting embodiment, produce comprises berries. A composition comprising a delivery material and at least one cyclopropene may be used, for example, to extend the shelf life of berries, including but not limited to strawberries, raspberries, blueberries, blackberries, elderberries, gooseberries, golden berries, grapes, champagne grapes, Concord grapes, red grapes, black grapes, green grapes, and globe grapes.

In a non-limiting embodiment, produce comprises vegetables. Examples of vegetables that may be treated by the compositions described herein include, but are not limited to, leafy green vegetables such as lettuce (e.g., Lactuea sativa), spinach (Spinaca oleracea) and cabbage (Brassica oleracea; various roots such as potatoes (Solanum tuberosum), carrots (Daucus); snapbeans (Phaseolus vulgaris), bulbs such as onions (Allium sp.); herbs such as basil (Ocimum basilicum), oregano (Origanum vulgare) and dill (Anethum graveolens); as well as soybean (Glycine max), lima beans (Phaseolus limensis), peas (Lathyrus sp.), corn (Zea mays), broccoli (Brassica oleracea italica), cauliflower (Brassica oleracea botrytis) and asparagus (Asparagus officinalis).

In a non-limiting embodiment, produce comprises fruit. Examples of fruits that may be treated by the compositions described herein include, but are not limited to, tomatoes (Lycopersicon esculentum), apples (Malus domes tica), bananas (Musa sapientum), cherries (Prunus avium), grapes (Vitis vinifera), pears (Pyrus communis), papaya (Carica papya), mangoes (Mangifera indica), peaches (Prunus persica), apricots (Prunus armeniaca), nectarines (Prunus persica nectarina), oranges (Citrus sp.), lemons (Citrus limonia), limes (Citrus aurantifolia), grapefruit (Citrus paradisi), tangerines (Citrus nobilis deliciosa), kiwi (Actinidia. chinenus), melons such as cantaloupes (C. cantalupensis) and musk melons (C. melo), honeydew, pineapples (Aranae comosus), persimmon (Diospyros sp.), raspberries (e.g., Fragaria or Rubus ursinus), blueberries (Vaccinium sp.), green beans (Phaseolus vulgaris), members of the genus Cucumis such as cucumber (C. sativus), starfruit, and avocados (Persea americana).

In a non-limiting embodiment, produce comprises cut flowers or ornamental plants. Examples of ornamental plants that may be treated by the compositions described herein include, but are not limited to, potted ornamentals and cut flowers. Potted ornamentals and cut flowers which may be treated with the methods of the present invention include azalea (Rhododendron spp.), hydrangea (Macrophylla hydrangea), hibiscus (Hibiscus rosasanensis), snapdragons (Antirrhinum sp.), poinsettia (Euphorbia pulcherima), cactus (e.g., Cactaceae schlumbergera truncata), begonias (Begonia sp.), roses (Rosa sp.), tulips (Tulipa sp.), daffodils (Narcissus sp.), petunias (Petunia hybrida), carnation (Dianthus caryophyllus), lily (e.g., Lilium sp.), gladiolus (Gladiolus sp.), Alstroemeria (Alstroemaria brasiliensis), anemone (e.g., Anemone bland), columbine (Aquilegia sp.), aralia (e.g., Aralia chinesis), aster (e.g., Aster carolinianus), bougainvillea (Bougainvillea sp.), camellia (Camellia sp.), bellflower (Campanula sp.), cockscomb (Celosia sp.), falsecypress (Chamaecyparis sp.), chrysanthemum (Chrysanthemum sp.), clematis (Clematis sp.), cyclamen (Cyclamen sp.), freesia (e.g., Freesia refracta), and orchids of the family Orchidaceae.

In a non-limiting embodiment, produce comprises plants. Examples of plants that may be treated by the compositions described herein include, but are not limited to, cotton (Gossypium spp.), pecans (Carva illinoensis), coffee (Cofffea arabica), and weeping fig (Ficus benjamina), as well as dormant seedlings such as various fruit trees including apple, ornamental plants, shrubbery, and tree seedlings. In addition, shrubbery which may be treated with the compositions described herein include, but are not limited to, privet (Ligustrum sp.), photinea (Photina sp.), holly (Ilex sp.), ferns of the family Polypodiaceae, schefflera (Schefflera sp.), aglaonema (Aglaonema sp.), cotoneaster (Cotoneaster sp.), barberry (Berberris sp.), waxmyrtle (Myrica sp.), abelia (Abelia sp.), acacia (Acacia sp.), and bromeliades of the family Bromeliaceae.

In some embodiments, one or more cyclopropenes may be delivered to produce using the compositions described herein. In some embodiments, the cyclopropene is a plant growth regulator. In some embodiments, the cyclopropene is an ethylene inhibitor. For the purpose of this application, ethylene inhibitors reduce the observed biological effects of ethylene in any way, as by for example inhibition of ethylene biosynthesis, occlusion of ethylene receptor protein active sites, non-competitive inhibition of biological ethylene binding or other means of desensitization. Ethylene inhibitors can protect produce from ethylene damage, improving produce quality and shelf life, for example preserving texture, flavor, and aroma. In some embodiments, the cyclopropene is 1-methylcyclopropene (1-MCP). As used herein cyclopropene compounds are also referred to interchangeably herein as “cyclropropene” or “cyclopropenes”. Additionally, one or more cyclopropene compounds as used herein can mean one cyclopropene compound or more than one cyclopropene compound (e.g two cyclopropene compounds, three cyclopropene compounds, or more).

In some embodiments, the cyclopropene may be a cyclopropene compound. As used herein, a cyclopropene compound, also referred to herein interchangeably as a cyclopropene or cyclopropenes, is any compound with the formula

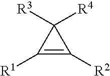

where each R¹, R², R³ and R⁴ is independently selected from the group consisting of H and a chemical group of the formula:

-(L)ₙ-Z,

where n is an integer from 0 to 12, each L is a bivalent radical, and Z is a monovalent radical. Non-limiting examples of L groups include radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (e.g., any one of R¹, R², R³ and R⁴) the total number of heteroatoms (e.g., atoms that are neither H nor C) is from 0 to 6. Independently, in any one R group the total number of non-hydrogen atoms is 50 or less. Non-limiting examples of Z groups are hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) akyl. In another embodiment, each of R¹, R², R³, and R⁴ is hydrogen or methyl. In another embodiment, R¹ is (C₁-C₄) alkyl and each of R², R³, and R⁷ is hydrogen. In another embodiment, R¹ is methyl and each of R², R³, and R⁴ is hydrogen, and the cyclopropene compound is known herein as 1-methylcyclopropene or “1-MCP.”

Other ethylene inhibitors useful for embodiments disclosed herein may also include: phosphonic acid compounds and derivatives thereof, for example, those disclosed in U.S. Pat. Nos. 3,879,188 and 6,562,758; diazocyclopentadiene and derivatives thereof, for example, those disclosed in U.S. Pat. No. 5,100,462; cyclopropene, 1.1.1, propellane, and derivatives thereof, for example, those disclosed in U.S. Pat. No. 5,518,988; and silver thiosulfate and derivatives thereof, and cyclopentene. The U.S. Patents mentioned in this paragraph are incorporated by reference in their entirety.

Again, as used herein cyclopropene compounds are also referred to interchangeably as “cyclropropene” or “cyclopropenes”. Additionally, one or more cyclopropene compounds as used herein can mean one cyclopropene compound or more than one cyclopropene compound (e.g two cyclopropene compounds, three cyclopropene compounds, or more). In some embodiments, cyclopropenes comprise organic compounds containing any unsubstituted or substituted three-carbon cyclic ring with an unsaturated or olefinic bond (of the root formula C₃Hₓ), or any organic compound containing a cyclopropene moiety. The simplest example of this class of molecules is cyclopropene, the simplest cycloalkene. The cyclopropene unit has a triangular structure. Cyclopropenes also include cyclopropene derivatives, such as 1-methylcyclopropene (1-MCP; molecular formula C₄H₆), or other cyclopropene derivatives (including, but not limited to borirenes, phosphirenes, and silirenes, which are boron-, phosphorus-, and silicon-substituted cyclopropenes respectively).

In an embodiment, a composition comprises a delivery material being a carbon material and a cyclopropene. In a non-limiting embodiment, the cyclopropene is 1-MCP.

The delivery material may be used to store and/or release the cyclopropene. Many of the above-described cyclopropenes may be in the vapor phase or gaseous, including cyclopropenes such as 1-MCP. In some embodiments, the delivery material is a solid material.

In some embodiments, the delivery material is a solid material having a high surface area, as described in more detail herein. In some embodiments, the delivery material is porous. In some embodiments, the delivery material is nanoporous. Non-limiting examples of porous materials are macroporous, mesoporous, and microporous materials. In some embodiments, the porous and/or nanoporous delivery material comprises one or more of macropores, mesopores, and micropores. In a non-limiting embodiment, macropores are pores having a diameter greater than 50 nm. For example, macropores may have diameters of between 50 and 1000 nm. In a non-limiting embodiment, mesopores are pores having a diameter between 2 nm and 50 nm. In a non-limiting embodiment, micropores are pores having a diameter of less than 2 nm. For example, micropores may have diameters of between 0.2 and 2 nm.

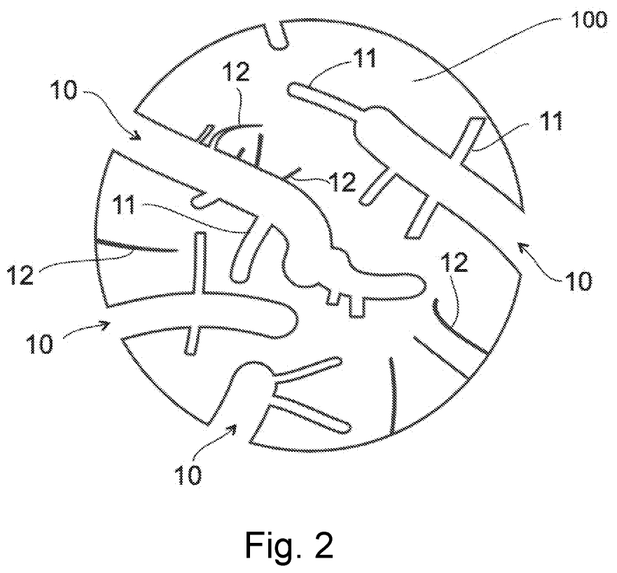

In a non-limiting embodiment, the delivery material is a carbon material, also referred to herein as a carbon-based delivery material. A carbon material may be of various geometries and formations including, but not limited to, macroporous, mesoporous, and microporous carbon materials, monolithic carbon materials, extruded or pelletized carbon materials, steam-activated carbon materials, oxidized carbon materials, or acid- or base-treated carbon materials. FIG. 2 shows a cross-section of an illustrative embodiment of a delivery material 100. In a non-limiting embodiment, delivery material 100 is a carbon based delivery material. In the illustrative embodiments of FIG. 1 and FIG. 2, delivery material 100 contains at least one macropore 10, at least one mesopore 11, and at least one micropore 12. In other embodiments, a porous delivery material 100 contains only either one or all of macropores 10, mesopores 11, and micropores 12. In other embodiments, a porous delivery material 100 contains only either one or both of macropores 10 and mesopores 11. In yet other embodiments, a porous material does not contain internal micropores or mesopores, limiting the porosity to macropores 10. In an embodiment, a liquid displacing medium in contact with a porous delivery material charged with cyclopropene displaces the cyclopropene from the pores of the delivery material to effect release.

In some embodiments, a carbon delivery material may be a commercially available carbon material which is offered in a wide array of states with respect to surface areas, porosities, degrees of surface functionalization, degree of oxidation, acidity, basicity, and other chemical and physicochemical features. As such, in some embodiments, the following commercial carbon materials may be used as delivery material for the compositions matrices described herein: carbon black (e.g. such as generally indicated by CAS No.: 1333-86-4) or lampblack carbon; activated carbon or activated charcoal (e.g. such as generally indicated by CAS No.: 7440-44-0); carbon in powder, granule, film, or extrudate form; optionally, carbon mixed with one or more adjuvants or diluents; carbon sold as DARCO® carbon (Sigma-Aldrich), ELORIT® (Cabot Corporation), HYDRODARCO® (Cabot Corporation), NORIT® carbon (Cabot Corporation), PETRODARCO® carbon (Cabot Corporation), BENTONORIT® carbon (Cabot Europe), SORBONORIT® carbon (Cabot Corporation), and the like; carbon sold as OXPURE™ carbon (Oxbow Activated Carbon); carbon derived from coconut, coal, wood, anthracite, or sand (Carbon Activated Corporation) and the like; reactivated carbon; ash, soot, char, charcoal, coal, or coke; vitreous carbon; glassy carbon; bone charcoal. Each of those carbons, whether commercially acquired or manufactured by hand as known in the art can be further modified to form other delivery materials 100 by operations including, but not limited to heat treating materials, oxidation, and/or acid- or base-treatment to arrive at other delivery materials and matrices described herein. Therefore, any carbons derived from: carbon black or lampblack carbon, activated carbon or activated charcoal, carbon in powder, granule, film, or extrudate form, any carbon sold as DARCO®, ELORIT®, HYDRODARCO®, NORIT®, PETRODARCO®, BENTONORIT®, SORBONORIT®, OXPURE™, reactivated carbon, ash, soot, char, charcoal, coal, or coke, vitreous carbon, glassy carbon, or bone charcoal through the modification of the parent carbon with, for example, adsorption-modifying functionalities, one or more acids, bases, oxidants, hydrolyzing reagents, or a combination thereof is within the scope of this invention to form the compositions described herein.

In a non-limiting embodiment, a delivery material that is a carbon material comprises about 75 to about 100% carbon. In a non-limiting embodiment, a delivery material that is a carbon material comprises about 80 to about 100% carbon. In a non-limiting embodiment, a delivery material that is a carbon material comprises about 90 to about 100% carbon. In a non-limiting embodiment, a delivery material that is a carbon material comprises about 95 to about 100% carbon. In a non-limiting embodiment, a delivery material that is a carbon material comprises 93-99% carbon. In a non-limiting embodiment, a delivery material that is a carbon material comprises 94-98% carbon. In a non-limiting embodiment, a delivery material that is a carbon material comprises about 90 to about 95% carbon. As would be appreciated by one of ordinary skill in the art, delivery materials described as comprising about 75 to about 100% carbon, or about 80 to about 100% carbon, or about 90 to about 100% carbon, or about 95 to about 100% carbon, or about 93-99% carbon, or about 94-98% carbon mean that the delivery materials contain about 75 to about 100 wt % carbon, or about 80 to about 100 wt % carbon, or about 90 to about 100 wt % carbon, or about 95 to about 100 wt % carbon, or about 93-99 wt % carbon, or about 94-98 wt % carbon, respectively.

In a non-limiting embodiment, a delivery material comprises an adsorption-modifying functionality. In a non-limiting embodiment, a delivery material comprises an adsorption-modifying functionality. An adsorption-modifying functionality is any chemical functionality that modifies the interaction between a cyclopropene and a delivery material, such that the introduction of the chemical functionality (a) increases or decreases the storage capacity of a delivery material (with respect to the storage capacity of the delivery material absent that chemical functionality) for a cyclopropene, or (b) accelerates or decelerates the release of an a cyclopropene from a delivery material (with respect to the release of cyclopropene from the delivery material absent that chemical functionality). Such modifiable interactions include, but are not limited to, covalent binding, dative binding, electrostatic binding, van der Waals binding, or chelative binding of an appropriate cyclopropene. The interaction between an cyclopropene and a matrix comprising a delivery material modified by an adsorption-modifying functionality may sometimes be referred to herein as ensemble dynamic interactions. Turning to adsorption-modifying functionalities, an example of an adsorption-modifying functionality is one or more hydrophobic groups, for instance trimethylsilyl-functionalities, incorporated in a delivery material via grafting. In a non-limiting embodiment, a delivery material comprises more than one type of adsorption-modifying functionality.

A non-limiting example of a carbon based delivery material and method of manufacture are provided below:

A carbon based delivery material modified with adsorption-modifying functionalities can be prepared in the following manner, resulting in a hydrophilically-modified delivery material. A commercial activated carbon, NORIT A®, may be purchased from Fisher Scientific. As received, the material has a surface area of 1146 m²/g. A quantity, 10 g, of this material is suspended in 100 mL of 70% nitric acid in water. The mixture is then refluxed for 18 hours, during which time reddish-brown gases evolve during the oxidation of the carbon surface. After the reaction is complete the solid is recovered by filtration and washed with water until the pH of the water wash is neutral. The solid is then dried at 100° C. This procedure results in a material with a smaller pore size and surface area than the parent activated carbon, but with hydrophilically modified walls, enabling ensemble dynamic interactions (including for example, a modified chemical potential) of the matrix with hydrophobic cyclopropenes such as 1-MCP as compared to its interaction with the unmodified parent material. The surface area after such a treatment was measured to be 1001 m²/g.

The delivery material may be comprised of a polymer, inorganic material, organic material, or hybrid thereof. In a non-limiting embodiment, the polymer, inorganic, organic, or hybrid inorganic-organic material comprises 0-99.99 wt % of the delivery material. In a non-limiting embodiment, the polymer, inorganic, organic, or hybrid inorganic-organic material comprises 0-99.99 wt % of the matrix. In a non-limiting embodiment, the polymer, inorganic material, organic material, or hybrid material of the matrix may be an inert material, which does not chemically interact with the cyclopropene stored in the matrix. In alternative embodiments, a cyclopropene may experience significant physicochemical interactions with the inert chemical surface, internal and/or external, of an inert delivery material. In a non-limiting embodiment, the polymer, inorganic material, organic material, or hybrid material of the matrix may be a chemically active material, which chemically interacts with the cyclopropene stored in the matrix.

In a non-limiting embodiment, the delivery material 100 is a solid material or solid carrier such as that typified by nanoporous, macroporous, mesoporous, and microporous carbon materials, templated organic materials of a type exemplified by mesoporous carbon, extruded or pelletized carbon materials, steam-activated carbon materials, oxidized carbon materials, or acid- or base-treated carbon materials. In a non-limiting embodiment, the delivery material has an elemental composition indistinguishable from that of ash. In a non-limiting embodiment, the delivery material having an elemental composition indistinguishable from that of ash stores and/or releases a vapor or gas. In a non-limiting embodiment, the delivery material has an elemental composition indistinguishable from biochar, flue char, or soot. In a non-limiting embodiment, the delivery material having an elemental composition indistinguishable from that of biochar, flue char, or soot stores and/or releases a vapor or gas.

In a non-limiting embodiment, the delivery materials 100 are solid materials. In a non-limiting embodiment porous delivery materials 100 are also high surface area materials. In a non-limiting embodiment, a high-surface area material is a material with a total chemical surface area, internal and external, of at least about 1 m²/g. In some embodiments, a high-surface area material is a material with a total chemical surface area, internal and external, of at least about 10 m²/g. In some embodiments, a high-surface area material is a material with a total chemical surface area, internal and external, of at least about 50 m²/g. In some embodiments, a high-surface area material is a material with a total chemical surface area, internal and external, of at least about 90 m²/g. In some embodiments, a high-surface area material is a material with a total chemical surface area, internal and external, greater than about 400 m²/g. In some embodiments, a high-surface area material is a material with a total chemical surface area, internal and external, of at least about 500 m²/g. In some embodiments, a high-surface area material is a material with a total chemical surface area, internal and external, greater than about 1000 m²/g. In some embodiments, a high-surface area material is a material with a total chemical surface area, internal and external, greater than about 2000 m²/g. The terms “total chemical surface area, internal and external”, “chemical surface area” and “surface area” are used interchangeably herein. Those of ordinary skill in the will be aware of methods for determining the total chemical surface area, internal and external, for example, using Brunauer-Emmett-Teller (BET) analysis.

In a non-limiting embodiment, a porous material is a material with a micropore diameter greater than about 0.1 nm. In a non-limiting embodiment, a porous material is a material with a micropore diameter greater than about 1 nm. In a non-limiting embodiment, a porous material is a material with a mesopore diameter between about 2 nm and about 5 nm. In some embodiments, a porous material is a material with an average pore diameter greater than 4 nm. In some embodiments, a porous material is a material with an average pore diameter greater than 6 nm. In a non-limiting embodiment, a porous delivery material is a material with an internal void volume greater than 0.1 cm³/g. In a non-limiting embodiment, a porous delivery material is a material with an internal void volume greater than 0.5 cm³/g. In a non-limiting embodiment, a porous material is a material with an internal void volume greater than 1 cm³/g. In a non-limiting embodiment, a porous material is a material with an internal void volume greater than 1.5 cm³/g. As used herein, the terms “internal void volume” and “pore volume” may be used interchangeably.

In a non-limiting embodiment, a carbon-based delivery material comprises one or more of the following properties: a density in the range of 0.1-3 g/cm³; a pore volume in the range of 0.1-1.5 cm³/g; a surface area in the range of 500-4000 m²/g; moisture content in the range of 0-30%; and an iodine number in the range of 0-1200 mg/g. As would be appreciated by one of ordinary skill in the art, delivery materials described as comprising moisture content in the range of 0-30% mean that delivery materials have a 0-30 wt % moisture content.

In a non-limiting embodiment, a carbon based delivery material has a density in the range of about 0.1 to about 0.3 g/cm³. In a non-limiting embodiment, a carbon-based delivery material has a density in the range of about 0.1 to about 0.4 g/cm³. In a non-limiting embodiment, a carbon-based delivery material has a density in the range of about 0.2 to about 0.4 g/cm³. In a non-limiting embodiment, a carbon-based delivery material has a density in the range of about 0.3 to about 0.6 g/cm³. In a non-limiting embodiment, a carbon-based delivery material has a density in the range of about 0.3 to about 1.0 g/cm³. In a non-limiting embodiment, a carbon-based delivery material has a density in the range of about 0.6 to about 1.0 g/cm³. In a non-limiting embodiment, a carbon-based delivery material has a density in the range of about 1 to about 3 g/cm³. In a non-limiting embodiment, a carbon-based delivery material has a density in the range of about 0.3 to about 1.5 g/cm³. In a non-limiting embodiment, a carbon-based delivery material has a density in the range of about 0.05 to about 0.15 g/cm. In a non-limiting embodiment, a carbon-based delivery material has a density in the range of about 0.15 to about 0.3 g/cm³. In a non-limiting embodiment, a carbon-based delivery material has a density in the range of about 0.15 to about 0.4 g/cm³. In a non-limiting embodiment, a carbon-based delivery material has a density in the range of about 0.3 to about 0.7 g/cm³. In a non-limiting embodiment, a carbon-based delivery material has a density in the range of about 1 to about 1.5 g/cm³. In a non-limiting embodiment, a carbon-based delivery material has a density in the range of about 0.5 to about 1.5 g/cm³. In a non-limiting embodiment, a carbon-based delivery material has a surface area in the range of about 1 to about 3000 m²/g. In a non-limiting embodiment, a carbon-based delivery material has a surface area in the range of about 1 to about 50 m²/g. In a non-limiting embodiment, a carbon-based delivery material has a surface area in the range of about 50 to about 500 m²/g. In a non-limiting embodiment, a carbon-based delivery material has a surface area in the range of about 100 to about 1500 m²/g. In a non-limiting embodiment, a carbon-based delivery material has a surface area in the range of about 500 to about 1500 m²/g. In a non-limiting embodiment, a carbon-based delivery material has a surface area in the range of about 1000 to about 1500 m²/g. In a non-limiting embodiment, a carbon based delivery material has a surface area in the range of about 500 to about 2000 m²/g. In a non-limiting embodiment, a carbon based delivery material has a surface area in the range of about 1000 to about 2500 m²/g. In a non-limiting embodiment, a carbon-based delivery material has a surface area in the range of about 1000 to about 3000 m²/g. In a non-limiting embodiment, a carbon-based delivery material has a surface area in the range of about 800 to about 1200 m²/g. In a non-limiting embodiment, a carbon-based delivery material has a surface area in the range of about 800 to about 1500 m²/g. In a non-limiting embodiment, a carbon-based delivery material has a moisture content in the range of 0 to about 2%. In a non-limiting embodiment, a carbon-based delivery material has a moisture content in the range of 2 to about 5%. In a non-limiting embodiment, a carbon-based delivery material has a moisture content in the range of 5 to about 15%. In a non-limiting embodiment, a carbon-based delivery material has a moisture content in the range of 15 to about 25%. In a non-limiting embodiment, a carbon-based delivery material has a moisture content in the range of 25 to about 50%. In a non-limiting embodiment, a carbon-based delivery material has a moisture content in the range of 50 to about 100%. As would be appreciated by one of ordinary skill in the art, moisture content percentages mean wt % of moisture in the carbon-based delivery material prior to exposure to a displacing medium (whether liquid or vapor, as the case may be).

In certain embodiments, moisture content is a property of the delivery material itself rather than the result of contact between the delivery material and the liquid displacing medium. In a non-limiting embodiment, a carbon-based delivery material has an iodine number in the range of about 0-500. In a non-limiting embodiment, a carbon-based delivery material has an iodine number in the range of about 500-1000. In a non-limiting embodiment, a carbon-based delivery material has an iodine number in the range of about 1000-1500. In a non-limiting embodiment, a carbon-based delivery material has a pore volume of about 0.1 cm³/g to about 1.5 cm³/g. In a non-limiting embodiment, a carbon-based delivery material has a pore volume of about 0.5 cm³/g to about 1.5 cm³/g. In a non-limiting embodiment, a carbon-based delivery material has a pore volume of about 0.7 cm³/g to about 1.5 cm³/g. In a non-limiting embodiment, a carbon-based delivery material has a pore volume of about 1 cm³/g to about 1.5 cm³/g.

FIG. 1 shows a cross-section of a non-limiting illustrative embodiment of a matrix 200 comprising a cyclopropene 20 and a delivery material 100. In a non-limiting embodiment, a matrix consists essentially of a delivery material 100 and a cyclopropene 20. As shown in FIG. 1, matrix 200 comprises a porous delivery material 100 and a cyclopropene 20. In the embodiment illustrated by FIG. 2, matrix 200 contains at least one macropore 10, at least one mesopore 11, and at least one micropore 12. In a non-limiting embodiment, at least one of the macropore 10, mesopore 11, and micropore 12 stores cyclopropene 20. The matrix 200 illustrates cyclopropene 20 stored in macropores 10 and mesopores 11 of the matrix 200. Micropores 12 may also store cyclopropene 20. As FIG. 1 is a non-limiting example and is not drawn to scale, it should be noted that other storage concentrations of cyclopropene 20 in matrix 200 can be achieved by the embodiments contemplated herein. Moreover, different positions of cyclopropene 20 within the pores 10, 11, 12 of matrix 200 are also contemplated. In a non-limiting embodiment, cyclopropene 20 is 1-MCP.

FIG. 1 also illustrates cyclopropene 21. Cyclopropene 21 is the same cyclopropene as cyclopropene 20; however, cyclopropene 21 has been released or liberated from matrix 200. The matrices herein may be configured for release of cyclopropene. In a non-limiting embodiment the cyclopropene is in the vapor phase or gas phase.

In some embodiments, cyclopropene may be present in the delivery material at up to about 25% by weight of the overall matrix. The storage capacity for cyclopropene can be uniquely tailored in the matrices described herein as a function of at least (a) the nature of the cyclopropene employed, including, but not limited to hydrophobicity, molecular weight, and boiling point of the cyclopropene; (b) the physicochemical characteristics of the delivery material, including but not limited to the hydrophobicity, chemical surface area, crystallinity, and/or pore size and volume within the delivery material; and (c) the chemical characteristics of the delivery material, including, but not limited to, the hydrophobicity or hydrophilicity of the delivery material, the degree of chemical functionalization of the delivery material (for instance by sulfonic, nitric, or carboxylic acid groups), the degree of oxidation of the delivery material, or the degree of aliphatic and aromatic functionalization of the delivery material. For example, delivery materials as described herein comprised of 75-100% carbon and having surface areas of 800-2000 m²/g can be charged with 0-25 wt % of cyclopropene via contact in either the liquid or gas phase with said cyclopropene. As would be appreciated by one of ordinary skill in the art, delivery materials described as comprising 75-100% mean that delivery materials contain 75-100 wt % carbon.

Preparation, loading, or charging of the delivery material with an cyclopropene to produce a matrix can be performed by, for example and including, but not limited to, directly contacting the delivery material with the pure liquid cyclopropene; directly contacting the delivery material with a solution of any kind containing the cyclopropene; directly contacting the delivery material with a cyclopropene in pure gas form; directly contacting the delivery material with a gas mixture containing the cyclopropene; directly contacting the delivery material with a cyclopropene in the vapor phase; directly contacting the delivery material with a gas mixture containing the cyclopropene in the vapor phase.

Treatment of the prepared, loaded, or charged matrix after such a preparation can occur via, but is not limited to, removal of excess cyclopropene by vacuum, distillation, evaporation, or blow-off; removal of excess solvent by vacuum, distillation, evaporation, or blow-off; isolation of the matrix under inert atmosphere, for instance nitrogen, to preserve the nature of the cyclopropene; isolation of the matrix at low temperatures, for instance −20° C. or −30° C., to preserve the nature of the cyclopropene and/or prevent or retard release of the cyclopropene from the matrix; steaming the matrix with water at an elevated temperature (20° C. or greater) to accelerate release of the cyclopropene; and other methods.

Heating is not required to liberate cyclopropene from the compositions herein. Additionally, heating is not required to modify the release of cyclopropenes from compositions herein. In some embodiments, the temperature of the liquid displacing medium that contacts the matrix or composition and results in release or modified release of the one or more cyclopropene compounds is less than 70° C., or is less than 65° C., or is less than 60° C., or is less than 55° C., or is less than 50° C., or is less than 45° C., or is less than 40° C., or is less than 35° C., or is less than 30° C., or is less than 25° C., or is less than 20° C., or is less than 15° C., or is less than 10° C., or is less than 5° C., or is less than 4° C., or is less than 3° C., or is less than 2° C., or is less than 1° C., or is less than 0° C., or is less than −1° C. In certain embodiments, the temperature of the liquid displacing medium that contacts the delivery material is at any temperature between about −2° C. and about 70° C., or between about −1° C. and about 70° C., or between about 0° C. and about 70° C., or between about 1° C. and about 70° C., or between about 5° C. and about 70° C., or between about 10° C. and about 70° C., or between about 15° C. and about 70° C., or between about 20° C. and about 70° C., or between about 25° C. and about 70° C., or between about 30° C. and about 70° C., or between about 40° C. and about 70° C., or between about −2° C. and about 65° C., or between about −1° C. and about 65° C. between about 0° C. and about 65° C., or between about 1° C. and about 65° C., or between about 5° C. and about 65° C., or between about 10° C. and about 65° C., or between about 15° C. and about 65° C., or between about 20° C. and about 65° C., or between about 25° C. and about 65° C., or between about 30° C. and about 65° C., or between about 40° C. and about 65° C., or between about −2° C. and about 60° C., or between about −1° C. and about 60° C., or between about 0° C. and about 60° C., or between about 1° C. and about 60° C., or between about 5° C. and about 60° C., or between about 10° C. and about 60° C., or between about 15° C. and about 60° C., or between about 20° C. and about 60° C., or between about 25° C. and about 60° C., or between about 30° C. and about 60° C., or between about 40° C. and about 60° C., or between about −2° C. and about 50° C., or between about −1° C. and about 50° C., or between about 0° C. and about 50° C., between about 1° C. and about 50° C., or between about 5° C. and about 50° C., or between about 10° C. and about 50° C., or between about 15° C. and about 50 C, or between about 20° C. and about 50° C., or between about 25° C. and about 50° C., or between about 30° C. and about 50° C., or between about 40° C. and about 50° C., or between about −2° C. and about 45° C., or between about −1° C. and about 45° C., or between about 0° C. and about 45° C., or between about 1° C. and about 45° C., or between about 5° C. and about 45° C., or between about 10° C. and about 45° C., or between about 15° C. and about 45° C., or between about 20° C. and about 45° C., or between about 25° C. and about 45° C., or between about 30° C. and about 45° C., or between about 40° C. and about 45° C., or between about −2° C. and about 40° C., or between about −1° C. and about 40° C., or between about 0° C. and about 40° C., or between about 1° C. and about 40° C., or between about 5° C. and about 40° C., or between about 10° C. and about 40° C., or between about 15° C. and about 40° C., or between about 20° C. and about 40° C., or between about 25° C. and about 40° C., or between about 30° C. and about 40° C., or between about −2° C. and about 35° C., or between about −1° C. and about 35° C., or between about 0° C. and about 35° C., or between about 1° C. and about 40° C., or between about 5° C. and about 35° C., or between about 10° C. and about 40° C., or between about 15° C. and about 35° C., or between about 20° C. and about 35° C., or between about 25° C. and about 35° C., or between about −2° C. and about 30° C., or between about −1° C. and about 30° C., or between about 0° C. and about 30° C., or between about 1° C. and about 30° C., or between about 5° C. and about 30° C., or between about 10° C. and about 30° C., or between about 15° C. and about 30° C., or between about 20° C. and about 30° C., or between about 25° C. and about 30° C., or between about −2° C. and about 25° C., or between about −1° C. and about 25° C., or between about 0° C. and about 25° C., or between about 1° C. and about 25° C., or between about 5° C. and about 25° C., or between about 10° C. and about 25° C., or between about 15° C. and about 25° C., or between about 20° C. and about 25° C., or between about −2° C. and about 20° C., or between about −1° C. and about 20° C., or between about 0° C. and about 20° C., or between about 1° C. and about 20° C., or between about 5° C. and about 20° C., or between about 10° C. and about 20° C., or between about 15° C. and about 20° C.

The matrices may be incorporated into a structure, for example, non-wovens, wovens, knits, coated substrates, impregnated substrates, various forms of paper, cardboard, paper products, paper derivatives, fabrics, fibers, films, cloths, and coatings. The matrices may also be incorporate into a structure such as wood, metal, clays, pulp, plastics, and other materials commonly used for planting, potting, shipping, harvesting, crating, storing, and supporting produce. The structures may be formed from natural materials, synthetic materials, or a combination thereof. Other structures may include dispersions, froths, foams, powders, flakes, pellets, or the like. In some embodiments, the matrices may be incorporated into a structure through compression molding, extrusion, injection molding, blow molding, dry spinning, melt spinning, wet spinning, solution casting, spray drying, solution spinning, film blowing, calendaring, rotational molding, powder injection molding, thixomolding, and other various methods.

The matrices may be incorporated into a sachet, insert, paint, gel, coating, powder or encased in a capsule, pod, compartment, or container for the purpose of sale and ease of use for application. These means of application may apply to any scale of treatment space or cyclopropene application, and may be adapted to the particular compartment or container of target produce.

In a non-limiting embodiment, the matrix is incorporated into a structure or form factor by being sealed inside the structure or form factor. In a non-limiting embodiment, the structure or form factor is comprised of a material that is one or more of food safe, non-absorptive, air permeable (but not necessarily porous). In a non-limiting embodiment, the one or more of food safe, non-absorptive, air permeable (but not necessarily porous) structure comprises a sachet. In a non-limiting embodiment, the sachet is porous. In an embodiment, the delivery material is charged with cyclopropene prior to be deposited and sealed in a sachet. For example, the sachet may be prepared by depositing the composition in the sachet and then sealing the sachet.

In a non-limiting embodiment, a sachet material comprises one of a polypropylene material, polyethylene material (e.g. TYVEK™), and a cellulose based material. In a non-limiting embodiment, the Gurley Hill porosity measurement of a sachet material is 45-60 sec/100 cm²-in. In some embodiments, the structure comprising the matrix or the means of holding, encapsulating, encasing, or enrobing the material may further modulate cyclopropene release properties. In some embodiments, the composition and/or the structure containing the matrix therein may be transported in hermetically sealed packaging.

In some embodiments, the compositions herein may be used as soil additives. In a non-limiting embodiment, the matrices discussed herein can be used in or incorporated into refrigeration systems and other cold compartments, refrigeration filtration systems and the like.

The rate of release of the cyclopropene(s) from the matrix disclosed herein may be controlled in various manners, some of which are discussed above. The rate of release may also be affected, for example, by varying the concentration of the cyclopropene in the matrix. The rate of release may also be affected, for example, by modifying certain characteristics of the delivery material, for example, by varying the size of the delivery material's particles, by introducing a binder, oil, or other manner of encapsulation, including, but not limited to, encapsulation using a hydrogel or polymer. The rate of release may also be affected, for example, by mixing a combination of two or more delivery materials with different compositions with respect to any of the above variables.

In some embodiments, the rate of release or amount of release may also be controlled by selecting a desired quantity of the delivery material or composition. For example, in a non-limiting embodiment, a user may select a smaller mass of composition for a smaller release of cyclopropene, or a larger mass for a greater release of cyclopropene. In some embodiments, the presence of additives may influence the rate of release of cyclopropene. For example, adding a diluent material may modify the rate of release, amount of release, or concentration of cyclopropene present in the total composition (e.g. including the diluent material). As a non-limiting example, a diluent material is combined, mixed with, or added to an already formed composition (e.g. comprising a delivery material impregnated with cyclopropene). In some cases, the diluent material is a different material than the delivery material used in the composition. In some cases, the diluent material may be the same material as the delivery material used in the composition. As a non-limiting example, a diluent material may be a carbon based material which is mechanically mixed with a composition (e.g. comprising a carbon-based delivery material impregnated with cyclopropene) after the composition has been formed. As another non-limiting example, a diluent material may be an activated carbon which is mixed with a composition (e.g. an activated carbon delivery material impregnated with cyclopropene) after the composition has been formed. As another non-limiting example, a diluent material may be a silicate material which is mixed with the composition after the composition has been formed.

In a non-limiting embodiment, the release of cyclopropene from the matrix can be accomplished passively, that is, without the addition of external wetting, hydrating, or chemically reactive agents in order to affect the release of the cyclopropene from the delivery material. In other embodiments, an initial release of the cyclopropene may be obtained within seconds or minutes of the matrix disclosed herein contacting water.

In a non-limiting embodiment, contact between a matrix and a liquid displacing medium accelerates release of the cyclopropene versus the release of the cyclopropene without the liquid displacing medium. In a non-limiting embodiment of a matrix wherein wetting or hydrating of the matrix is not required for release of the cyclopropene, contact between the matrix and a liquid displacing medium accelerates release of the cyclopropene from the matrix versus the release of the cyclopropene without wetting or hydrating.

While heating is not required to release cyclopropene from the compositions herein, in some embodiments, the release of cyclopropene from the matrix may occur as a function of temperature. For example, delayed release may be accomplished by storing the matrix at very low temperatures (e.g. approximately −20° C. or lower) until release is desired, for example, at any temperature between −2° C. and 40° C. or any temperature between 0° C. and 40° C. In some embodiments, an initial release of the cyclopropene may be delayed for several hours. In other embodiments, an initial release of the cyclopropene may be delayed for several days, weeks, or months.

In a non-limiting embodiment, cyclopropene is liberated from the delivery material without the use of a solvent. In a non-limiting embodiment, after delayed release and once release is desired, the cyclopropene is liberated from the delivery material without the use of a solvent. In an embodiment, cyclopropene is liberated from the delivery material without the use of a solvent at temperatures between 0° C. and ambient room temperature. In an embodiment, cyclopropene is liberated from the delivery material without the use of a solvent at temperatures between −2° C. and 40° C. In a non-limiting embodiment, the matrices described herein may provide for an initial release of cyclopropene upon exposure to air (for example, at temperatures between −2° C. and 40° C.), and a second release of cyclopropene upon contact with moisture, humidity, and/or a liquid displacing medium.

In embodiments where the matrices are in contact with, embedded on, embedded within, or incorporated into a structure, the structure can be sized appropriately to control release of the cyclopropene. Discrete structures, for example, pellets, flakes, and powders are advantageous for use in applications requiring a measurable or controllable dosage of the cyclopropene. Pellets and flakes may be advantageous for various dispersal methods, for example, where the pellets or flakes are scattered throughout a field during planting or prior to harvesting. Films and sheets, for example, may also provide measurable and controllable dosage due to the ability of the user to select a desired length of film or sheet. In other embodiments a smaller area or smaller volume of the structure may be selected for smaller release amounts of cyclopropene. In other embodiments, the rate of release may be influenced based upon the rate in which the hygroscopic components used in forming the structure dissolve or swell in water. In other embodiments, the rate of release may be affected by the rate at which water or another liquid displacing medium diffuses through the structure and the location of the matrix within the structure.

Various applications for which the cyclopropenes disclosed herein may be used may require different amounts of cyclopropene dosing. As described above, structures described herein may advantageously provide for selective dosing. Other applications may require different doses of cyclopropene to be delivered at various times. Structures and compositions described herein may provide for various modes of degradation, allowing for multiple releases or multiple release rates. As would be appreciated by one of ordinary skill in the art, degradation of structures and compositions as discussed above refer to formulations in which the structure or composition that holds the cyclopropene degrades in order to allow for different rates of release of the cyclopropene. In some embodiments, compositions and structures disclosed herein may provide an initial burst or high-concentration release of cyclopropene, followed by a lower-concentration release over time. In other embodiments, compositions and structures disclosed herein may provide an initial low-concentration release over time, followed by a high-concentration release at a given time or condition.

These and other aspects will be further appreciated upon consideration of the following Examples, which are intended to illustrate certain particular embodiments of the invention but are not intended to limit its scope, as defined by the claims.

### EXAMPLES

### 1-Methylcyclopropene (1-MCP)

While the examples described below are related to the storage of the cyclopropene 1-MCP in and its release from the delivery materials described herein, a person skilled in the art would appreciate that the same or similar charging methods can be effective, for example, for cyclopropene, other cyclopropene derivatives, cyclopentadiene, diazocyclopentadiene, their derivatives, and other cyclopropenes to arrive at the matrices described herein. These examples use 1-MCP because it is one of the most active derivatives of cyclopropene that binds to the ethylene receptor site of plants.

### Synthesis and Generation of 1-MCP

Synthesis methods for generating 1-MCP are known in the art. Herein described are three examples of known methods for generating 1-MCP, appreciating that other methods for generating 1-MCP may also be employed.

### Generation of 1-MCP: Example 1

1-MCP is purchased in powder form as ETHYLBLOC™ (FLORALIFE®; Walterboro, S.C.), which contains 0.14% 1-MCP by weight. Depending on the concentration of 1-MCP gas desired, the ETHYLBLOC™ powder is weighed and placed in a glass flask holding distilled water as a solvent. The solution is then mixed and held at room temperature, for example, over time to develop the desired concentration of 1-MCP gas. The glass flask holding the 1-MCP gas has a gas inlet and outlet port to allow continuous flow. 1-MCP generation as extracted from ETHYLBLOC™ has been described in the art. For example, see “Development of a 1-Methylcyclopropene (1-MCP) Sachet Release System,” Journal of Food Science, 2006, Vol. 71, Nr. 1; p. C1-C6, which is incorporated herein by reference.

### Generation of 1-MCP: Example 2

1-MCP is generated from a 1-MCP-Li suspension in mineral oil, which is prepared by reacting lithium diisopropylamide (LDA) with 3-chloro-2-methylpropene under a nitrogen environment which is described in “Kinetics of Molecular Encapsulation of 1-Methylcyclopropene into α-Cyclodextrin,” Journal of Agricultural and Food Chemistry, 2007, 55(26): p. 11020-11026, which is incorporated herein by reference in its entirety. Table 1 summarizes the reaction conditions that can be used to synthesize 1-MCP in this manner.

TABLE 1
Reaction conditions to synthesize 1-MCP

| | |
|---|---|
| Reaction mixture component | LDA:3-chloro-2-methylpropene = |
| | 4:1 (molar ratio) |
| Reaction temperature | Ambient temperature (23° C.) |
| Reaction time | 1.5 hours |
| Yield (based on 1 mol of | 60% (0.6 mol of 1-MCP) |
| 3-chloro-2-methylpropene) | |

### Generation of 1-MCP: Example 3

At room temperature, nitrogen gas (99.95% pure) is pumped into a nitrogen vessel (351/2″x28″×32″) containing either sodium amide powder (90%-NaNH₂) or lithium diisopropylamide powder (97%-[(CH₃)₂CH]₂NLi). A separate powder addition vessel is also purged with the same nitrogen gas. Purging with nitrogen is necessary because of the reactivity of the above-mentioned Lewis bases with air, and to eliminate any contamination before conducting the synthesis reaction. In the powder addition vessel containing the inert atmosphere, the sodium amide (or an equivalent molar concentration of lithium diisopropylamide) is added in an amount ranging from 365-1100 grams, with the larger amount being preferred. To weigh the proper amount of the Lewis base, all weighing is performed in a nitrogen box with nitrogen purging to eliminate oxygen and the threat of spontaneous ignition of the base. Special care is important when working with such bases for proper safety.

Once the Lewis base in powder form is completely added, the openings in the powder addition vessel that were used for purging are sealed off to exclude air. The powder addition vessel is attached to the main system. The reaction vessel, which already has been purged with nitrogen and has been partially evacuated, is opened to the powder addition vessel to allow the powder to fall into the reaction vessel with the aid of nitrogen flow. Nitrogen enters the powder addition vessel during transfer of the Lewis base.

After the powder is transferred into the reaction vessel, the ball valve is closed. After the powder is added, a light mineral oil (dried with molecular sieves) or another equivalent solvent is added by opening the connecting ball valve and allowing it to pour into the reaction vessel with the aid of nitrogen flow. The amount of oil added during the reaction can vary from 1-47 liters, with the higher amount 47 liters being preferred. The reaction vessel is then purged and closed. The reaction vessel temperature is adjusted to a temperature anywhere from 0° C. to 75° C., and preferably about 20° C. to start the reaction. The temperature can be raised or lowered by heating or chilling the jacket using a circulating pump. Should the holding capacity of the vessel be exceeded, the procedure is repeated.

During the addition of ingredients, the contents of the reaction vessel are stirred with a propeller mixer, but splashing of the contents should be avoided. After mixing for 1-60 minutes, and preferably for about 20 minutes, 3-chloro-2-methylpropene is added to the reaction vessel in an amount ranging from 0.15-1.0 liters. During the addition of the 3-chloro-2-methylpropene, there is continuous purging with nitrogen gas. The liquid reactant 3-chloro-2-methylpropene is added slowly over a period of 20 minutes. During this addition, the temperature of the reaction vessel is monitored and kept at less than 40° C. Once the 3-chloro-2-methylpropene is completely added, the vessel should be agitated for an additional 1-30 minutes, and preferably for 15 minutes, using the propeller mixer discussed above. A reaction vessel pressure of about two atmospheres is used in this example.

After all the 3-chloro-2-methylpropene has been reacted, the desired end-product, methylcyclopropene, exists as a sodium salt. To react the remainder of the Lewis base and facilitate liberation of the methylcyclopropene product, the nitrogen purge is stopped and water is added ranging from 0.00-1.47 liters by adding the water under positive pressure over a period of 1 hour. Once all the water has been added, a ball valve connecting the vessel with the condenser is opened and the headspace 1-MCP gas can be utilized. 1-MCP generation in this fashion is described in U.S. Pat. No. 6,017,819, which is incorporated herein by reference in its entirety.

Charging Process

In a non-limiting embodiment, in order to form the compositions described herein, a stream of gaseous (or liquid) cyclopropene at a known concentration is flowed through a tube of delivery material using an inert air stream (such as N₂) at a sufficient rate and duration to exhaust the desired amount of cyclopropene into the tube of delivery material. Depending on the purity of the cyclopropene, the temperature of the vessel containing the cyclopropene may be adjusted to reduce impurities from loading into the delivery material. For example, if the cyclopropene has a lower boiling point than impurities also contained in the vessel, the vessel containing the cyclopropene (and impurities) may be chilled to a temperature below the boiling point of the cyclopropene.

Manufacture of Matrix Comprising 1-MCP

One non-limiting example of an illustrative process for manufacturing matrices comprising 1-MCP is described. A chilled vessel (0° C. or less, for example) placed in an ice bath containing a desired amount of 1-MCP is connected to a packed bed column containing a desired amount of delivery material, for example, activated charcoal (available as DARCO® or other commercial charcoals). Under inert air stream (for example, N₂), a known concentration of 1-MCP vapor is forced through the packed bed column until a desired amount of 1-MCP has been exposed to the packed bed column in order to arrive at the desired weight loading. The delivery materials described herein are efficient adsorbers of 1-MCP. Therefore, a skilled artisan will appreciate that the desired weight percent of 1-MCP and other cyclopropene compounds in the matrix may be achieved, for example, by controlling the system variables such as the concentration of 1-MCP in the inert air stream and the mass of delivery material in the packed bed column.

Material weight gain may be measured after the charging process to assess the ultimate weight loading of 1-MCP in the matrix. If a lower weight loading is desired, diluent material (in the form of uncharged delivery material, for example) may be added. The resulting matrix material may be packaged in form factors such as sachets or injection molded “pods” for example, for sales dress. In order to delay release or prevent release of 1-MCP from the matrix (and/or form factors holding the material), the resulting composition may be stored at cold temperatures (−4° C. or less, for example) until release is desired.

Some non-limiting specific examples various compositions are provided below.

SAMPLE 1: A commercial carbon material (NORIT ROX®, Fisher Scientific) was obtained as an extrudate of 0.8 mm pellets. The carbon had a surface area of 1086 m²/g. The delivery material was charged with 1-MCP (e.g. available in the form of ETHYLBLOC™ from FloraLife®) in the vapor phase by slowly flowing a mixture of nitrogen and gaseous 1-MCP through a packed tube of the carbon for 30 minutes. Thermogravimetric analysis of this matrix recovered a total of 3 wt % 1-MCP per gram of matrix (30 mg 1-MCP/g matrix).

SAMPLE 2: A commercial carbon material (NORIT ROX®, Fisher Scientific) was obtained as an extrudate of 0.8 mm pellets. The carbon had a surface area of 1086 m²/g. The delivery material was charged with 1-MCP (e.g. available in the form of ETHYLBLOC™ from FloraLife®) in the vapor phase by slowly flowing a mixture of nitrogen and gaseous 1-MCP through a packed tube of the carbon for 30 minutes. Thermogravimetric analysis of this matrix recovered a total of 2 wt % 1-MCP per gram of matrix (20 mg 1-MCP/g matrix).

Sample Characteristics

Measuring the surface area of delivery materials as described herein may be accomplished by commercial nitrogen physisorption and BET analyzer apparatus. The sample may be outgassed at 120° C. for 24 h prior to physisorption measurements. Example analytical methods for thermogravimetric analysis follows:

In the first method, ca. 1 g of matrix (comprising the delivery material and cyclopropene) is loaded into a glass vessel. The exact mass of matrix may be recorded to 0.1 mg accuracy, and the overall weight of the vessel may be recorded to 0.1 mg accuracy. The vessel is then subjected to vacuum at 50° C. in a conventional rotovap apparatus attached to an oil vacuum pump with a rotational speed of 250 RPM. Care is taken so that the sample did not dislodge into the rotovap. The sample is evacuated for 30 minutes and the mass of the vessel taken again. The difference in mass in the two samples is attributed to the loss of cyclopropene from the matrix and is normalized to a mass of cyclopropene per unit mass of matrix.

In the second method, a ca. 1 g of matrix loaded with cyclopropene is placed in a tared vial. The total mass of the vial plus the sample was then recorded. The sample is placed overnight in an oven at 150° C. and left open to drive off any adsorbed volatiles. After 18 h, the sample was removed from the oven, cooled, and reweighed. The difference in sample mass is attributed to the loss of cyclopropene from the matrix and was normalized to a mass of cyclopropene per unit mass of matrix.

Release Tests from Sample 1—Release Reported as a Rate for Matrices without Using a Liquid Displacing Medium and Using a Liquid Displacing Medium for Release.

The release of 1-MCP from Sample 1 was determined using headspace analysis of sealed vials containing 50 mg of the sample, as measured with a gas chromatograph equipped with a flame ionization detector. 1-MCP released out of Samples 1 was measured based on 1-MCP released from the composition not using a liquid displacing medium and upon contact with various displacing media.

The vials were 45 mm tall and 20 mm wide with a mouth of 15 mm, for a total internal volume of 8 mL. To seal the vials, a screw-cap with a TEFLON™ liner was screwed onto the vial and the vial sealed with paraffin wax to prevent leakage. To eliminate the effects of equilibrium adsorption of cyclopropenes, vials were left open to allow the cyclopropenes to escape freely. At the appropriate timepoint (e.g. sixty (60) minutes prior to the sample time), the vial was sealed for 1 hour to allow gas to build up in the headspace of the vial, and a volume (e.g. 200 μL) was sampled from the headspace. In this way the rate of release at a given timepoint could be measured. The GC oven temperature was set to 200° C. The area of the GC peak was calibrated by comparison to known quantities of 1-MCP released from ETHYLBLOC™ powder (0.14 wt % 1-MCP).

The procedure was to place a quantity of ETHYLBLOC™ corresponding to the desired number of moles of 1-MCP in a sealed chromatograph vial, then inject 1 mL of the ETHYLBLOC™ buffer solution (99.5% water and 0.5% SDS) into the vial. The vial was shaken to promote complete release of 1-MCP and a sample of the headspace injected in the gas chromatograph. By varying the amount of 1-MCP in each vial, a linear calibration for GC peak area could be determined. During the release experiments, the samples were stored at 25° C. at atmospheric pressure.

The release rate results over 120 hours for Sample 1, not using a liquid displacing medium, from the experiment detailed above are summarized in Table 2 below. The results below are not reported cumulatively and are reported as rate values in the unit of μL 1-MCP/g matrix/hr. Equivalent to the unit μL 1-MCP/g matrix/hr is the unit μL 1-MCP/g composition/hr. As a person skilled in the art would appreciate, the release values below in μL 1-MCP/g matrix/hr can be converted to μg 1-MCP/g matrix/hr by dividing the values given below by 0.452, which is the number of μL of 1-MCP in one μg of 1-MCP at 25° C. at atmospheric pressure.

TABLE 2
1-MCP Release Rates from Sample 1 (without using
a liquid displacing medium) over 120 hours.

| | Rate of 1-MCP Release |
|---|---|
| Time (hrs) | (μL 1-MCP/g matrix/hr) |
| 1 | 57.7 |
| 22 | 28.6 |
| 48 | 18.9 |
| 72 | 17.9 |
| 96 | 14.1 |
| 120 | 10.5 |

The release of 1-MCP from Sample 1 after combination with various displacing media was accomplished via the following method: 250 mg of Sample 1 was dispensed in a clean, amber, 500 mL jar and sealed with a septum cap. A quantity, 10 mL, of each liquid displacing medium was then injected through the septum. The combination of Sample 1 and the liquid displacing medium were agitated for at least 20 minutes in the jar, and the amount of 1-MCP released at each time point was quantified by distributing the combination of Sample 1 and the liquid displacing medium from the jar into vials and using the GC the method described above. All experiments were conducted at 25° C. The displacing media tested herein are as follows: light mineral oil (neat, Sigma-Aldrich); a saturated aqueous solution of NaHCO₃ (99.7%, ACS Reagent grade, Sigma-Aldrich), prepared by dissolving 96 g NaHCO₃ per L of water; ethanol (190 proof, ACS Reagent, Sigma-Aldrich); 1:9 ethanol water, prepared by mixing 100 mL ethanol (200 proof, anhydrous, 99.5+%, Sigma-Aldrich) with 900 mL water; a saturated aqueous solution of sodium chloride (ACS Reagent, 99.0+%, Sigma-Aldrich), prepared by dissolving 358.9 g of sodium chloride per 1 μL of water; water, obtained from the tap; and water containing 0.5% sodium dodecyl sulfate (SDS) (obtainable as ETHYLBLOC™ buffer, FloraLife).

The release rate results over 3 hours for Sample 1, using various liquid displacing mediums, from the experiment detailed above are summarized in Table 3 below. The results below are not reported cumulatively and are reported as rate values in the unit of μL 1-MCP/g matrix/hr. Equivalent to the unit μL 1-MCP/g matrix/hr is the unit μL 1-MCP/g composition/hr. As a person skilled in the art would appreciate, the release values below in μL 1-MCP/g matrix/hr can be converted to μg 1-MCP/g matrix/hr by dividing the values given below by 0.452, which is the number of μL of 1-MCP in one μg of 1-MCP at 25° C. at atmospheric pressure.

TABLE 3
1-MCP Release Rates (in μL/g matrix/hr) over 3 hours
from Sample 1 using various Liquid Displacing Media

| | | | | | | | Water + 0.5% |
|---|---|---|---|---|---|---|---|
| | | | | | | | SDS |
| Time | Mineral | Saturated | | 1:9 | Saturated | | (ETHYLBLOC |
| (hrs) | Oil | NaHCO₃ | Ethanol | Ethanol/Water | NaCl | Water | buffer) |
| 0.33 | 94 | 576 | 1061 | 173 | 800 | 297 | 73 |
| 1 | 35 | 8 | 344 | 58 | 46 | 44 | 4 |
| 2 | 16 | 3 | 115 | 12 | 2 | 2 | 2 |
| 3 | 15 | 3 | 83 | 10 | 1 | 1 | 3 |

In a similar experiment, the release rates of Sample 1 in combination with several displacing media at 25° C. were determined over 22 hours. The displacing media tested herein were as follows: water, obtained from the tap; ethanol (190 proof, ACS Reagent, Sigma-Aldrich); isopropanol (ACS Reagent, 99.5+%, Sigma-Aldrich); and acetone (ACS Reagent, 99.5+%, Sigma-Aldrich). These results are summarized in Table 4 below. The results below are not reported cumulatively and are reported as rate values in the unit of μL 1-MCP/g matrix/hr. Equivalent to the unit μL 1-MCP/g matrix/hr is the unit μL 1-MCP/g composition/hr. As a person skilled in the art would appreciate, the release values below in μL 1-MCP/g matrix/hr can be converted to μg 1-MCP/g matrix/hr by dividing the values given below by 0.452, which is the number of μL of 1-MCP in one μg of 1-MCP at 25° C. at atmospheric pressure. Comparison of Table 4 to Table 2 exhibits that a composition that releases a cyclopropene upon exposure to a non-equilibrium condition accelerates its release of the cyclopropene upon contact with a liquid displacing medium.

TABLE 4
1-MCP Release Rates (in μL/g matrix/hr) over 22 hours
from Sample 1 using various Liquid Displacing Media

| Time (hrs) | Water | Ethanol | Isopropanol | Acetone |
|---|---|---|---|---|
| 0.33 | 297 | 1061 | 488 | 852 |
| 1 | 44 | 344 | 430 | 377 |
| 2 | 2 | 115 | 161 | 158 |
| 3 | 1 | 83 | 93 | 95 |
| 4 | 6 | 53 | 49 | 0 |
| 5 | 4 | 21 | 28 | 0 |
| 22 | 0.2 | <0.05 | <0.01 | 0 |

The total amount of 1-MCP released from the application of each liquid displacing medium at 25° C. is tabulated from the integration of the release curve data depicted above. The results are calculated on the basis of a material containing 3 wt % of 1-MCP initially. The results are shown in Table 5.

TABLE 5
% 1-MCP Released after 22 hours from Sample
1 using various Liquid Displacing Media

| Liquid displacing medium | % 1-MCP Released after 22 hours |
|---|---|
| Water | 10% |
| Ethanol | 75% |
| Isopropanol | 62% |

A similar experiment was conducted with ETHYLBLOC™, a commercially available product using a cyclodextrin/1-MCP complex that is typically dissolved in an aqueous buffer consisting of 99.5% water and 0.5% sodium dodecyl sulfate (SDS) (an ionic surfactant). The amount of 1-MCP released from the ETHYLBLOC™ sample in contact with different solvents at 25° C. is shown in Table 6. This ETHYLBLOC™ powder contains 0.14 wt % 1-MCP. The % of 1-MCP release is calculated as the molar quantity of 1-MCP observed via GC divided by the total molar quantity of 1-MCP present in the ETHYLBLOC(™) sample.

TABLE 6
Amount of 1-MCP Released from ETHYLBLOC ™ (0.14 wt
% 1-MCP) after 1 hour in contact with various Solvents

| | Mass of | % Released of |
|---|---|---|
| Solvent | ETHYLBLOC ™ (mg) | Total 1-MCP |
| ETHYLBLOC ™ buffer | 1.85 | 93% |
| Ethanol | 1.2 | 36% |

At least these examples exhibit that neither the matrix, the delivery material, nor the cyclopropene dissolve in the liquid displacing medium. In the presence of a liquid displacing medium like ethanol, the release of 1-MCP is accelerated relative to the release of 1-MCP from a liquid displacing medium like water. In contrast, when ethanol is added to an alpha-cyclodextrin complex of 1-MCP (like ETHYLBLOC™), the release of 1-MCP is greatly slowed, confirming that dissolution of the alpha-cyclodextrin 1-MCP complex is a necessary process to the release of 1-MCP from such a complex.

The matrices described herein release cyclopropene differently than do compositions employing, for example, molecular encapsulation complexes (e.g. cyclodextrin and 1-MCP in a “lock-and-key” or “cage” complex). In such a complex, the cyclodextrin represents a highly water-soluble material (50 mg/mL solubility), whereas the 1-MCP is highly water-insoluble (0.137 mg/mL solubility). Therefore, in an aqueous solution consisting of 99.5% water and 0.5% hydrophobic surfactant (as in the case of the recommended solvent for ETHYLBLOC™) alpha-cyclodextrin rapidly dissolves in water, which in turn liberates from the “cage” of the cyclodextrin. The water, unable to solubilize 1-MCP, liberates 1-MCP gas from the complex.

An alpha-cyclodextrin complex with 1-MCP does not release 1-MCP as effectively in the presence of a solvent in which alpha-cyclodextrin is less soluble, like ethanol. For example, an alpha-cyclodextrin/1-MCP complex mixed with ethanol will release less I-MCP than one mixed with an equivalent volume of water. In contrast, however, the matrices described herein do not molecularly encapsulate 1-MCP, and the delivery materials of the matrices do not dissolve in the liquid displacing medium. These matrices will release 1-MCP in the presence of a liquid displacing medium regardless of solubility.

Further, from the above results, it can be seen that the use of displacing media having different densities and hydrophobic/hydrophilic properties result in different rates of release for the matrices described herein. For example, even though ethanol has only ⅓ the molecular density of water, the hydrophobicity of the medium greatly accelerates release of 1-MCP from the carbon-based delivery material. Conversely, mineral oil is highly hydrophobic and possesses a lower density than water (0.838 g/mL), but is more viscous than water. In this case, the viscosity likely hinders diffusion of the 1-MCP through the oil medium.

Release Tests from Sample 2—Comparative Release Using Water, where Release is of Cyclpropene is Reported as Concentration

The release of 1-MCP from Sample 2 after combination with water was accomplished via the following method: 2.5 g of Sample 2 was dispensed in a clean plastic 18.9 L container with a compression-fitting lid and equipped with a septum through which a needle can obtain a sample of the internal atmosphere. A quantity, 200 mL, of water was then added through the septum. The combination of Sample 2 and the liquid displacing medium were agitated rapidly to ensure thorough contact between the matrix and the water, and the amount of 1-MCP released at each time point was quantified using GC. All experiments were conducted at 25° C. Values derived for ETHYLBLOC™ (0.14 wt % 1-MCP) were obtained using a similar method and 6 g of ETHYLBLOC™. In this experiment, time 0 occurred at the instant Sample 1 and ETHYLBLOC™ were contacted with water. Agitation occurred between time 0 and time 1.

The release results over 5 hours for Sample 2 using water from the experiment detailed above are summarized in Table 7 below. The results below are reported cumulatively and are reported as concentration values in ppm, representing μL/L of 1-MCP gas in the 18.9 L container according to the ideal gas law at T=298° K.

TABLE 7
Concentrations (in ppm) of 1-MCP after
exposure of ETHYLBLOC ™ and
Sample 1 with water at Time 0

| Time (min) | ETHYLBLOC ™ | Sample 1 |
|---|---|---|
| 0 | 0 | 0 |
| 1 | 74 | 8 |
| 3 | 114 | 13 |
| 10 | 154 | 24 |
| 30 | 169 | 37 |
| 60 | 189 | 67 |
| 90 | 194 | 84 |
| 120 | 196 | 107 |
| 150 | 198 | 128 |
| 180 | 198 | 157 |
| 240 | 199 | 188 |
| 300 | 199 | 193 |

The release results of the above experiment can also be summarized as percentage of total 1-MCP released over 5 hours. These percentages are summarized in Table 8, below. In contrast to the encapsulation material (α-cyclodextrin) of ETHYLBLOC™, the delivery material of Sample 1 is not soluble in water. As equilibrium effects are present in the interaction between the matrix of Sample 2 and the 1-MCP freely released into the headspace (even upon contact with water), the percentage concentration values reported in Table 8 are tabulated as percentage of the final concentration (rounded to 200 ppm) of 1-MCP in the container headspace at 5 hours (300 minutes)—not as a percentage of the total amount of 1-MCP present in the initial sample—in order to achieve an accurate comparison between the release of both samples under the same conditions.

In the context of this example, percentage concentration means cyclopropene concentration sampled at a particular timepoint after sample exposure to water at time 0 versus the concentration of cyclopropene sampled at hour 5 (rounded to 200 ppm) in the headspace of the container.

TABLE 8
Percentage concentration of 1-MCP at particular timepoints
in the headspace of the container, after contact of
ETHYLBLOC ™ and Sample 1 with water at Time 0

| Time (min) | ETHYLBLOC ™ | Sample 1 |
|---|---|---|
| 0 | 0.0% | 0.0% |
| 1 | 37.2% | 4.0% |
| 3 | 57.2% | 6.7% |
| 10 | 76.9% | 11.9% |
| 30 | 84.7% | 18.5% |
| 60 | 94.7% | 33.3% |
| 90 | 96.9% | 42.2% |
| 120 | 97.9% | 53.6% |
| 150 | 99.1% | 64.0% |
| 180 | 99.0% | 78.3% |
| 240 | 99.7% | 93.8% |
| 300 | 99.6% | 96.4% |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for effecting release of one or more cyclopropene compounds, comprising:
a carbon-based delivery material;
the one or more cyclopropene compounds present in the carbon-based delivery material in at least about 0.01 wt % versus the total weight of the carbon-based delivery material and the one or more cyclopropene compounds; and
a liquid displacing medium at a temperature of less than about 70° C.

2. A system for effecting release of one or more cyclopropene compounds, comprising:
a matrix comprising:
a carbon-based delivery material; and
the one or more cyclopropene compounds present in the carbon-based delivery material in at least about 0.01 wt % versus the total weight of the matrix; and
a liquid displacing medium at a temperature of less than about 70° C.

3. A system for effecting release of one or more cyclopropene compounds, comprising:
a liquid displacing medium at a temperature of less than about 70° C.;
a delivery material being substantially insoluble in the liquid displacing medium; and
the one or more cyclopropene compounds present in the delivery material in at least about 0.01 wt % versus the total weight of the delivery material and the one or more cyclopropene compounds.

4. A system for effecting releasing of 1-methylcyclopropene (1-MCP), comprising:
an adsorber of 1-MCP; and
the 1-MCP present in the adsorber in at least about 0.01 wt % versus the total weight of the adsorber and the 1-MCP; and
a liquid displacing medium at a temperature of less than about 70° C.

5. A system for effecting releasing of 1-methylcyclopropene (1-MCP), comprising:
a matrix consisting essentially of:
an adsorber of 1-MCP; and
the 1-MCP present in the adsorber in at least about 0.01 wt % versus the total weight of the adsorber and the 1-MCP; and
a liquid displacing medium at a temperature of less than about 70° C.

6. A composition that is capable of modifying release of one or more cyclopropene compounds upon or after exposure to a liquid displacing medium relative to a rate at which the cyclopropene was being released by the composition in a non-equilibrium condition prior to the exposure of the composition to the liquid displacing medium.

7. A composition, comprising:
a matrix comprising a carbon-based delivery material and one or more cyclopropene compounds present in the carbon-based delivery material,
wherein the matrix is capable of releasing the one or more cyclopropene compounds at a rate of at least about 0.1 μL/g matrix/hr over at least 24 hours.

8. A composition, comprising:
one or more cyclopropene compounds, wherein the composition is capable of releasing the one or more cyclopropene compounds at a first release rate of at least 0.1 μL/g matrix/hr in a non-equilibrium condition that is not a liquid displacing medium, and
wherein release of the cyclopropene from the composition is modified upon or after contact between the composition and a liquid displacing medium such that the composition is capable of releasing the one or more cyclopropene compounds at a second release rate that is different than the first release rate.

9. A composition, comprising:
one or more cyclopropene compounds, wherein the composition is capable of releasing the one or more cyclopropene compounds at a first release rate of at least 0.1 μL/g matrix/hr at hour 1, without addition of external wetting or hydrating, and
wherein release of the cyclopropene from the composition is modified upon or after contact between the composition and a liquid displacing medium such that the composition is capable of releasing the one or more cyclopropene compounds at a second release rate that is different than the first release rate.

10. A composition, comprising:
one or more cyclopropene compounds, wherein the composition is capable of releasing the one or more cyclopropene compounds at a first release rate of at least 0.1 μL/g matrix/hr at hour 2, without addition of external wetting or hydrating, and
wherein release of the cyclopropene from the composition is modified upon or after contact between the composition and a liquid displacing medium such that the composition is capable of releasing the one or more cyclopropene compounds at a second release rate that is different than the first release rate.

11. A composition, comprising:
one or more cyclopropene compounds, wherein the composition is capable of releasing the one or more cyclopropene compounds at a first release rate of at least 0.1 μL/g matrix/hr at hour 3, without addition of external wetting or hydrating, and
wherein release of the cyclopropene from the composition is modified upon or after contact between the composition and a liquid displacing medium such that the composition is capable of releasing the one or more cyclopropene compounds at a second release rate that is different than the first release rate.

12. A composition, comprising:
one or more cyclopropene compounds, wherein the composition is capable of releasing the one or more cyclopropene compounds at a first release rate of at least 0.1 μL/g matrix/hr at hour 4, without addition of external wetting or hydrating, and
wherein release of the cyclopropene from the composition is modified upon or after contact between the composition and a liquid displacing medium such that the composition is capable of releasing the one or more cyclopropene compounds at a second release rate that is different than the first release rate.

13. A composition that releases a cyclopropene upon or after contact with a liquid displacing medium, the composition comprising:
a delivery material being a carbon material; and
the cyclopropene present in the composition in at least about 0.01 wt % versus the total weight of the delivery material and the cyclopropene.

14. A composition that releases a cyclopropene at temperatures between about −2° C. and about 40° C. upon contact with a liquid displacing medium, the composition comprising:
a delivery material being a carbon material; and
the cyclopropene present in the composition in at least about 0.01 wt % versus the total weight of the delivery material and the cyclopropene.

15. A composition that releases a cyclopropene at at least one temperature between about −2° C. and about 40° C. upon contact with a liquid displacing medium, the composition comprising:
a delivery material being a carbon material; and
one or more cyclopropene compounds present in the composition in at least about 0.01 wt % versus the total weight of the delivery material and the cyclopropene.

16. A composition that releases a cyclopropene upon exposure to water, wherein:
the concentration of cyclopropene sampled at minute 3 is less than about 50% of the concentration of cyclopropene sampled at minute 300, or wherein the concentration of cyclopropene sampled at minute 3 is less than about 40% of the concentration of cyclopropene sampled at minute 300, or wherein the concentration of cyclopropene sampled at minute 3 is less than about 30% of the concentration of cyclopropene sampled at minute 300, or wherein the concentration of cyclopropene sampled at minute 3 is less than about 20% of the concentration of cyclopropene sampled at minute 300, or wherein the concentration of cyclopropene sampled at minute 3 is less than about 15% of the concentration of cyclopropene sampled at minute 300, or wherein the concentration of cyclopropene sampled at minute 3 is less than about 10% of the concentration of cyclopropene sampled at minute 300, wherein the concentration of cyclopropene sampled at minute 30 is less than about 80% of the concentration of cyclopropene sampled at minute 300, or wherein the concentration of cyclopropene sampled at minute 30 is less than about 70% of the concentration of cyclopropene sampled at minute 300, or wherein the concentration of cyclopropene sampled at minute 30 is less than about 60% of the concentration of cyclopropene sampled at minute 300, or wherein the concentration of cyclopropene sampled at minute 30 is less than about 50% of the concentration of cyclopropene sampled at minute 300, or wherein the concentration of cyclopropene sampled at minute 30 is less than about 40% of the concentration of cyclopropene sampled at minute 300, or wherein the concentration of cyclopropene sampled at minute 30 is less than about 30% of the concentration of cyclopropene sampled at minute 300, or wherein the concentration of cyclopropene sampled at minute 30 is less than about 20% of the concentration of cyclopropene sampled at minute 300, or wherein the concentration of cyclopropene sampled at minute 60 is less than about 50% of the concentration of cyclopropene sampled at minute 300, or wherein the concentration of cyclopropene sampled at minute 60 is less than about 40% of the concentration of cyclopropene sampled at minute 300, or wherein the concentration of cyclopropene sampled at minute 60 is less than about 35% of the concentration of cyclopropene sampled at minute 300, or wherein the concentration of cyclopropene sampled at minute 90 is less than about 50% of the concentration of cyclopropene sampled at minute 300, or wherein the concentration of cyclopropene sampled at minute 90 is less than about 45% of the concentration of cyclopropene sampled at minute 300, or wherein the concentration of cyclopropene sampled at minute 120 is less than about 90% of the concentration of cyclopropene sampled at minute 300, or wherein the concentration of cyclopropene sampled at minute 120 is less than about 80% of the concentration of cyclopropene sampled at minute 300, or wherein the concentration of cyclopropene sampled at minute 120 is less than about 70% of the concentration of cyclopropene sampled at minute 300, or wherein the concentration of cyclopropene sampled at minute 120 is less than about 60% of the concentration of cyclopropene sampled at minute 300, or wherein the concentration of cyclopropene sampled at minute 120 is less than about 55% of the concentration of cyclopropene sampled at minute 300 or wherein the concentration of cyclopropene sampled at minute 150 is less than about 90% of the concentration of cyclopropene sampled at minute 300, or wherein the concentration of cyclopropene sampled at minute 150 is less than about 80% of the concentration of cyclopropene sampled at minute 300, or wherein the concentration of cyclopropene sampled at minute 150 is less than about 70% of the concentration of cyclopropene sampled at minute 300, or wherein the concentration of cyclopropene sampled at minute 150 is less than about 65% of the concentration of cyclopropene sampled at minute 300.

17. A composition comprising a cyclopropene, wherein:
the concentration of cyclopropene sampled at minute 3 is less than about 50% of the concentration of cyclopropene sampled at minute 300, or wherein the concentration of cyclopropene sampled at minute 3 is less than about 40% of the concentration of cyclopropene sampled at minute 300, or wherein the concentration of cyclopropene sampled at minute 3 is less than about 30% of the concentration of cyclopropene sampled at minute 300, or wherein the concentration of cyclopropene sampled at minute 3 is less than about 20% of the concentration of cyclopropene sampled at minute 300, or wherein the concentration of cyclopropene sampled at minute 3 is less than about 15% of the concentration of cyclopropene sampled at minute 300, or wherein the concentration of cyclopropene sampled at minute 3 is less than about 10% of the concentration of cyclopropene sampled at minute 300, wherein the concentration of cyclopropene sampled at minute 30 is less than about 80% of the concentration of cyclopropene sampled at minute 300, or wherein the concentration of cyclopropene sampled at minute 30 is less than about 70% of the concentration of cyclopropene sampled at minute 300, or wherein the concentration of cyclopropene sampled at minute 30 is less than about 60% of the concentration of cyclopropene sampled at minute 300, or wherein the concentration of cyclopropene sampled at minute 30 is less than about 50% of the concentration of cyclopropene sampled at minute 300, or wherein the concentration of cyclopropene sampled at minute 30 is less than about 40% of the concentration of cyclopropene sampled at minute 300, or wherein the concentration of cyclopropene sampled at minute 30 is less than about 30% of the concentration of cyclopropene sampled at minute 300, or wherein the concentration of cyclopropene sampled at minute 30 is less than about 20% of the concentration of cyclopropene sampled at minute 300, or wherein the concentration of cyclopropene sampled at minute 60 is less than about 50% of the concentration of cyclopropene sampled at minute 300, or wherein the concentration of cyclopropene sampled at minute 60 is less than about 40% of the concentration of cyclopropene sampled at minute 300, or wherein the concentration of cyclopropene sampled at minute 60 is less than about 35% of the concentration of cyclopropene sampled at minute 300, or wherein the concentration of cyclopropene sampled at minute 90 is less than about 50% of the concentration of cyclopropene sampled at minute 300, or wherein the concentration of cyclopropene sampled at minute 90 is less than about 45% of the concentration of cyclopropene sampled at minute 300, or wherein the concentration of cyclopropene sampled at minute 120 is less than about 90% of the concentration of cyclopropene sampled at minute 300, or wherein the concentration of cyclopropene sampled at minute 120 is less than about 80% of the concentration of cyclopropene sampled at minute 300, or wherein the concentration of cyclopropene sampled at minute 120 is less than about 70% of the concentration of cyclopropene sampled at minute 300, or wherein the concentration of cyclopropene sampled at minute 120 is less than about 60% of the concentration of cyclopropene sampled at minute 300, or wherein the concentration of cyclopropene sampled at minute 120 is less than about 55% of the concentration of cyclopropene sampled at minute 300 or wherein the concentration of cyclopropene sampled at minute 150 is less than about 90% of the concentration of cyclopropene sampled at minute 300, or wherein the concentration of cyclopropene sampled at minute 150 is less than about 80% of the concentration of cyclopropene sampled at minute 300, or wherein the concentration of cyclopropene sampled at minute 150 is less than about 70% of the concentration of cyclopropene sampled at minute 300, or wherein the concentration of cyclopropene sampled at minute 150 is less than about 65% of the concentration of cyclopropene sampled at minute 300.

18. A composition comprising:
a solid powder delivery material; and
a cyclopropene,
the concentration of cyclopropene sampled at minute 3 is less than about 50% of the concentration of cyclopropene sampled at minute 300, or wherein the concentration of cyclopropene sampled at minute 3 is less than about 40% of the concentration of cyclopropene sampled at minute 300, or wherein the concentration of cyclopropene sampled at minute 3 is less than about 30% of the concentration of cyclopropene sampled at minute 300, or wherein the concentration of cyclopropene sampled at minute 3 is less than about 20% of the concentration of cyclopropene sampled at minute 300, or wherein the concentration of cyclopropene sampled at minute 3 is less than about 15% of the concentration of cyclopropene sampled at minute 300, or wherein the concentration of cyclopropene sampled at minute 3 is less than about 10% of the concentration of cyclopropene sampled at minute 300, wherein the concentration of cyclopropene sampled at minute 30 is less than about 80% of the concentration of cyclopropene sampled at minute 300, or wherein the concentration of cyclopropene sampled at minute 30 is less than about 70% of the concentration of cyclopropene sampled at minute 300, or wherein the concentration of cyclopropene sampled at minute 30 is less than about 60% of the concentration of cyclopropene sampled at minute 300, or wherein the concentration of cyclopropene sampled at minute 30 is less than about 50% of the concentration of cyclopropene sampled at minute 300, or wherein the concentration of cyclopropene sampled at minute 30 is less than about 40% of the concentration of cyclopropene sampled at minute 300, or wherein the concentration of cyclopropene sampled at minute 30 is less than about 30% of the concentration of cyclopropene sampled at minute 300, or wherein the concentration of cyclopropene sampled at minute 30 is less than about 20% of the concentration of cyclopropene sampled at minute 300, or wherein the concentration of cyclopropene sampled at minute 60 is less than about 50% of the concentration of cyclopropene sampled at minute 300, or wherein the concentration of cyclopropene sampled at minute 60 is less than about 40% of the concentration of cyclopropene sampled at minute 300, or wherein the concentration of cyclopropene sampled at minute 60 is less than about 35% of the concentration of cyclopropene sampled at minute 300, or wherein the concentration of cyclopropene sampled at minute 90 is less than about 50% of the concentration of cyclopropene sampled at minute 300, or wherein the concentration of cyclopropene sampled at minute 90 is less than about 45% of the concentration of cyclopropene sampled at minute 300, or wherein the concentration of cyclopropene sampled at minute 120 is less than about 90% of the concentration of cyclopropene sampled at minute 300, or wherein the concentration of cyclopropene sampled at minute 120 is less than about 80% of the concentration of cyclopropene sampled at minute 300, or wherein the concentration of cyclopropene sampled at minute 120 is less than about 70% of the concentration of cyclopropene sampled at minute 300, or wherein the concentration of cyclopropene sampled at minute 120 is less than about 60% of the concentration of cyclopropene sampled at minute 300, or wherein the concentration of cyclopropene sampled at minute 120 is less than about 55% of the concentration of cyclopropene sampled at minute 300 or wherein the concentration of cyclopropene sampled at minute 150 is less than about 90% of the concentration of cyclopropene sampled at minute 300, or wherein the concentration of cyclopropene sampled at minute 150 is less than about 80% of the concentration of cyclopropene sampled at minute 300, or wherein the concentration of cyclopropene sampled at minute 150 is less than about 70% of the concentration of cyclopropene sampled at minute 300, or wherein the concentration of cyclopropene sampled at minute 150 is less than about 65% of the concentration of cyclopropene sampled at minute 300.

19. A composition comprising:
a carbon delivery material being 75-100 wt % carbon; and
a cyclopropene,
wherein the concentration of cyclopropene sampled at minute 3 is less than about 50% of the concentration of cyclopropene sampled at minute 300, or wherein the concentration of cyclopropene sampled at minute 3 is less than about 40% of the concentration of cyclopropene sampled at minute 300, or wherein the concentration of cyclopropene sampled at minute 3 is less than about 30% of the concentration of cyclopropene sampled at minute 300, or wherein the concentration of cyclopropene sampled at minute 3 is less than about 20% of the concentration of cyclopropene sampled at minute 300, or wherein the concentration of cyclopropene sampled at minute 3 is less than about 15% of the concentration of cyclopropene sampled at minute 300, or wherein the concentration of cyclopropene sampled at minute 3 is less than about 10% of the concentration of cyclopropene sampled at minute 300, wherein the concentration of cyclopropene sampled at minute 30 is less than about 80% of the concentration of cyclopropene sampled at minute 300, or wherein the concentration of cyclopropene sampled at minute 30 is less than about 70% of the concentration of cyclopropene sampled at minute 300, or wherein the concentration of cyclopropene sampled at minute 30 is less than about 60% of the concentration of cyclopropene sampled at minute 300, or wherein the concentration of cyclopropene sampled at minute 30 is less than about 50% of the concentration of cyclopropene sampled at minute 300, or wherein the concentration of cyclopropene sampled at minute 30 is less than about 40% of the concentration of cyclopropene sampled at minute 300, or wherein the concentration of cyclopropene sampled at minute 30 is less than about 30% of the concentration of cyclopropene sampled at minute 300, or wherein the concentration of cyclopropene sampled at minute 30 is less than about 20% of the concentration of cyclopropene sampled at minute 300, or wherein the concentration of cyclopropene sampled at minute 60 is less than about 50% of the concentration of cyclopropene sampled at minute 300, or wherein the concentration of cyclopropene sampled at minute 60 is less than about 40% of the concentration of cyclopropene sampled at minute 300, or wherein the concentration of cyclopropene sampled at minute 60 is less than about 35% of the concentration of cyclopropene sampled at minute 300, or wherein the concentration of cyclopropene sampled at minute 90 is less than about 50% of the concentration of cyclopropene sampled at minute 300, or wherein the concentration of cyclopropene sampled at minute 90 is less than about 45% of the concentration of cyclopropene sampled at minute 300, or wherein the concentration of cyclopropene sampled at minute 120 is less than about 90% of the concentration of cyclopropene sampled at minute 300, or wherein the concentration of cyclopropene sampled at minute 120 is less than about 80% of the concentration of cyclopropene sampled at minute 300, or wherein the concentration of cyclopropene sampled at minute 120 is less than about 70% of the concentration of cyclopropene sampled at minute 300, or wherein the concentration of cyclopropene sampled at minute 120 is less than about 60% of the concentration of cyclopropene sampled at minute 300, or wherein the concentration of cyclopropene sampled at minute 120 is less than about 55% of the concentration of cyclopropene sampled at minute 300 or wherein the concentration of cyclopropene sampled at minute 150 is less than about 90% of the concentration of cyclopropene sampled at minute 300, or wherein the concentration of cyclopropene sampled at minute 150 is less than about 80% of the concentration of cyclopropene sampled at minute 300, or wherein the concentration of cyclopropene sampled at minute 150 is less than about 70% of the concentration of cyclopropene sampled at minute 300, or wherein the concentration of cyclopropene sampled at minute 150 is less than about 65% of the concentration of cyclopropene sampled at minute 300.

20. A composition consisting of:
a carbon delivery material being 75-100 wt % carbon; and
a cyclopropene.

21. A method of releasing one or more cyclopropene compounds from a composition, comprising:
exposing the composition to a liquid displacing medium; wherein:
the composition comprises a carbon-based delivery material,
the one or more cyclopropene compounds are present in the composition in at least about 0.01 wt % versus the total weight of the carbon-based delivery material and the one or more cyclopropene compounds, and
the liquid displacing medium is at a temperature of less than about 70° C. when in contact with the composition.

22. A method of releasing one or more cyclopropene compounds from a matrix, comprising:
exposing the matrix to a liquid displacing medium, wherein:
the composition comprises a carbon-based delivery material,
the one or more cyclopropene compounds are present in the composition in at least about 0.01 wt % versus the total weight of the carbon-based delivery material and the one or more cyclopropene compounds, and
the liquid displacing medium is at a temperature of less than about 70° C. when in contact with the composition.

23. A method of releasing one or more cyclopropene compounds from a composition, comprising:
exposing the composition to a liquid displacing medium; wherein:
the composition comprises a delivery material that is substantially insoluble in the liquid displacing medium,
the one or more cyclopropene compounds are present in the composition in at least about 0.01 wt % versus the total weight of the carbon-based delivery material and the one or more cyclopropene compounds, and
the liquid displacing medium is a temperature of less than about 70° C. when in contact with the composition.

24. A method of releasing 1-methylcyclopropene (1-MCP) compounds from a composition, comprising:
exposing the composition to a liquid displacing medium; wherein:
the composition comprises an adsorber of 1-MCP,
the 1-MCP is present in the composition in at least about 0.01 wt % versus the total weight of the carbon-based delivery material and the one or more cyclopropene compounds, and
the liquid displacing medium is at a temperature of less than about 70° C. when in contact with the composition.

25. A method of modifying release of one or more cyclopropene compounds, comprising:
exposing the composition comprising the one or more cyclopropene compounds to a non-equilibrium condition that is not a liquid displacing medium such that there is first release rate of the one or more cyclopropene compounds from a composition upon exposure to the non-equilibrium condition;
exposing the composition to a liquid displacing medium such that there is a second release rate, wherein the second release rate is different than the first release rate.

26. A method of releasing one or more cyclopropenes from a composition, comprising:
exposing the composition to a non-equilibrium condition such that the composition control releases the one or more cyclopropene compounds; and
subsequently contacting the composition with a liquid displacing medium to modify the release of the one or more cyclopropene compounds.

27. A method of delivering one or more cyclopropene compounds to produce to inhibit an ethylene response in the produce, comprising:
exposing the composition to a non-equilibrium condition such that the composition control releases the one or more cyclopropene compounds; and
subsequently contacting the composition with a liquid displacing medium to modify the
release of the one or more cyclopropene compounds.

28. A method of accelerating release of one or more cyclopropene from a composition capable of releasing the one or more cyclopropene compounds at a rate of at least about 0.1 μL/g matrix/hr over a duration of at least 3 days, or at least 4 days, or at least 5 days, the method comprising:
exposing the composition to a liquid displacing medium.

29. A method of delivering one or more cyclopropene compounds to produce to inhibit an ethylene response in the produce, comprising:
exposing the composition to a non-equilibrium condition such that the composition is capable of releasing one or more cyclopropene compounds at a rate of at least about 5 μL/g matrix/hr over a duration of at least 5 days;
after exposure to the non-equilibrium condition, subsequently contacting the composition with a liquid displacing medium to accelerate release of the one or more cyclopropenes from the composition in the non-equilibrium condition such that at hour 22, the composition releases at a rate of less than about 1 μL/g matrix/hr,
wherein the one or more cyclopropene compounds released from the composition can contact the produce.

30. A method of delivering one or more cyclopropene compounds to produce to inhibit an ethylene response in the produce, comprising:
exposing the composition to a non-equilibrium condition such that the composition is capable of releasing one or more cyclopropene compounds at a rate of at least about 5 μL/g matrix/hr over a duration of at least 5 days;
after exposure to the non-equilibrium condition, subsequently contacting the composition with a liquid displacing medium to accelerate release of the one or more cyclopropenes from the composition in the non-equilibrium condition such that at hour 22, the composition releases at a rate of less than about 1 μL/g matrix/hr,
wherein the one or more cyclopropene compounds released from the composition can contact the produce.

31. A method of releasing one or more cyclopropene compounds comprising:
exposing a composition comprising the one or more cyclopropene compounds to water,
wherein the concentration of cyclopropene sampled at minute 3 is less than about 55% of the concentration of cyclopropene sampled at minute 300, or the concentration of cyclopropene sampled at minute 3 is less than about 50%, or less than about 40%, or less than about 30%, or less than about 20%, or less than about 15%, or less than about 10%, or less than about 8% of the concentration of cyclopropene sampled at minute 300, or the concentration of cyclopropene sampled at minute 30 is less than about 80%, or less than about 70%, or less than about 60%, or less than about 50%, or less than about 40%, or less than about 30%, or less than about 20% of the concentration of cyclopropene sampled at minute 300, or the concentration of cyclopropene sampled at minute 60 is less than about 90%, or less than about 80%, or less than about 70%, or less than about 60%, or less than about 50%, or less than about 40%, or less than about 35% of the concentration of cyclopropene sampled at minute 300, or the concentration of cyclopropene sampled at minute 90 is less than about 95%, or less than about 90%, or less than about 80%, or less than about 70%, or less than about 60%, or 50%, or less than about 45% of the concentration of cyclopropene sampled at minute 300, or the concentration of cyclopropene sampled at minute 120 is less than about 95%, or less than about 90%, or less than about 80%, or less than about 70%, or less than about 60%, or less than about 57%, or less than about 55% of the concentration of cyclopropene sampled at minute 300, or the concentration of cyclopropene sampled at minute 150 is less than about 95%, or less than about 90%, or less than about 80%, or less than about 70%, or less than about 65% of the concentration of cyclopropene sampled at minute 300, or the concentration of cyclopropene sampled at minute 180 is less than about 95%, or less than about 90%, or less than about 80%, or less than about 85% of the concentration of cyclopropene sampled at minute 300, or the concentration of cyclopropene sampled at minute 3 is between about 3% and about 35%, or between about 3% and about 45%, or between about 3% and about 55%, or between about 5% and about 55% of the concentration of cyclopropene sampled at minute 300, or the concentration of cyclopropene sampled at minute 30 is between about 10% and about 50%, between about 10% and about 60%, or between about 10% and 70%, or between about 10% and 80%, or between about 15% and about 80% of the concentration of cyclopropene sampled at minute 300, or the concentration of cyclopropene sampled at minute 60 is between about 20% and about 50%, or between about 20% and about 60%, or between about 20% and about 70%, or between about 20% and about 80%, or 30% and about 80%, or between about 30% and about 90% of the concentration of cyclopropene sampled at minute 300, or the concentration of cyclopropene sampled at minute 90 is between about 25% and about 65%, or between about 25% and about 75%, or between about 25% and about 85%, or between about 25% and about 95%, or between about 35% and about 95% of the concentration of cyclopropene sampled at minute 300, or the concentration of cyclopropene sampled at minute 120 is between about 40% and about 65%, or between about 40% and about 75%, or between about 40% and about 85%, or between about 40% and about 95%, or between about 50% and about 95% of the concentration of cyclopropene sampled at minute 300, or the concentration of cyclopropene sampled at minute 150 is between about 50% and about 65%, or between about 50% and about 75%, or between about 50% and about 85%, or between about 50% and about 95%, or about 60% to about 95% of the concentration of cyclopropene sampled at minute 300 or the concentration of cyclopropene sampled at minute 180 between about 60% and about 75%, or between about 60% and about 85%, or between about 60% and about 95%, or between 75% to about 95% of the concentration of cyclopropene sampled at minute 300.

32. A system for effecting release of one or more cyclopropene compounds, comprising:
a carbon-based delivery material;
the one or more cyclopropene compounds present in the carbon-based delivery material; and
a vapor displacing medium.

33. A method of releasing one or more cyclopropene compounds from a composition, comprising:
exposing the composition to a vapor displacing medium; wherein:
the composition comprises a carbon-based delivery material,
the one or more cyclopropene compounds are present in the composition.

34. The system of claim 32, wherein the vapor displacing medium is water vapor.

35. The method of claim 33, wherein the vapor displacing medium is water vapor.

36. The method of any of the preceding claims, wherein the concentration of cyclopropene is the concentration of the one or more cyclopropene compounds.

37. The composition of any of the preceding claims, wherein:
the liquid displacing medium is at a temperature below about 5° C., or below about 10° C., below about 15° C., or below about 20° C., or below about 25° C., or below about 30° C., or below about 35° C., or below about 40° C., or below about 50° C., or below about 60° C., or below about 70° C., or below about 80° C., or below about 90° C., or below about 100° C.

38. The system, composition, or method of any of the preceding claims, wherein:
the liquid displacing medium is at a temperature between about 1° C. to about 25° C., between about 1° C. to about 40° C., or between about 10° C. to about 35° C., or between about 15° C. to about 30° C., or between about 15° C. to about 50° C., or between about 15° C. to about 70° C., or between about 15° C. to about 90° C.

39. The system, composition, or method of any of the preceding claims, wherein the delivery material is a carbon-based material.

40. The system, composition, or method of any of the preceding claims, wherein the composition comprises a matrix.

41. The system, composition, or method of any of the preceding claims, wherein a delivery material charged with the one or more cyclopropene compounds is a matrix.

42. The system, composition, or method of any of the preceding claims, wherein the matrix comprises a carbon-based delivery material and the one or more cyclopropene compounds.

43. The system, composition, or method of any of the preceding claims, wherein the matrix comprises a delivery material and the one or more cyclopropene compounds, the one or more cyclopropene compounds contained within the delivery material.

44. The system, composition, or method of any of the preceding claims, wherein the matrix comprises a carbon-based delivery material and the one or more cyclopropene compounds, the at least one cyclopropene contained within the carbon-based delivery material.

45. The system, composition, or method of any of the preceding claims, wherein the matrix comprises a carbon-based delivery material and the one or more cyclopropene compounds, the one or more cyclopropene compounds adsorbed by the carbon-based delivery material.

46. The system, composition, or method of any of the preceding claims, wherein the matrix comprises a delivery material and the one or more cyclopropene compounds, the one or more cyclopropene compounds adsorbed by the delivery material.

47. The system, composition, or method of any of the preceding claims, wherein the matrix consists essentially of a delivery material and the one or more cyclopropene compounds.

48. The system, composition, or method of any of the preceding claims, wherein the matrix consists essentially of a carbon-based delivery material and the one or more cyclopropene compound.

49. The system, composition, or method of any of the preceding claims, wherein effecting release is modifying release.

50. The system, composition, or method of any of the preceding claims, wherein the liquid displacing medium is in contact with the matrix.

51. The system, composition, or method of any of the preceding claims, wherein the total weight of the matrix is the total weight of the carbon-based delivery material and the one or more cyclopropene compounds.

52. The system, composition, or method of any of the preceding claims, wherein the adsorber is porous.

53. The system, composition, or method of any of the preceding claims, wherein the adsorber is substantially insoluble in the liquid displacing medium.

54. The system, composition, or method of any of the preceding claims, wherein the adsorber is a delivery material that has been charged with the one or more cyclopropene compounds to form a matrix.

55. The system, composition, or method of any of the preceding claims, wherein the adsorber is a carbon-based delivery material.

56. The system, composition, or method of any of the preceding claims, wherein the delivery material is substantially insoluble in the liquid displacing medium.

57. The system, composition, or method of any of the preceding claims, wherein the total weight of the matrix is the total weight of the carbon-based delivery material and the one or more cyclopropene compounds.

58. The system, composition, or method of any of the preceding claims, wherein the liquid displacing medium is in contact with the matrix.

59. The system, composition, or method of any of the preceding claims, wherein the composition comprises a delivery material charged with the one or more cyclopropene compounds.

60. The system, composition, or method of any of the preceding claims, wherein the one or more cyclopropene compounds is present in the matrix in at least about 0.01 wt % versus the total weight of the matrix.

61. The system, composition, or method of any of the preceding claims, wherein the one or more cyclopropene compounds is present in the composition in at least about 0.01 wt % versus the total weight of the delivery material and the one or more cyclopropene compounds.

62. The system, composition, or method of any of the preceding claims, wherein the one or more cyclopropene compounds is present in the composition in at least about 0.01 wt % versus the total weight of the carbon-based delivery material and the one or more cyclopropene compounds.

63. The system, composition, or method of any of the preceding claims, wherein the matrix is capable of releasing the one or more cyclopropene compounds without heating.

64. The system, composition, or method of any of the preceding claims, wherein the release modification is one of acceleration and deceleration.

65. The system, composition, or method of any of the preceding claims, wherein the second release rate is measured at the same hour as the first release rate, and the second release rate is lower than the first release rate.

66. The system, composition, or method of any of the preceding claims, wherein the second release rate is measured at the same hour as the first release rate, and the second release rate is higher than the first release rate.

67. The system, composition, or method of any of the preceding claims, wherein the matrix is capable of releasing the one or more cyclopropene compounds at the first release rate without heating.

68. The system, composition, or method of any of the preceding claims, wherein the matrix is capable of releasing the one or more cyclopropene compounds at the second release rate without heating.

69. The system, composition, or method of any of the preceding claims, wherein contact between the composition and the liquid displacing medium comprises contact between the matrix and the liquid displacing medium.

70. The system, composition, or method of any of the preceding claims, wherein the first release rate is at least 0.1 μL/g matrix/hr.

71. The system, composition, or method of any of the preceding claims, wherein contact with the liquid displacing medium comprises agitation.

72. The system, composition, or method of any of the preceding claims, wherein the composition is capable of releasing of the one or more cyclopropene compounds without the addition of external wetting or hydrating.

73. The system, composition, or method of any of the preceding claims, wherein release of the one or more cyclopropene compounds from the composition is modified upon contact between the composition and the liquid displacing medium relative to release of the one or more cyclopropene compounds from the composition without the addition of external wetting or hydrating.

74. The system, composition, or method of any of the preceding claims, wherein the composition is capable is capable of initial release of the cyclopropene upon exposure to a non-equilibrium condition.

75. The system, composition, or method of any of the preceding claims, wherein heating the composition is not required to release the one or more cyclopropene compounds from the composition.

76. The system, composition, or method of any of the preceding claims, wherein heating the composition comprises exposing the composition to average temperatures above about 70° C., or above about 80° C., or above about 90° C., or above about 100° C.

77. The system, composition, or method of any of the preceding claims, wherein exposing a composition or matrix to a liquid displacing medium comprises initiating contact between the composition or matrix and the liquid displacing material.

78. The system, composition, or method of any of the preceding claims, wherein the weight percent of the 1-MCP or the one or more cyclopropene compounds is the weight percent prior to exposure of the composition or matrix to the liquid displacing medium.

79. The system, composition, or method of any of the preceding claims, wherein the composition is subsequently exposed to the liquid displacing medium after composition exposure to the non-equilibrium condition.

80. The system, composition, or method of any of the preceding claims, wherein the non-equilibrium condition is not a liquid displacing medium.

81. The system, composition, or method of any of the preceding claims, wherein the non-equilibrium condition is not a liquid displacing medium.

82. The system, composition, or method of any of the preceding claims, wherein
the liquid displacing medium is at a temperature of less than about 70° C. when in contact with the matrix or composition.

83. The system, composition, or method of any of the preceding claims, wherein the total weight of the matrix is the total weight of the carbon-based delivery material and the one or more cyclopropene compounds.

84. The system, composition, or method of any of the preceding claims, wherein the total weight of the matrix is the total weight of the delivery material and the one or more cyclopropene compounds.

85. The system, composition, or method of any of the preceding claims, wherein the total weight of the matrix is the total weight of the carbon-based delivery material and the one or more cyclopropene compounds.

86. The system, composition, or method of any of the preceding claims, wherein the total weight of the matrix is the total weight of the activated carbon delivery material and the one or more cyclopropene compounds.

87. The system, composition, or method of any of the preceding claims, wherein the total weight of the matrix is the total weight of the one or more cyclopropene compounds and carbon in the delivery material.

88. The system, composition, or method of any of the preceding claims, wherein the modification of release is one of acceleration or deceleration.

89. The composition of any of the preceding claims, wherein the delivery material that is a carbon material comprises about 75 to about 100 wt % carbon, or about 90 to about 100 wt % carbon, or about 95 to about 100 wt % carbon, or 93-99 wt % carbon, or 94-98 wt % carbon, or about 90 to about 95 wt % carbon.

90. The composition of any of the preceding claims, wherein:
release of the cyclopropene from the composition is accelerated after contact between the composition and a liquid displacing medium versus the release of the cyclopropene without the addition of external wetting or hydrating.

91. The system, composition, or method, of any of the preceding claims wherein the liquid the liquid displacing medium comprises water.

92. The system, composition, or method, of any of the preceding claims wherein, the liquid displacing medium is water.

93. The system, composition, or method, of any of the preceding claims wherein, the liquid displacing medium comprises an alcohol.

94. The system, composition, or method, of any of the preceding claims wherein, is the liquid displacing medium is an alcohol.

95. The system, composition, or method, of any of the preceding claims wherein, the liquid displacing medium comprises acetone.

96. The system, composition, or method, of any of the preceding claims wherein, the liquid displacing medium is acetone.

97. The composition of any of the preceding claims, wherein:
release of the cyclopropene from the composition is decelerated after contact between the composition and a liquid displacing medium versus the release of the cyclopropene without the addition of external wetting or hydrating.

98. The composition of any of the preceding claims, wherein the delivery material that is a carbon material comprises about 75 to about 100 wt % carbon, or about 90 to about 100 wt % carbon, or about 95 to about 100 wt % carbon, or 93-99 wt % carbon, or 94-98 wt % carbon, or about 90 to about 95 wt % carbon.

99. The system, composition, or method of any of the preceding claims, wherein the delivery material that is a carbon-based material contains carbon in an amount of about 75 to about 100 wt % carbon, or about 90 to about 100 wt % carbon, or about 95 to about 100 wt % carbon, or 93-99 wt % carbon, or 94-98 wt % carbon, or about 90 to about 95 wt % carbon.

100. The composition of any of the preceding claims, the liquid displacing medium selected from the group consisting of water, water in which an electrolyte or ionic compound has been dissolved, alcohol, methanol, ethanol, isopropanol, butanol, or glycerol, acetone, ethyl acetate, pentane, hexane, heptane, toluene, and combinations thereof.

101. The composition of any of the preceding claims, further comprising a binder, oil, hydrogel, or polymer.

102. The composition of any of the preceding claims, further comprising a hygroscopic material.

103. The composition of any of the preceding claims, further comprising a diluent material.

104. The composition of any one of the preceding claims, wherein the delivery material is porous.

105. The composition of any of the preceding claims, wherein the delivery material comprises a nanoporous, microporous, macroporous, or mesoporous carbon, or combinations thereof.

106. A composition of any of the preceding claims, wherein the delivery material is in at least one of powder, pellet, granule, nanoscale, and mesoporous form.

107. The composition of any of the preceding claims, wherein the delivery material comprises a solid material.

108. The composition of any of the preceding claims, wherein the delivery material comprises an amorphous solid, a glassy solid, a ceramic, or a non-crystalline solid.

109. The composition of any of the preceding claims, wherein the delivery material comprises a carbon based material.

110. The composition of any of the preceding claims, wherein the delivery material comprises activated carbon or activated charcoal.

111. The composition of any of the preceding claims, wherein the carbon material comprises a monolithic carbon material, an extruded or pelletized carbon material, a steam-activated carbon material, an oxidized carbon material, a heat treated carbon material, an acid-treated carbon material, a base-treated carbon material, ash, char, biochar, soot, or a combination thereof.

112. The composition of any of the preceding claims, wherein the carbon material is in at least one of powder, pellet, granule, film, and extrudate form.

113. A composition of any of the preceding claims, wherein the carbon material comprises a commercial carbon.

114. The composition any of the preceding claims, wherein the carbon material is an extruded carbon with a pellet diameter of 0.1-4.5 mm.

115. The composition of any of the preceding claims, wherein the delivery material comprises a high-surface area material.

116. The composition of any of the preceding claims, wherein the delivery material comprises at least one of a mesoporous carbon material, a nanoporous carbon material, and microporous carbon material, the carbon material modified with at least one of an oxidant, hydrolyzing reagent, heat, an acid, and a base.

117. The composition of any of the preceding claims, wherein the delivery material comprises a modified carbon material.

118. The composition of claim of any of the preceding claims, wherein the carbon material has been modified with water that is not the liquid displacing medium.

119. The composition of any of the preceding claims, wherein the carbon material has been modified with at least one of sulfuric acid, hydrochloric acid, perchloric acid, hypochloric acid, and a conjugate base of those acids.

120. The composition of any of the preceding claims, wherein the carbon material has been modified with at least one of ozone gas, hydrogen peroxide, organoperoxides, and oxygen gas.

121. The composition of any of the preceding claims, wherein the carbon material has been modified with nitric acid in a concentration from 0.01-99%.

122. The composition of any of the preceding claims, wherein the delivery material has a surface area between about 1 to about 3000 m²/g, or between about 1 to about 2500 m²/g, or between about 100 to about 1500 m²/g, or between about 500 to about 1500 m²/g, or between about 1000 to about 1500 m²/g or between about 50 to about 2000 m² g.

123. The composition of any of the preceding claims, wherein the delivery material comprises a high-surface area material comprising a total chemical surface area, internal and external, greater than 1 m²/g, or greater than 10 m²/g, or greater than 90 m²/g, or greater than 500 m²/g, or greater than 1000 m²/g.

124. The composition of any of the preceding claims, wherein the delivery material comprises a porous material having a pore volume between about 0.1 cm³/g to about 10 cm³/g, or between about 0.1 cm³/g to about 5 cm³/g, or between about 0.5 cm³/g to about 2 cm³/g, or between about 0.5 cm³/g to about 1.5 cm³/g, or between about 0.5 cm³/g to about 10 cm³/g, or between about 0.5 cm³/g to about 5 cm³/g, or between about 0.5 cm³/g to about 1.5 cm³/g, or between about 1 cm³/g to about 1.5 cm³/g.

125. The composition of any of the preceding claims, wherein the delivery material comprises a porous material having a d-spacing of about 3.0 Å to about 4.5 Å.

126. The composition of any of the preceding claims, wherein the delivery material comprises a porous material having an internal void volume greater than about 0.1 cm³/g, or greater than about 1 cm³/g, or greater than about 1.5 cm³/g.

127. The composition of any of the preceding claims, wherein the delivery material comprises a carbon material having one or more of the following properties: a density in the range of 0.2-3 g/cm³; a pore volume in the range of 0.1-1.5 cm³/g; a surface area in the range of 500-4000 m²/g; moisture content in the range of 0-30 wt %.

128. The composition any of the preceding claims, wherein the delivery material is a polymer, inorganic material, organic material, or hybrid thereof.

129. The composition of claim 16, wherein the polymer, inorganic material, organic material, or hybrid thereof comprises 0-99.99 wt % of the composition.

130. The composition of claim 1, wherein the delivery material comprises 0-99.99 wt % of the composition.

131. The composition of any of the preceding claims, wherein the polymer, inorganic material, organic material, or hybrid thereof comprises 50-100 mol % of the delivery material.

132. The composition of any of the preceding claims, wherein the delivery material comprises an inert material.

133. The composition of any of the preceding claims, wherein:
the inert material is selected from the group consisting of a polysiloxane, a polyalkylsiloxane, a polyalkylenesiloxane, and a polyoxoalkyelene, and
wherein the inert material optionally further comprises a surfactant.

134. The composition of any of the preceding claims, wherein the inert material comprises a templated, porous, or otherwise high-surface-area organic material.

135. The composition of any of the preceding claims, wherein the inert material comprises nanoporous, microporous, or mesoporous activated carbon; and optionally a surfactant.

136. The composition of any of the preceding claims, wherein the delivery material comprises a recyclable material.

137. A composition of any of the preceding claims, prepared by a process comprising the steps of modifying at least one of the hydrophobicity, hydrophilicity, chemical potential, zeta-potential, acidity, basicity, surface functionalization, and surface functional group density of a carbon material; and impregnating the modified carbon material with at least one or more cyclopropene compounds.

138. The composition of any of the preceding claims, the delivery material comprising at least one adsorption-modifying functionality.

139. The composition of any of the preceding claims, wherein the adsorption-modifying functionality is a trimethylsilyl-functionality.

140. The composition of any of the preceding claims, wherein the adsorption-modifying functionality is one of hydrophobic or aliphatic groups installed on at least one of an internal and external surface of the delivery material.

141. The composition of any of the preceding claims, wherein the delivery material has a moisture content in the range of 0 to about 2 wt %, or in the range of 2 to about 5 wt %, or in the range of 5 to about 15 wt %, or in the range of 15 to about 25 wt %, or in the range of 25 to about 50 wt %, or in the range of 50 to about 100 wt %.

142. The composition of any of the preceding claims, wherein the delivery material has a moisture content of about 2 wt %.

143. The composition of any of the preceding claims, wherein the delivery material has a moisture content of less than about 5 wt %, or less than about 4 wt %, or less than about 3 wt %, or less than about 2 wt %.

144. The composition of any of the preceding claims, wherein the delivery material has a moisture content in the range of about 1 to 3 wt %.

145. The composition of any of the preceding claims, wherein the delivery material is a carbon material having a density in the range of about 0.1 to about 0.3 g/cm³, or in the range of about 0.3 to about 0.6 g/cm³, or in the range of about 0.6 to about 1.0 g/cm³, or in the range of about 1 to about 3 g/cm³, or in the range of about 0.3 to about 1.5 g/cm³, or in the range of about 0.05 to about 0.15 g/cm³, or in the range of about 0.15 to about 0.3 g/cm³, or in the range of about 0.3 to about 0.7 g/cm³, or in the range of about 1 to about 1.5 g/cm³, or in the range of about 0.5 to about 1.5 g/cm³.

146. The composition of any of the preceding claims, wherein the delivery material is a carbon material having a density in the range of about 0.3 to about 0.5 g/cm³.

147. The composition of any of the preceding claims, wherein the delivery material comprises a plurality of pores.

148. The composition of claim 82, wherein a plurality of the plurality of pores store the cyclopropene.

149. The composition of any of the preceding claims, wherein the cyclopropene is present in the composition in up to 30 wt % versus the total weight of the delivery material and the cyclopropene.

150. The composition of any of the preceding claims, wherein the composition is configured to release the cyclopropene for at least 10 hours following contact with a liquid displacing medium.

151. The composition of any of the preceding claims, wherein the composition is configured to release the cyclopropene for at least 15 hours following contact with a liquid displacing medium.

152. The composition of any of the preceding claims, wherein the composition is configured to release the cyclopropene for at least 20 hours following contact with a liquid displacing medium.

153. The composition of any of the preceding claims wherein the cyclopropene is 1-methylcyclopropene (1-MCP).

154. The composition of any of the preceding claims, wherein the cyclopropene is released from the composition in the vapor or gas phase.

155. The composition of any of the preceding claims incorporated into a structure or form factor.

156. The composition of claim 88, wherein the structure or form factor comprises one or more of a sachet, an insert, a gel, a coating, a powder, a pellet, a film, a sheet or flake, or encased in a capsule, pod, compartment, a container, a non-woven material, a woven material, a knitted material, a paint, a coating, a paper, a cardboard, a paper derivative, a fabric, a fiber, a film, a cloth, a wood, a clay, a pulp, or a plastic.

157. The composition of any of the preceding claims incorporated into a structure or form factor comprising a Gurley Hill porosity measurement of 45-60 sec/100 cm²-in.

158. The composition any of the preceding claims wherein the composition is sealed inside the structure or form factor.

159. The composition any of the preceding claims wherein the cyclopropene can be liberated from the composition and the structure without the use of a solvent.

160. The composition of any of the preceding claims wherein the composition is contained in hermetically sealed or gas impermeable packaging.

161. The composition of any of the preceding claims wherein the composition is incorporated into one of a refrigeration system, a cold compartment, and a refrigeration filtration system.

162. The system, composition, or method of any of the preceding claims, exposure to a non-equilibrium condition comprises removing the composition or matrix from hermetically sealed or gas impermeable packaging.

163. The composition of any of the preceding claims, configured to release the or more cyclopropene compounds without addition of external wetting, hydrating, or chemically reactive agents.

164. The composition of any of the preceding claims, configured to release the or more cyclopropene compounds without use of a solvent.

165. A for releasing of a cyclopropene from a composition comprising a carbon delivery material and a cyclopropene, the method comprising:
contacting the composition comprising the carbon delivery material and the cyclopropene with a liquid displacing medium,
wherein release of the cyclopropene from the composition occurs at temperatures between about −2° C. and about 40° C.

166. A method for accelerating release of a cyclopropene from a composition comprising a carbon delivery material and a cyclopropene, the method comprising:
contacting the composition comprising the carbon delivery material and the cyclopropene with a liquid displacing medium,
wherein release of the cyclopropene from the composition occurs at temperatures between about −2° C. and about 40° C.

167. A method for decelerating release of a cyclopropene from a composition comprising a carbon delivery material and a cyclopropene, the method comprising:
contacting the composition comprising the carbon delivery material and the cyclopropene with a liquid displacing medium,
wherein release of the cyclopropene from the composition occurs at temperatures between about −2° C. and about 40° C.

168. A method of exposing produce to cyclopropene, the method comprising:
contacting a composition comprising a carbon delivery material and a cyclopropene with a liquid displacing medium in the presence of produce.

169. A method of any of the preceding claims, wherein the composition comprises between about 0.01-30 wt % cyclopropene versus the total weight of the delivery material and the cyclopropene.

170. A method of any of the preceding claims, further comprising:
exposing the composition of any one of the preceding claims to a non-equilibrium condition.

171. A method comprising exposing the composition of any one of the preceding claims to produce.

172. A method comprising exposing the composition of any one of the preceding claims to food, or optionally an edible perishable substance.

173. The method of any of the preceding claims, wherein the exposure to produce occurs at temperatures anywhere between about −2° C.-30° C.

174. The method any of the preceding claims, wherein the release of cyclopropene may be effected without wetting or hydrating.

175. The method any of the preceding claims, wherein the application of the volatile or gaseous or more cyclopropene compounds is effected without the use of a solvent.

176. A method of making the composition of any of the preceding claims, comprising:
modifying at least one of the hydrophobicity, hydrophilicity, chemical potential, zeta-potential, acidity, basicity, surface functionalization, and surface functional group density of a carbon material to make a delivery material; and
associating the at least one or more cyclopropene compounds with the delivery material.

177. The method of making the composition of any of the preceding claims, comprising associating the delivery material with an or more cyclopropene compounds to form the composition prior to sealing the composition in a structure or form factor.

178. The method of making the composition of any of the preceding claims, wherein associating the delivery material with or more cyclopropene compounds is accomplished by loading the or more cyclopropene compounds into the delivery material.

179. The method of making the composition of any of the preceding claims, comprising loading the delivery material with or more cyclopropene compounds by doing one or more of: directly contacting the delivery material with a pure liquid or more cyclopropene compounds; directly contacting the delivery material with a solution comprising the or more cyclopropene compounds; directly contacting the delivery material with an or more cyclopropene compounds in gas form; directly contacting the delivery material with a gas mixture comprising the or more cyclopropene compounds.

180. The method of any of the preceding claims, the liquid displacing medium selected from the group consisting of water, water in which an electrolyte or ionic compound has been dissolved, alcohol, methanol, ethanol, isopropanol, butanol, or glycerol, acetone, ethyl acetate, pentane, hexane, heptane, toluene, and combinations thereof.

181. The system, composition or method, of any of the preceding claims, wherein surface area of the delivery material in the range of about 800 to about 2000 m²/g.

182. The composition of any of the preceding claims,
wherein the concentration of cyclopropene sampled at minute 3 is less than about 50% of the concentration of cyclopropene sampled at minute 300, or wherein the concentration of cyclopropene sampled at minute 3 is less than about 40% of the concentration of cyclopropene sampled at minute 300, or wherein the concentration of cyclopropene sampled at minute 3 is less than about 30% of the concentration of cyclopropene sampled at minute 300, or wherein the concentration of cyclopropene sampled at minute 3 is less than about 20% of the concentration of cyclopropene sampled at minute 300, or wherein the concentration of cyclopropene sampled at minute 3 is less than about 15% of the concentration of cyclopropene sampled at minute 300, or wherein the concentration of cyclopropene sampled at minute 3 is less than about 10% of the concentration of cyclopropene sampled at minute 300, wherein the concentration of cyclopropene sampled at minute 30 is less than about 80% of the concentration of cyclopropene sampled at minute 300, or wherein the concentration of cyclopropene sampled at minute 30 is less than about 70% of the concentration of cyclopropene sampled at minute 300, or wherein the concentration of cyclopropene sampled at minute 30 is less than about 60% of the concentration of cyclopropene sampled at minute 300, or wherein the concentration of cyclopropene sampled at minute 30 is less than about 50% of the concentration of cyclopropene sampled at minute 300, or wherein the concentration of cyclopropene sampled at minute 30 is less than about 40% of the concentration of cyclopropene sampled at minute 300, or wherein the concentration of cyclopropene sampled at minute 30 is less than about 30% of the concentration of cyclopropene sampled at minute 300, or wherein the concentration of cyclopropene sampled at minute 30 is less than about 20% of the concentration of cyclopropene sampled at minute 300, or wherein the concentration of cyclopropene sampled at minute 60 is less than about 50% of the concentration of cyclopropene sampled at minute 300, or wherein the concentration of cyclopropene sampled at minute 60 is less than about 40% of the concentration of cyclopropene sampled at minute 300, or wherein the concentration of cyclopropene sampled at minute 60 is less than about 35% of the concentration of cyclopropene sampled at minute 300, or wherein the concentration of cyclopropene sampled at minute 90 is less than about 50% of the concentration of cyclopropene sampled at minute 300, or wherein the concentration of cyclopropene sampled at minute 90 is less than about 45% of the concentration of cyclopropene sampled at minute 300, or wherein the concentration of cyclopropene sampled at minute 120 is less than about 90% of the concentration of cyclopropene sampled at minute 300, or wherein the concentration of cyclopropene sampled at minute 120 is less than about 80% of the concentration of cyclopropene sampled at minute 300, or wherein the concentration of cyclopropene sampled at minute 120 is less than about 70% of the concentration of cyclopropene sampled at minute 300, or wherein the concentration of cyclopropene sampled at minute 120 is less than about 60% of the concentration of cyclopropene sampled at minute 300, or wherein the concentration of cyclopropene sampled at minute 120 is less than about 55% of the concentration of cyclopropene sampled at minute 300 or wherein the concentration of cyclopropene sampled at minute 150 is less than about 90% of the concentration of cyclopropene sampled at minute 300, or wherein the concentration of cyclopropene sampled at minute 150 is less than about 80% of the concentration of cyclopropene sampled at minute 300, or wherein the concentration of cyclopropene sampled at minute 150 is less than about 70% of the concentration of cyclopropene sampled at minute 300, or wherein the concentration of cyclopropene sampled at minute 150 is less than about 65% of the concentration of cyclopropene sampled at minute 300.

183. The system, composition, or method of any of the preceding claims,
wherein the delivery material is activated carbon or activated charcoal.

184. The system, composition, or method of any of the preceding claims,
wherein the carbon-based delivery material is activated carbon or activated charcoal.

185. The composition of any of the preceding claims,
wherein the delivery material is between 75-100 wt % carbon.

186. The composition of any of the preceding claims,
wherein the cyclopropene is 1-methylcyclopropene (1-MCP).

187. The composition of any of the preceding claims,
wherein cyclopropene is present in the delivery material in at least 0.01 wt % versus the total weight of the composition.

188. The composition of any of the preceding claims,
wherein the total weight of the composition is the total weight of the delivery material and the cyclopropene.

189. The system, composition, or method of any of the preceding claims wherein the one or more cyclopropene compounds is 1-methylcyclopropene (1-MCP).

190. The system, composition, or method, of any of the preceding claims wherein, particle size of at least 70 wt %, or at least 80 wt %, or at least 90 wt %, or at least 95 wt %, or at least 99 wt %, or at least 99.9 wt %, or at least 99.99 wt % of the delivery material is less than about 0.6 mm.

191. The system, composition, or method, of any of the preceding claims wherein, particle size of at least 70 wt %, or at least 80 wt %, or at least 90 wt %, or at least 95 wt %, or at least 99 wt %, or at least 99.9 wt %, or at least 99.99 wt % of the delivery material is between about 0.2 nm and 0.5 mm.
